(19) United States
(12) Patent Application Publication
(10) Pub. No.: US 2004/0215552 A1
(43) Pub. Date: Oct. 28, 2004

(54) Apparatus, system, and method for managing data and workflow

(76) Inventors: Joel A. Horn, Broomfield, CO (US); Theron J. Rubley, Highlands Ranch, CO (US); Ian George Alexander Lloyd, Highlands Ranch, CO (US); Ritesh Saraf, Denver, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/660,892

(22) Filed: Sep. 12, 2003

Related U.S. Application Data
(60) Provisional application No. 60/410,631, filed on Sep. 12, 2002.

(51) Int. Cl. G06F 17/60

(52) U.S. Cl. 705/38

(57) ABSTRACT

An apparatus and method for electronically managing and approving a loan application. The apparatus may include a document administration module, a loan officer module, an underwriting module, and an administration module, with each of the modules interacting with one another. Further, at least one of the modules operates on a document, and a plurality of the modules may simultaneously operate on the loan application. The method may receive a loan application, generate an indication of at least one document required to approve the loan application, electronically receive the at least one document, store the at least document, provide access to the at least one document; electronically underwrite the at least one document, and in response to electronically underwriting the at least one document, electronically approve the loan application.

### CROSS-REFERENCE TO RELATED APPLICATIONS

This application claims priority under 35 U.S.C. § 119(e) to United States provisional patent application serial No. 60/410,631, entitled “Apparatus, System, and Method for Managing Data and Workflow” and filed on Sep. 2, 2002, the entirety of which is hereby incorporated by reference.

### BACKGROUND

1. Field of the Invention

The present invention generally involves an apparatus and method for managing data, and more particularly to tracking, organization, and analysis of data related to various facets of securing a mortgage loan for a borrower.

2. Background Art

Obtaining a mortgage loan to purchase a home oftentimes involves many steps beginning with a flow of capital that is eventually routed to a borrower. Numerous entities and individuals are involved in routing the flow of capital to the borrower. Companies such as Fannie Mae and Freddie Mac pool and securitize mortgages, and sell them as mortgage-backed securities to public, private, institutional and other investors on the open market. The capital used to purchase the mortgage-backed securities is oftentimes aggregated at a mortgage loan wholesaler.

Mortgage loan brokers work with prospective borrowers to obtain a mortgage loan from the wholesaler. Conventionally, the processes of securing a mortgage loan for a borrower involves a series of steps that are performed consecutively. One step does not begin until the previous step is complete. FIG. 1A (Prior Art) illustrates the various steps involved in a typical conventional method for obtaining a mortgage loan. First, the borrower applies for a mortgage loan in step 10. Typically, the application process involves the borrower completing a loan application and submitting it to the mortgage broker. One such typical loan application is referred to as the Uniform Residential Loan Application. The loan application requires the prospective borrower to submit information to the mortgage broker, such as the borrower's income, employer, current assets and current liabilities. The loan application process also involves the borrower providing documents, such as a pay stub from an employer and bank statements, to the mortgage loan broker. Applying for a mortgage loan can take as little as a day or as long as a week or more.

When the loan application is complete and the mortgage loan broker has received the documents, the mortgage loan broker processes the mortgage loan application in step 20. Processing involves the verification and validation of the information submitted in the loan application. Typically, the mortgage broker will verify the applicant's employment, income, checking and savings account balances, and other information. The mortgage loan broker also orders an appraisal and a title report for the property being purchased with the mortgage loan. Loan processing may take a week or more, and can be greatly effected when various institutions, such as employers or banks, do not respond to validation requests in a timely manner and when appraisals and title reports are delayed. When the verification is complete and the appraisal and title documents have been received, the loan application is ready for underwriting processing by the lender, performed in step 30.

Generally, underwriting is undertaken by an underwriter to review all aspects of the loan application and analyze the creditworthiness of the applicant to approve, conditionally approve, or disapprove the loan request. More specifically, the underwriter will typically analyze the applicant's projected monthly housing expenses including the monthly principal and interest payments projected for the mortgage loan and the applicant's other current debt obligations, analyze the monthly income of the applicant, compare the income to the total debt, analyze the sources of funding for the closing and down payment, check the credit history of the applicant, and analyze the appraisal to ensure that it is accurate.

From the underwriting analysis, the underwriter will oftentimes request further documentation to validate certain information, shown as the “conditions to close” step 40 on FIG. 1A. This is especially common if the mortgage loan broker does not undertake an interval underwriting. For example, the underwriter may request additional pay stubs and past tax returns to further verify the applicant's employment history. In some instances, the underwriter will not request any further documentation and the loan will be approved quickly. Typically, however, the underwriting process takes a few days. When all of the documents and information are complete and suitably validated by the underwriter, then the underwriter will issue a final approval of the loan, shown as “HUD-1 Approval” 50 on FIG. 1A.

When final approval is issued by the underwriter, the closing is scheduled and the closing documents are ordered in step 60. The closing documents typically include a mortgage note that has the total amount of the mortgage loan, the term and monthly payment on the loan. The closing documents also typically include a Housing and Urban Development (“HUD”)-1 settlement statement, which is a document providing an itemized listing of the amounts that are payable at closing, such as real estate commissions, loan fees, points, and initial escrow amounts. The HUD-1 statement informs the borrower as to the amount of funds that must be brought to the closing. In many instances, the final closing documents are not received until the day of the closing. Thus, the borrower does not know the amount he or she must bring to the closing, which can cause what is oftentimes referred to as “closing day stress” for the borrower as he or she must be prepared to run to the bank to obtain the funds and then proceed to the closing.

At the closing, the borrower and lender sign the mortgage note and other required documents. The borrower will also provide the down payment, if required. When the closing is complete, the funds are released by the lender. The funds are disbursed appropriately. Typically, the various steps between applying for a loan and funding the loan may take at least a week, and oftentimes several weeks. The various operations are performed consecutively, such that one step must be completed before the next step begins. For example, the loan application process must be complete before underwriting may be commenced, and underwriting must be complete, before the closing can be scheduled and the closing documents ordered.

The present invention provides a management tool for the mortgage loan broker to assist in underwriting, closing, funding, administration, quality control, and document administration. Aspects of the present invention allow the mortgage loan broker to dramatically reduce the time between the start of the loan application process to the funding of the loan, and to provide a high quality product to the lender to make its underwriting as smooth as possible.

### SUMMARY OF THE INVENTION

Generally, one embodiment of the present invention takes the form of an apparatus for electronically managing and approving a loan application. The apparatus may include a document administration module, a loan officer module, an underwriting module, and an administration module, with each of the modules operably connected to one another. Further, at least one of the modules operates on a document, and a plurality of the modules may simultaneously operate on the loan application.

Another embodiment of the present invention takes the form of a computer-implemented method for managing mortgage broker workflow. The method may receive a loan application, generate an indication of at least one document required to approve the loan application, electronically receive the at least one document, store the at least document, provide access to the at least one document; electronically underwrite the at least one document, and in response to electronically underwriting the at least one document, electronically approve the loan application.

Additional advantages and benefits of the present invention and its various embodiments will be apparent upon reading the following description and claims.

### BRIEF DESCRIPTION OF THE DRAWINGS

FIG. 1A depicts the various steps involved in a typical conventional method for obtaining a mortgage loan.

FIG. 1 depicts a block diagram of a comprehensive document and workflow management tool, in accordance with an embodiment of the present invention.

FIG. 2A depicts a screenshot of a loan officer “loans in queue” screen, which is part of the loan officer subsystem of the embodiment of FIG. 1.

FIG. 2B depicts a screenshot of an “edit loan” screen, which is part of the loan officer subsystem of the embodiment of FIG. 1.

FIG. 2C depicts a screenshot of the edit loan screen of FIG. 2B, after a user has indicated that a loan is locked at an interest rate of 8%.

FIG. 2D depicts a screenshot of the loan officer “loans in queue” screen, updated to reflect an indication that an interest rate was locked.

FIG. 2E depicts a screenshot of the loan officer “loans in queue” screen, updated to reflect loan approval.

FIG. 2F depicts a screenshot of the loan officer “AEC Underwriting Notice” screen, which is part of the loan officer subsystem of the embodiment of FIG. 1.

FIG. 2G depicts a screenshot of the loan officer “loans in queue” screen after underwriter approval.

FIG. 2H depicts a screenshot of the “AEC Underwriting Notice” screen of FIG. 2F, after underwriting approval.

FIG. 21 depicts a screen-short of the “AEC Underwriting Notice” screen of FIG. 2F, illustrating the approval of required documents.

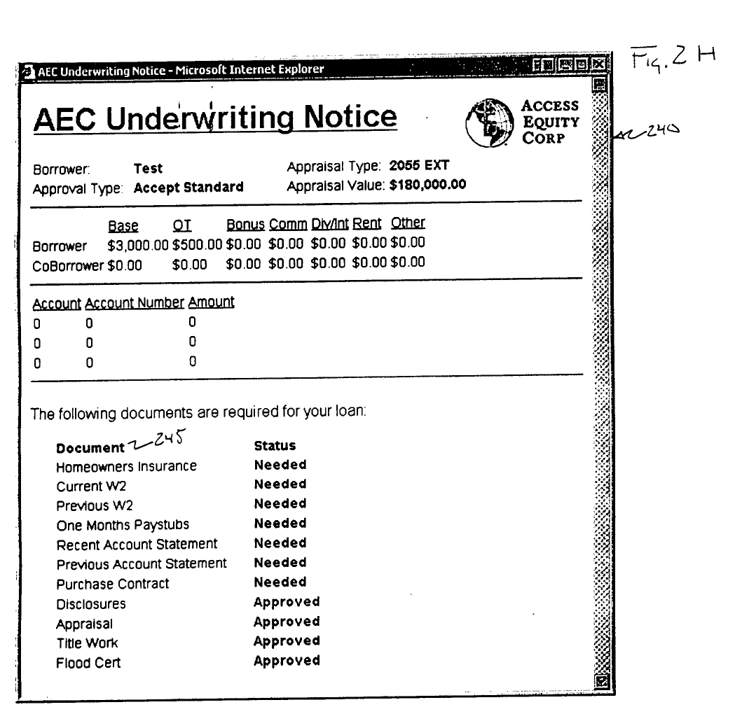

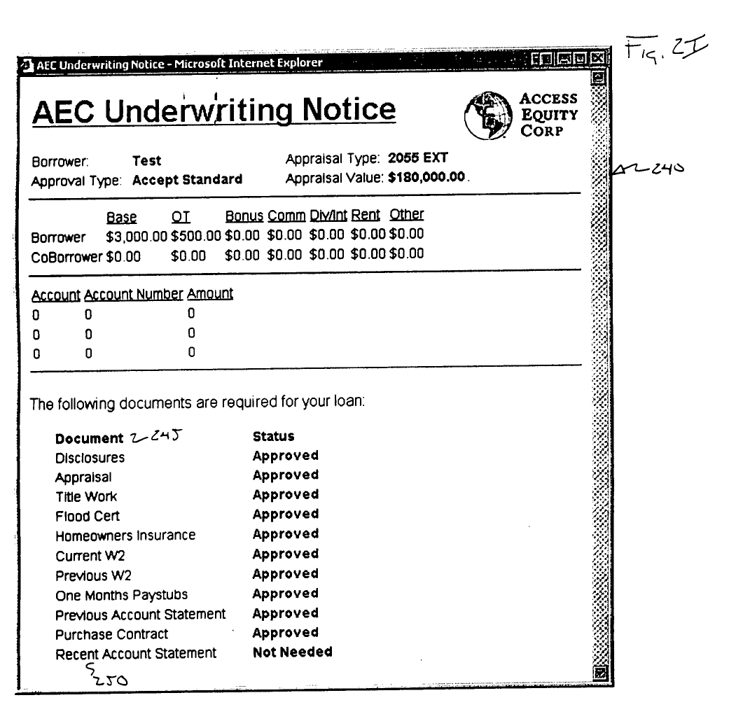

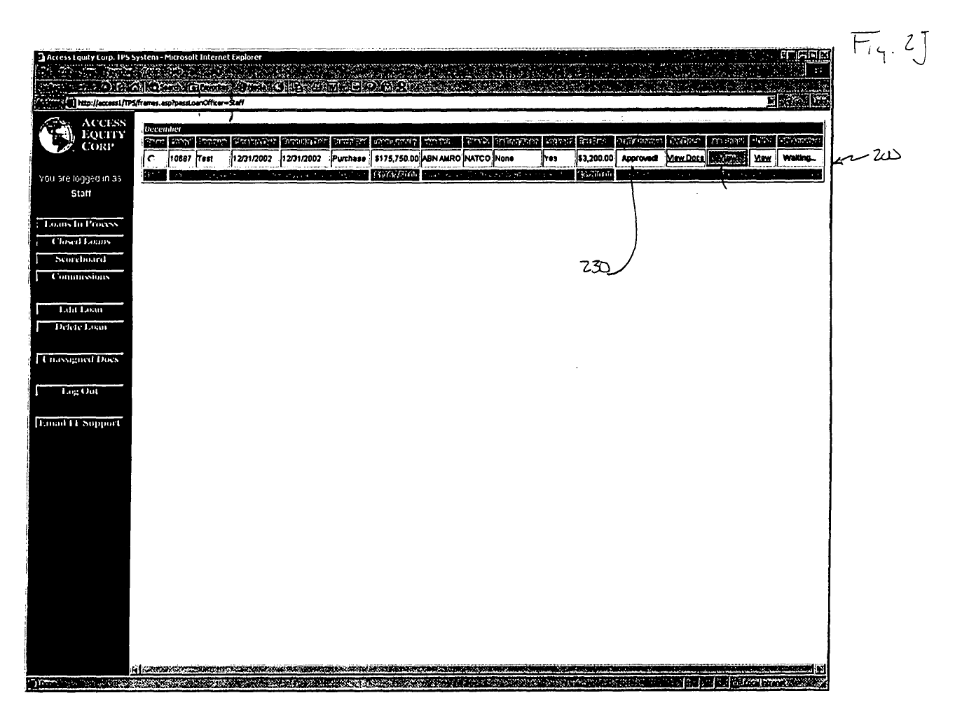

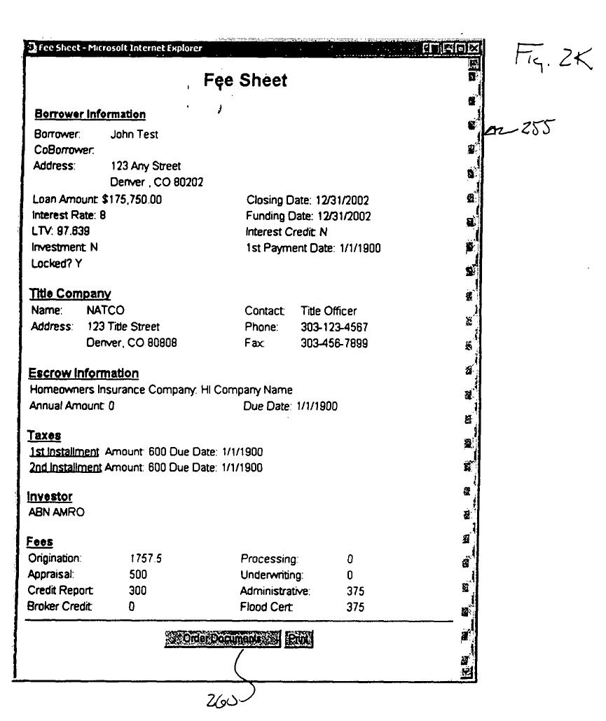

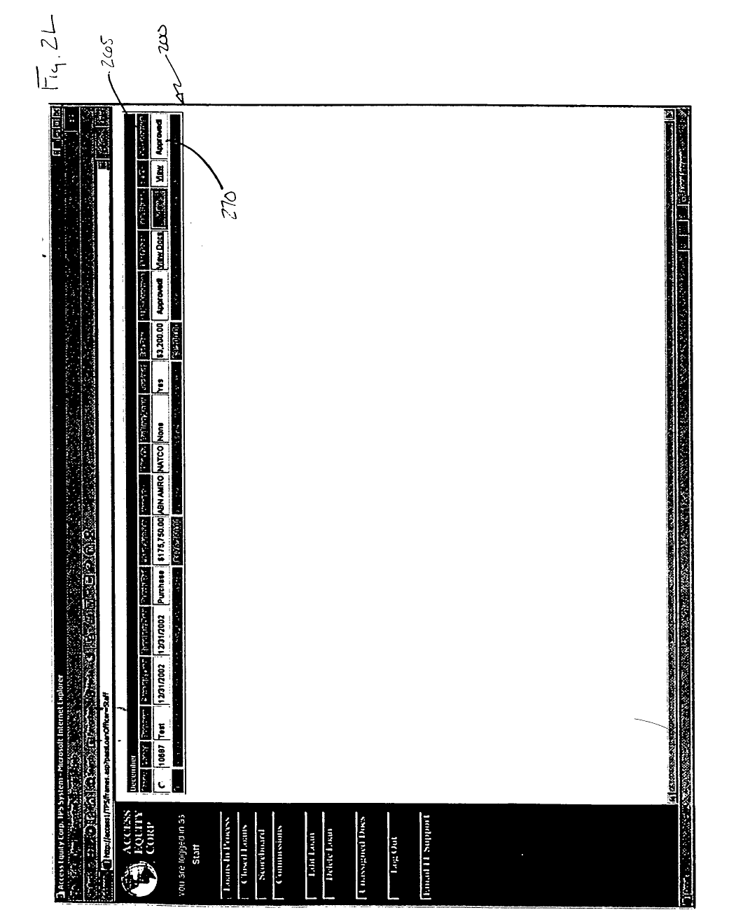

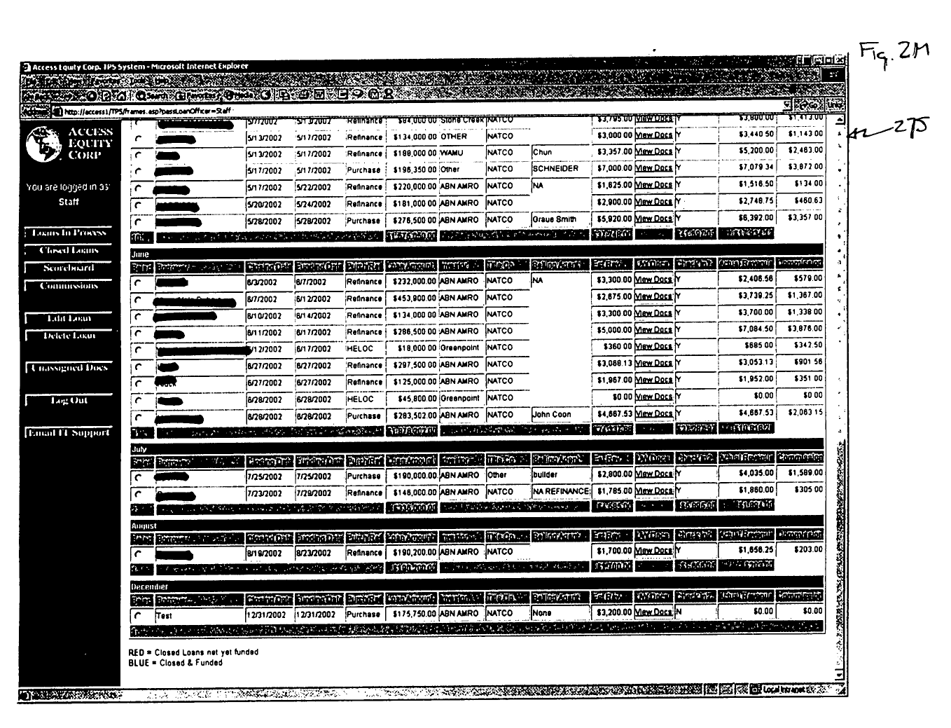

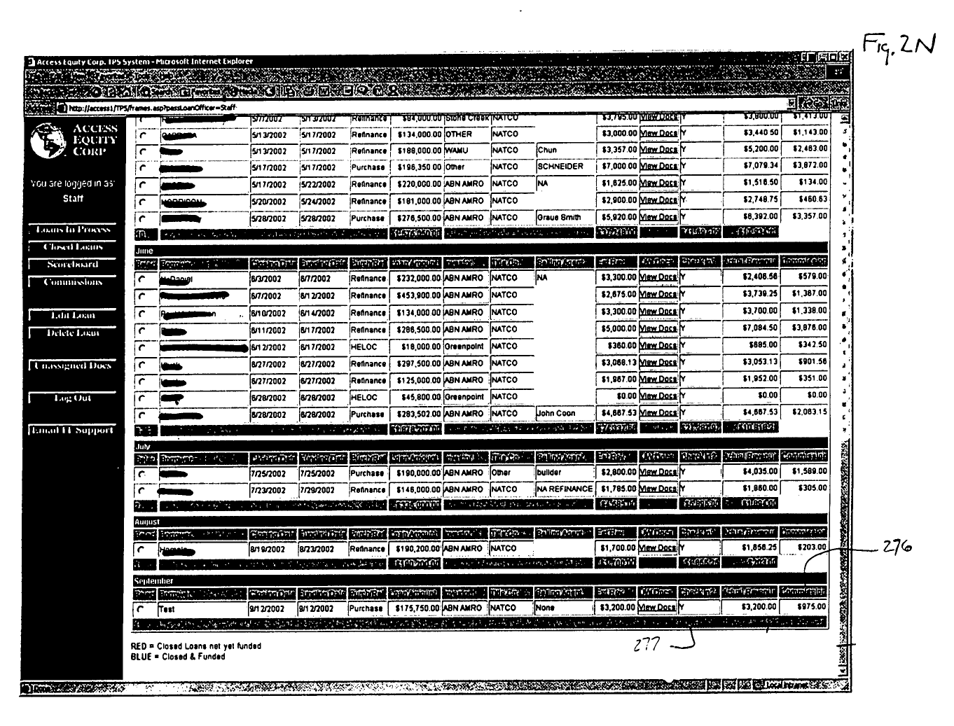

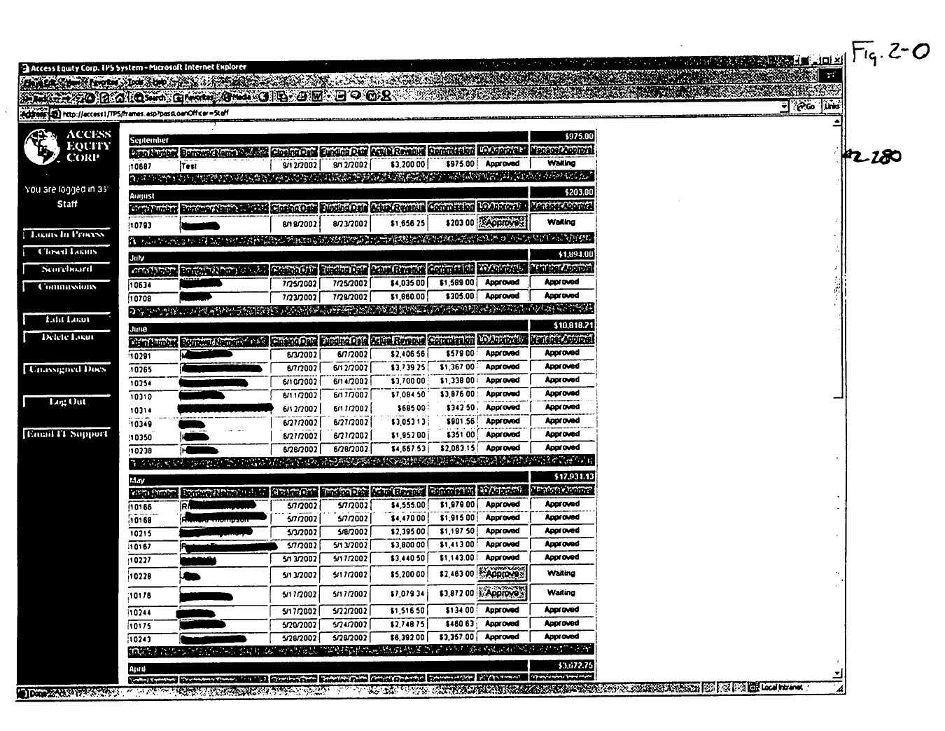

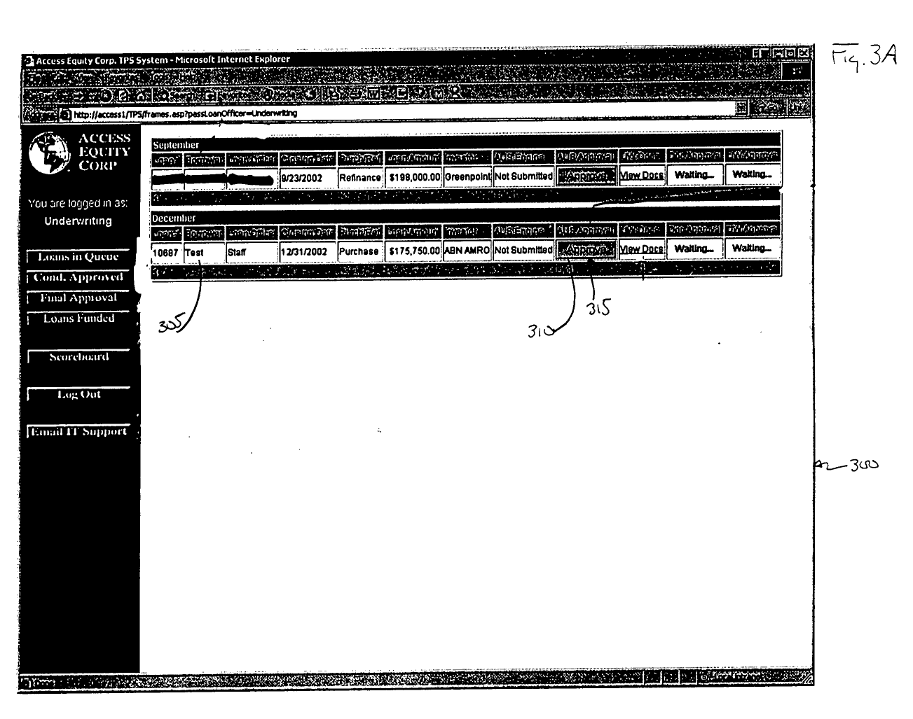

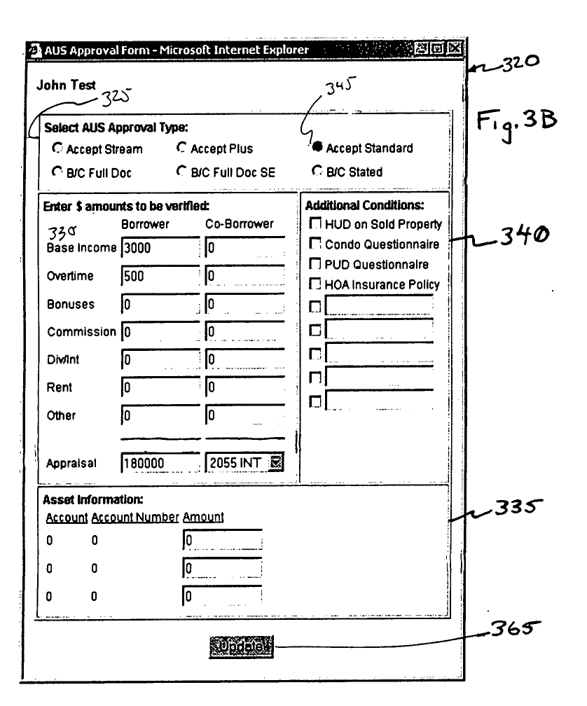

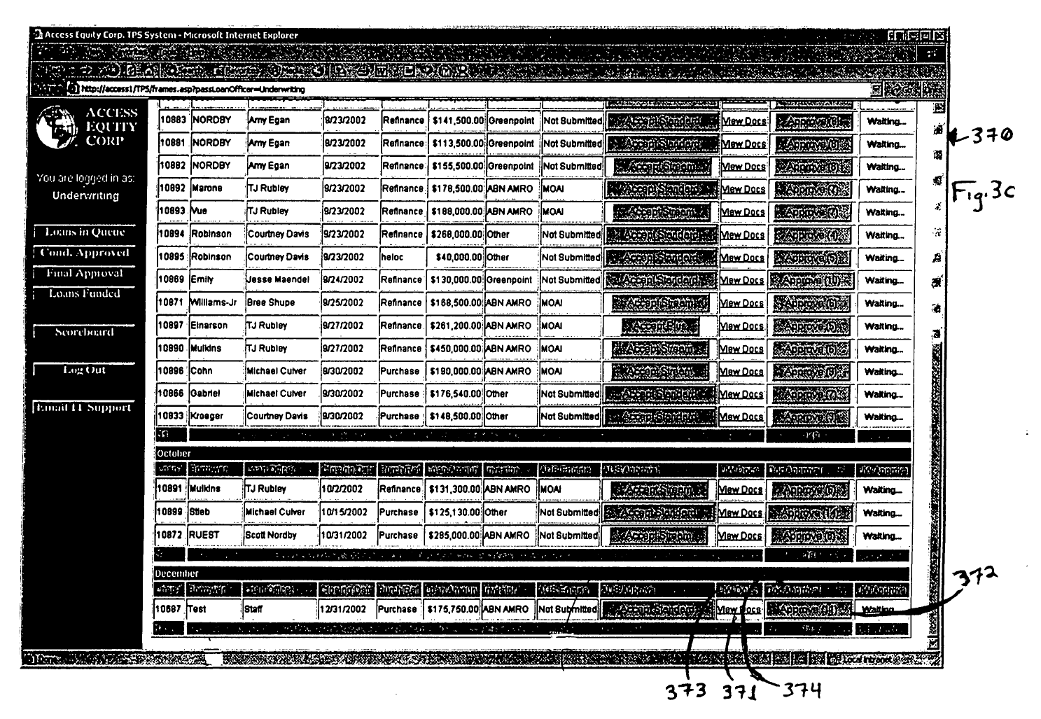

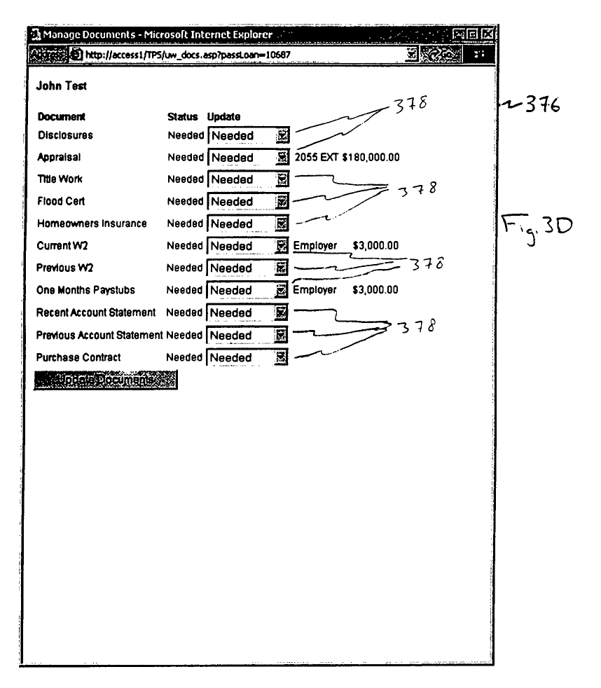

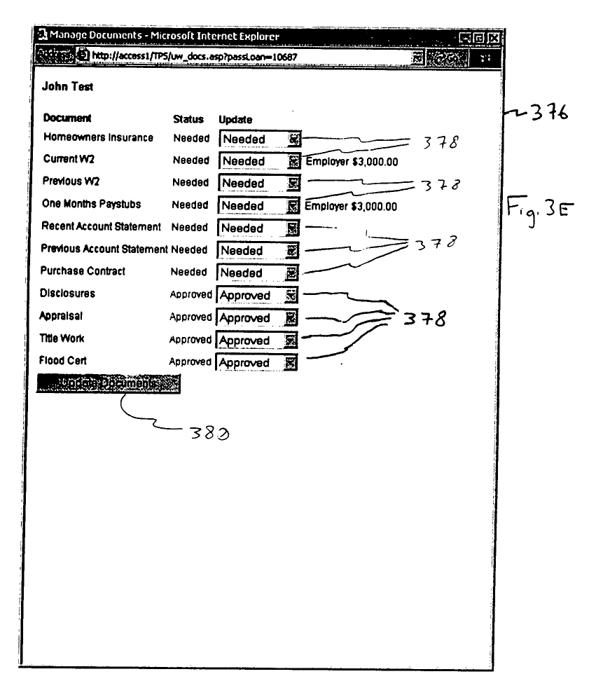

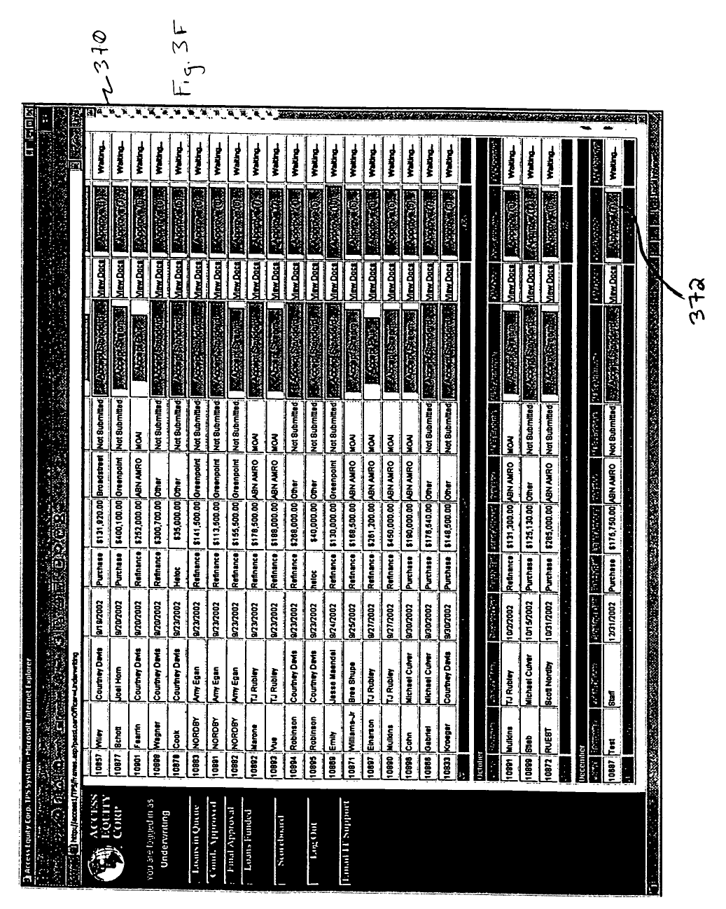

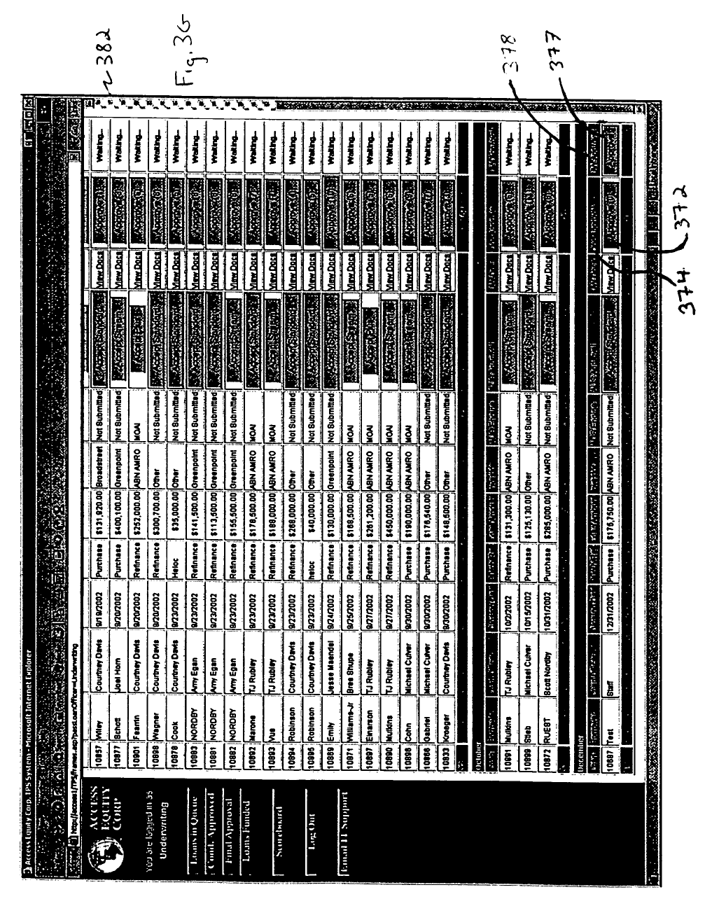

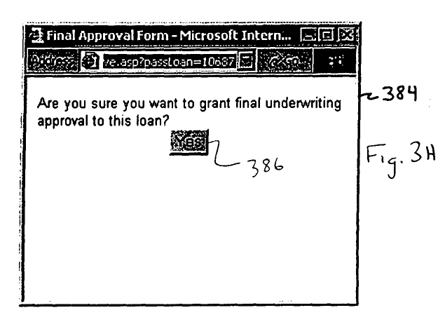

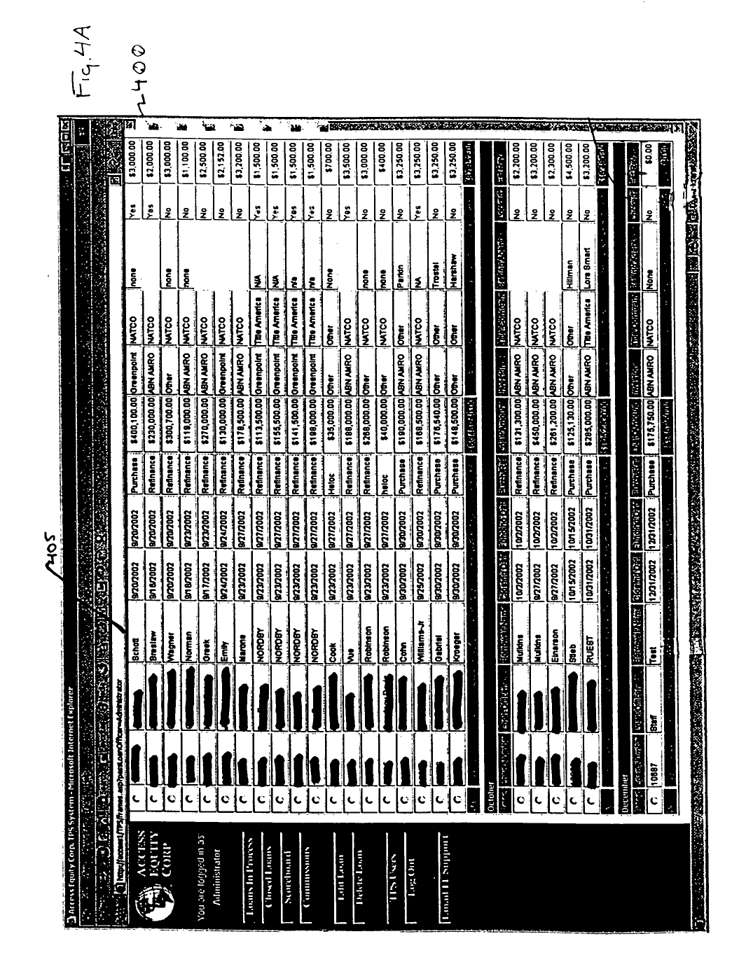

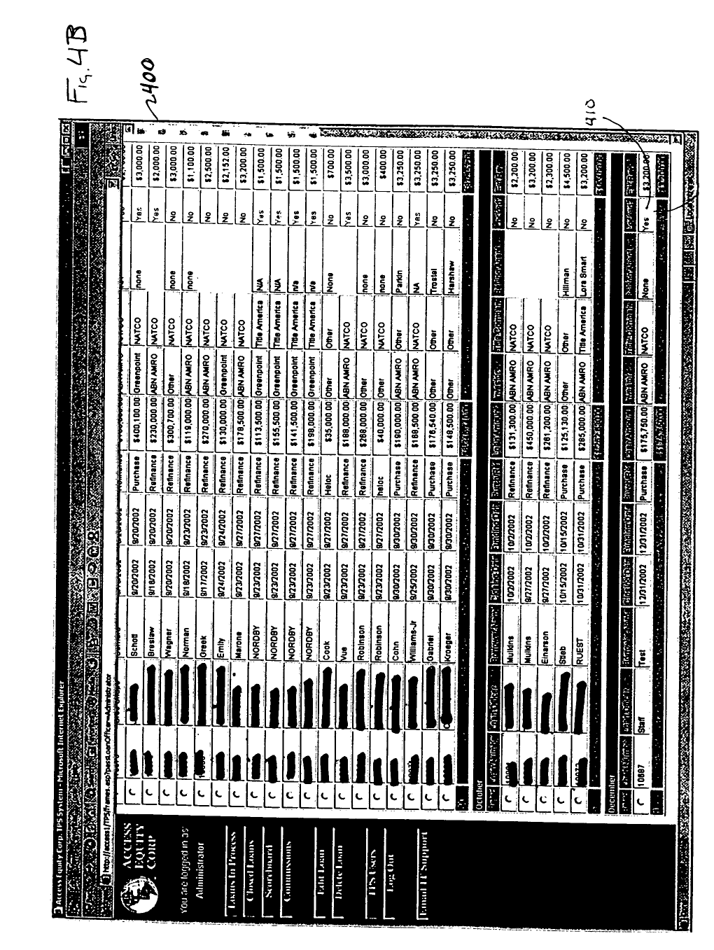

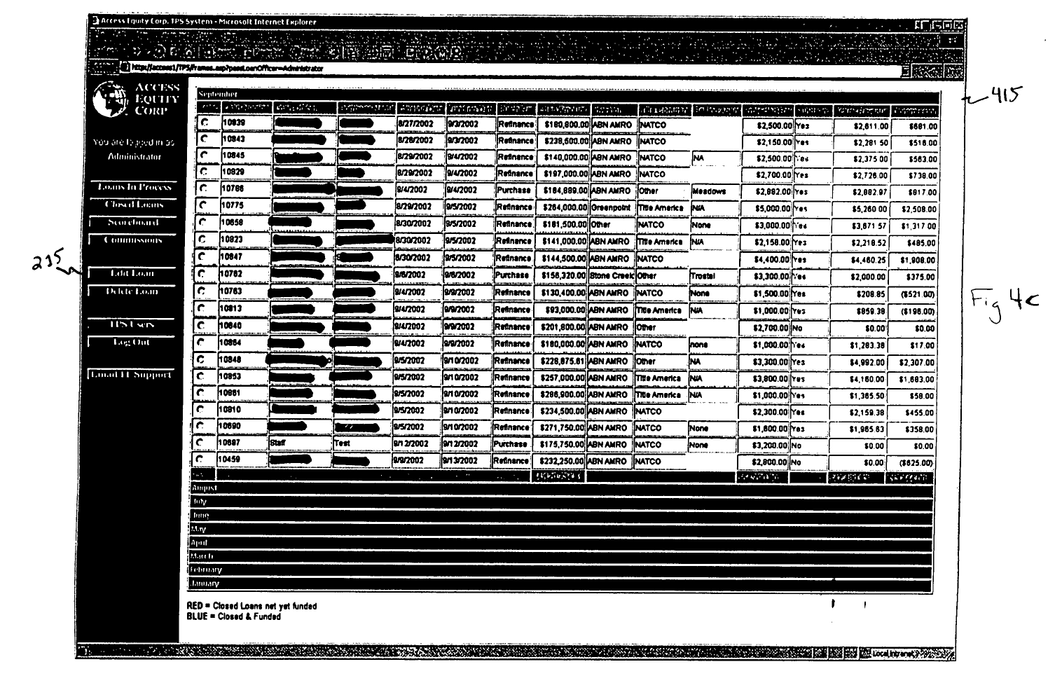

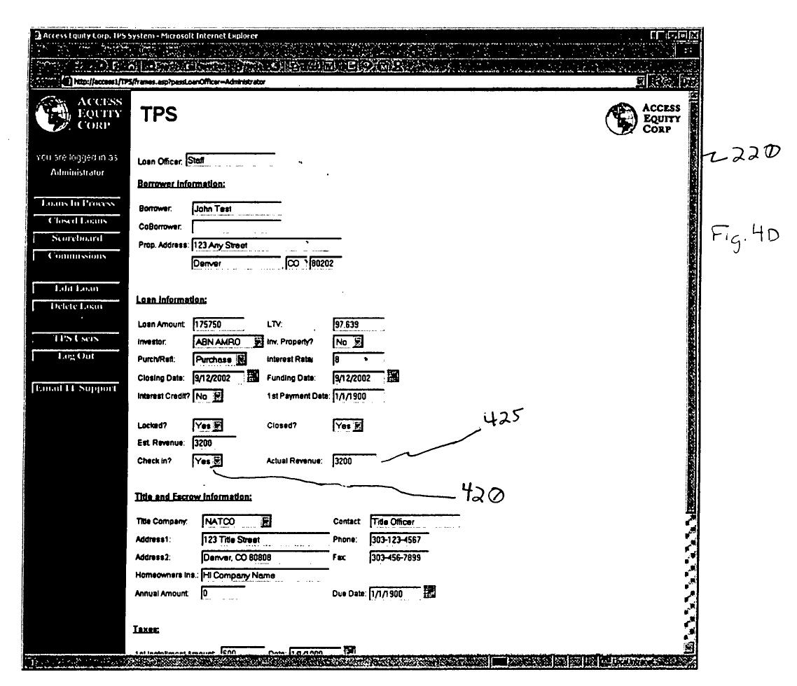

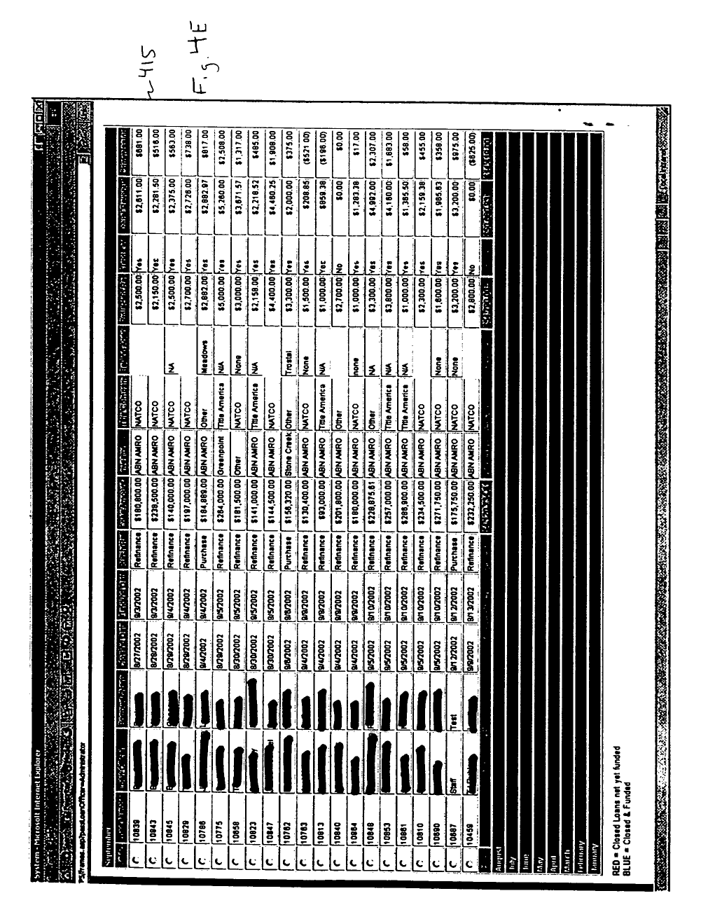

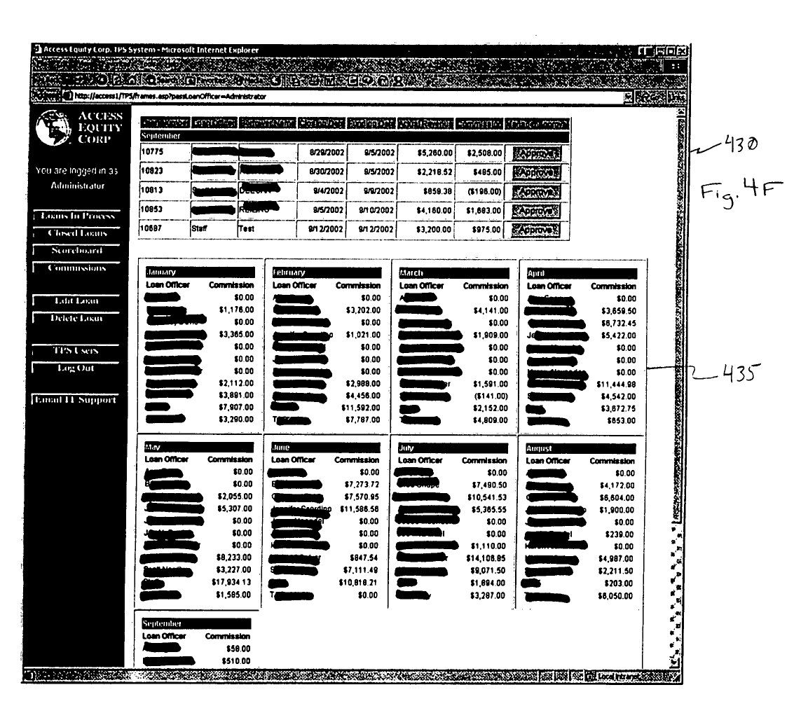

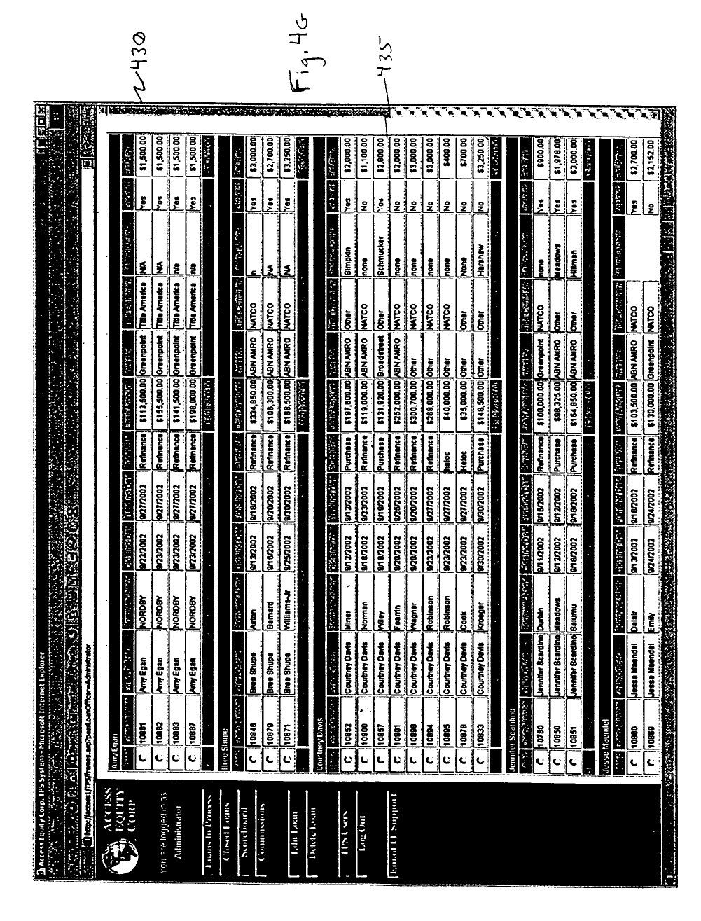

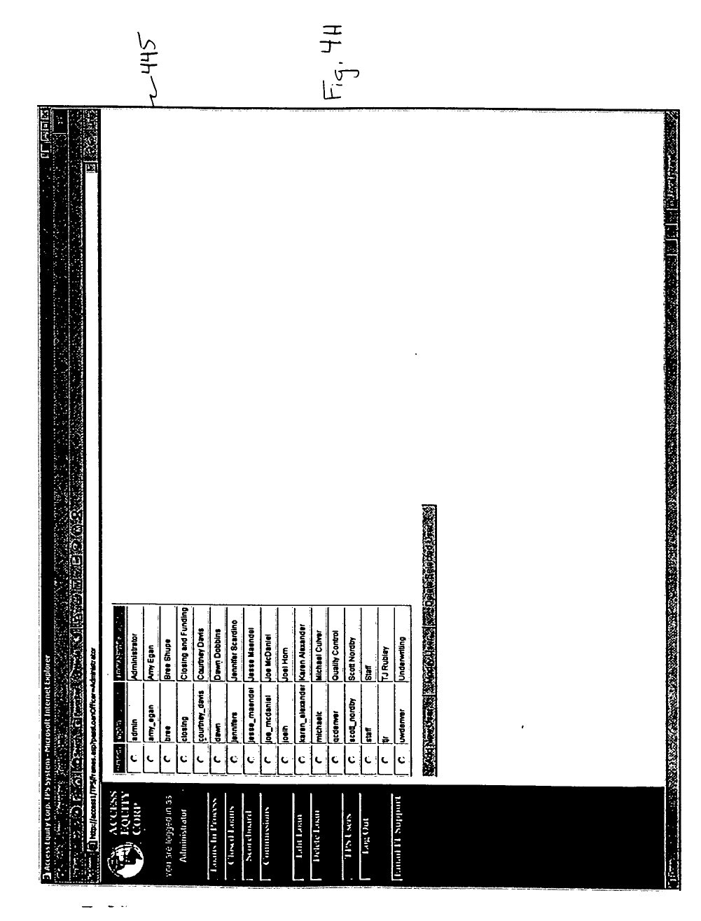

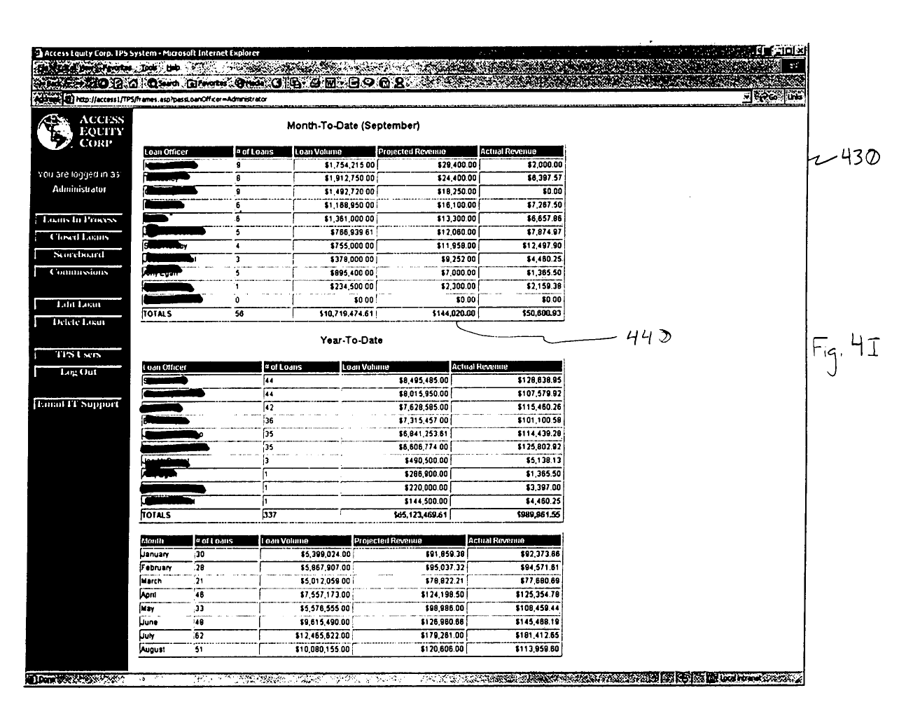

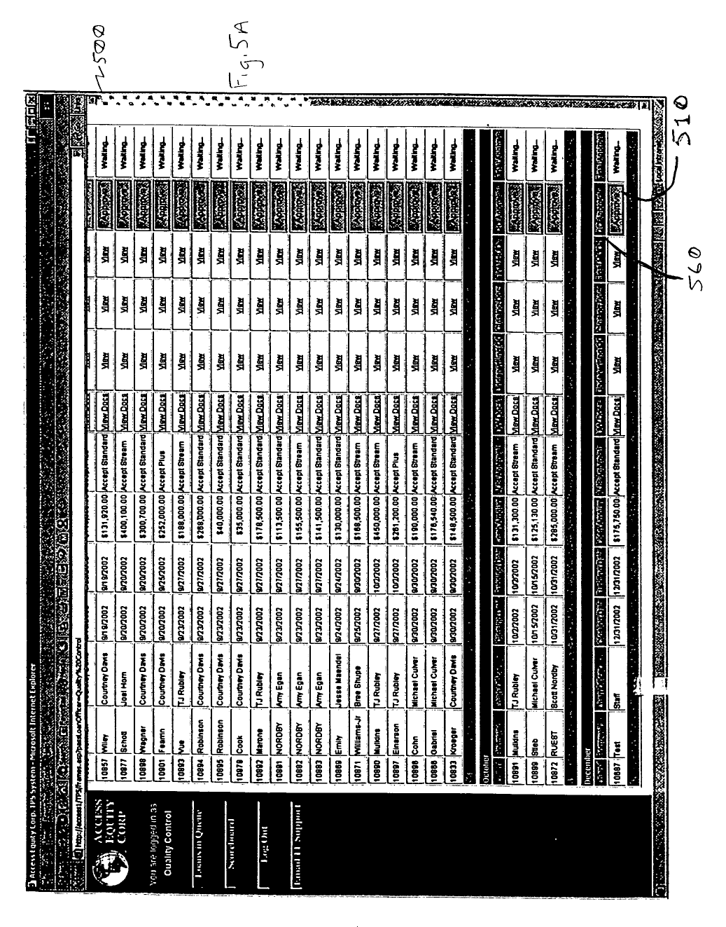

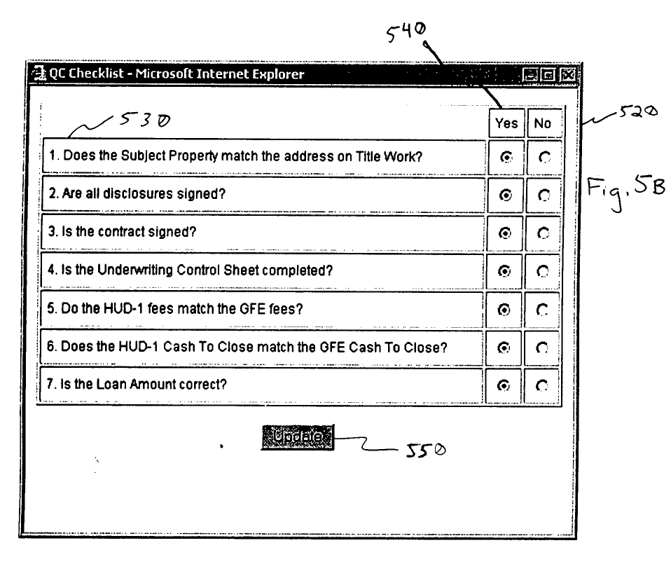

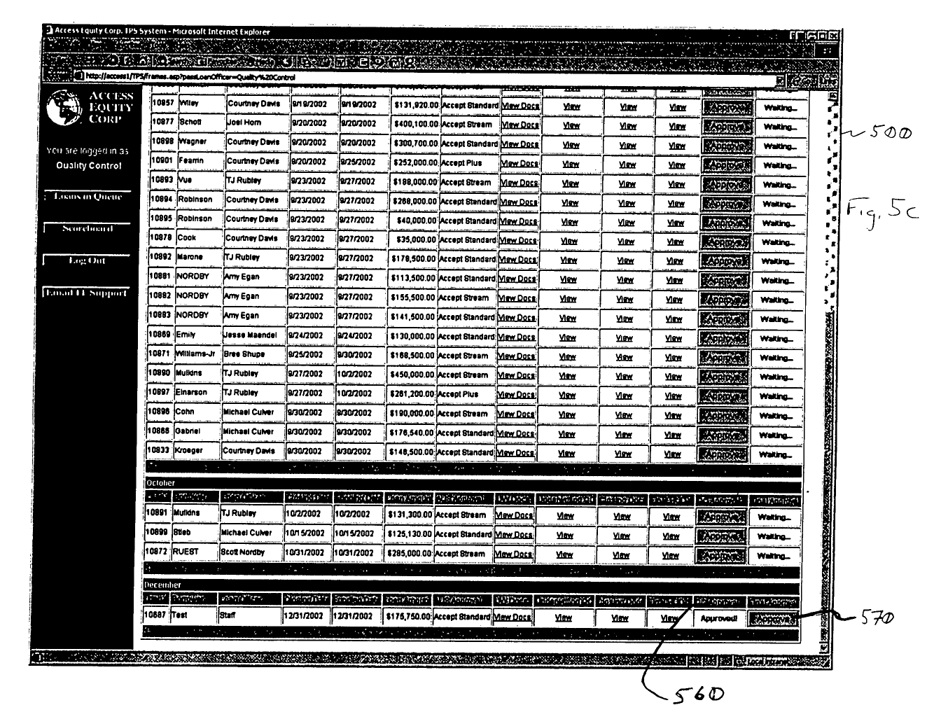

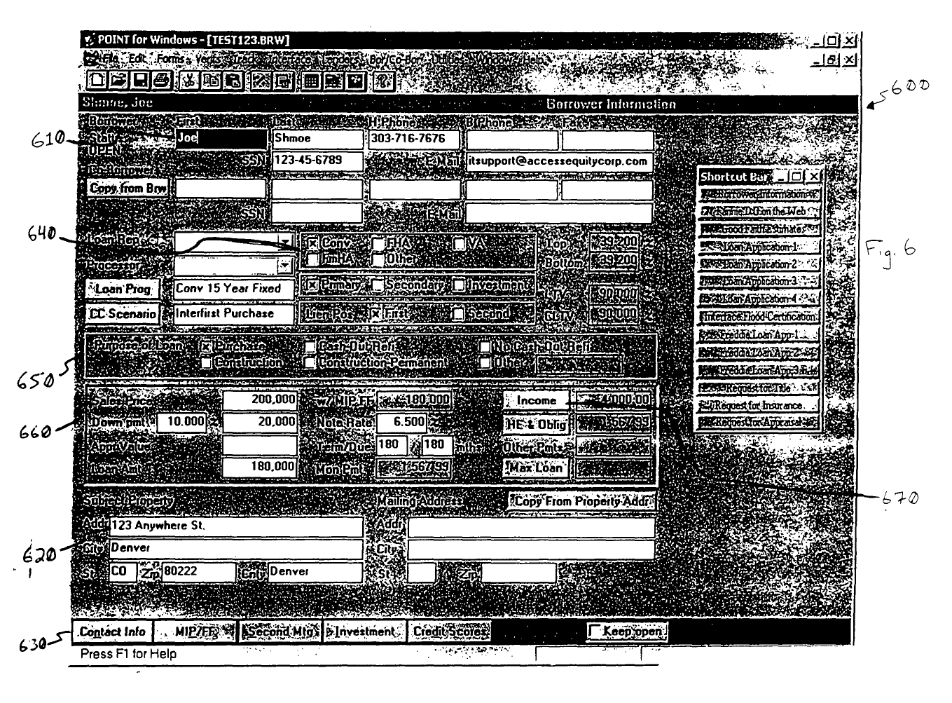

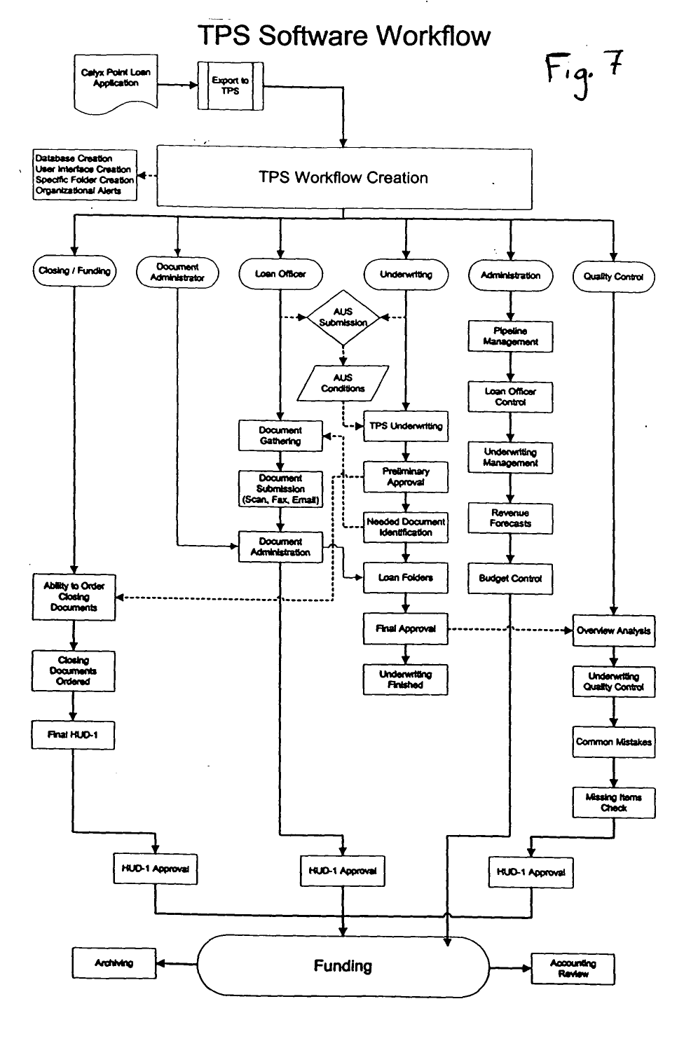

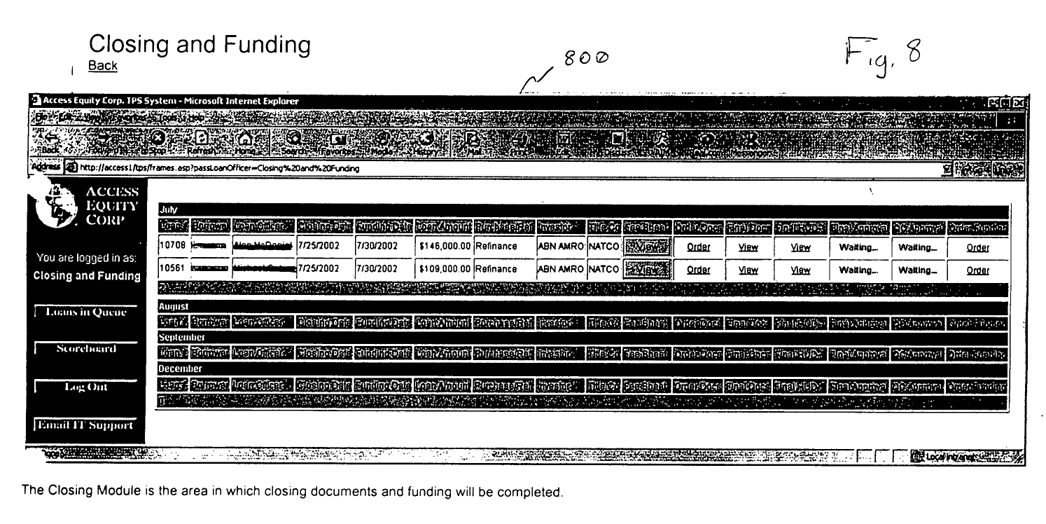

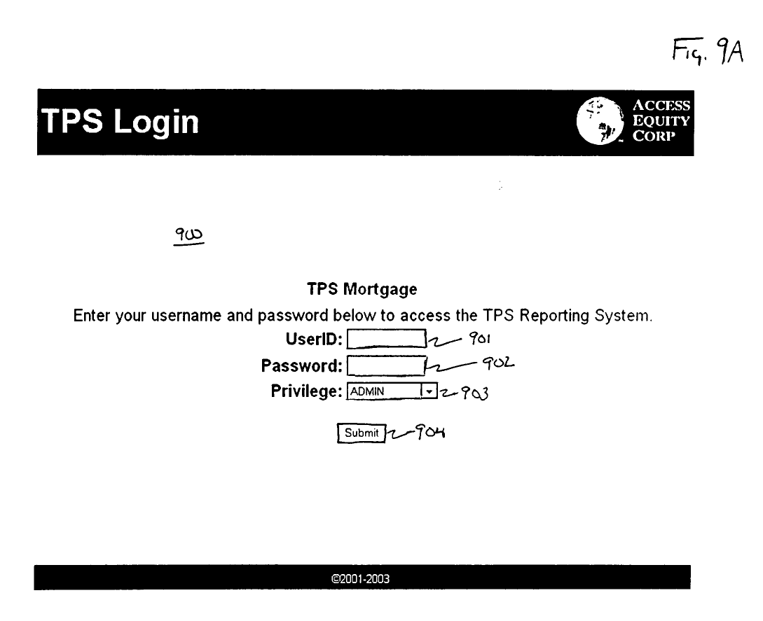

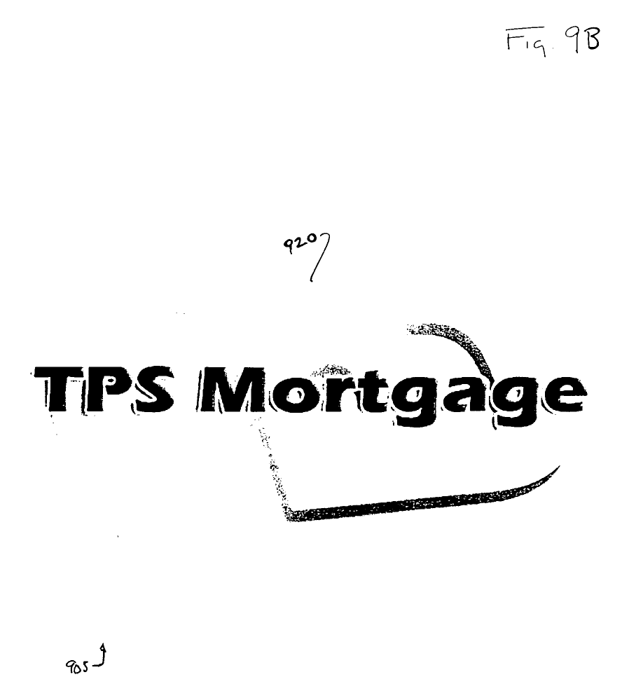

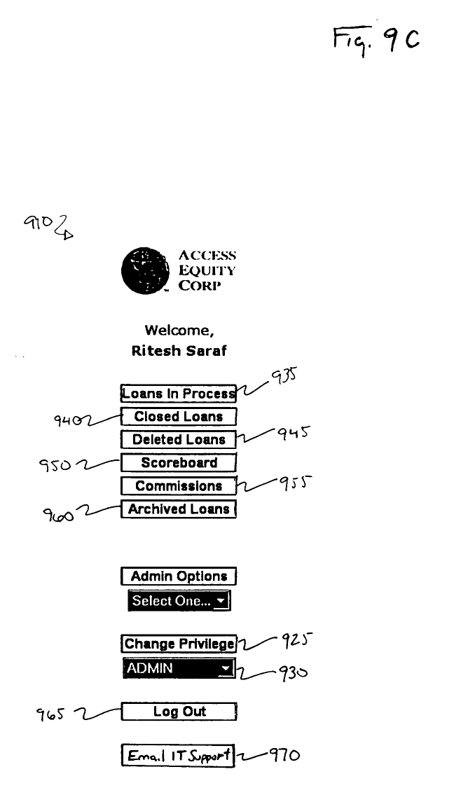

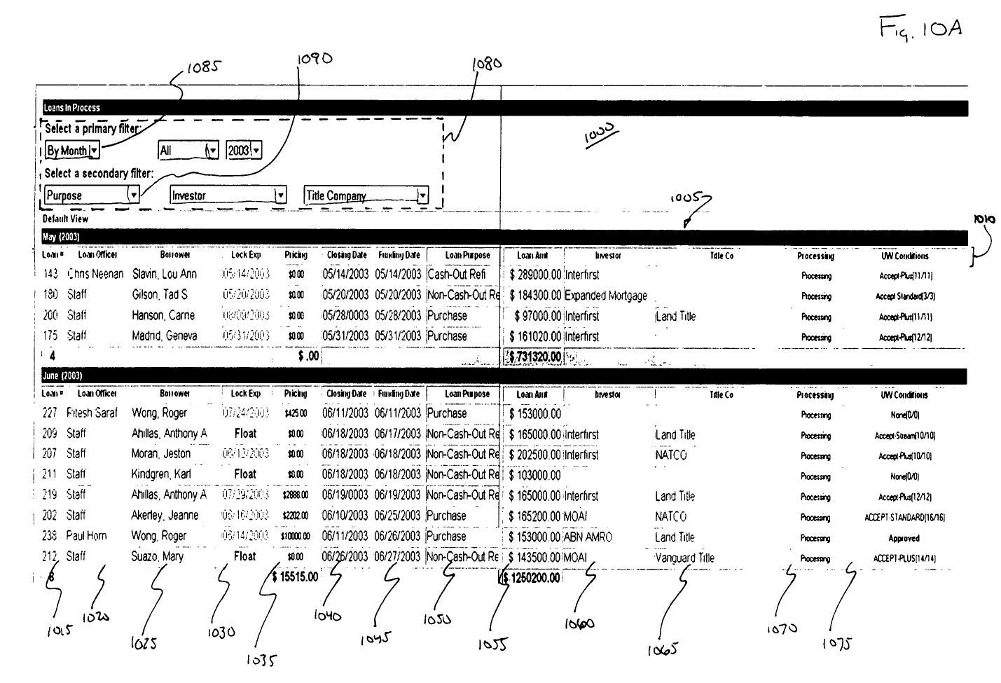

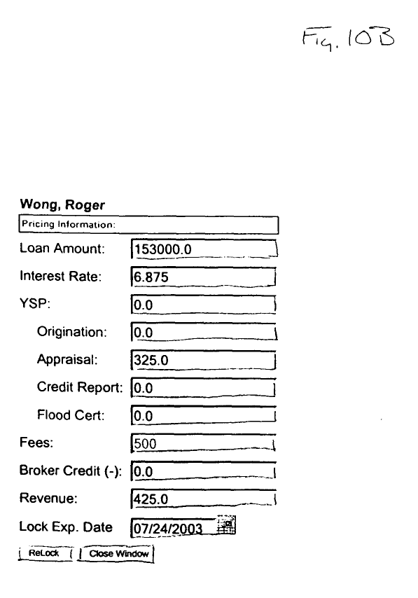

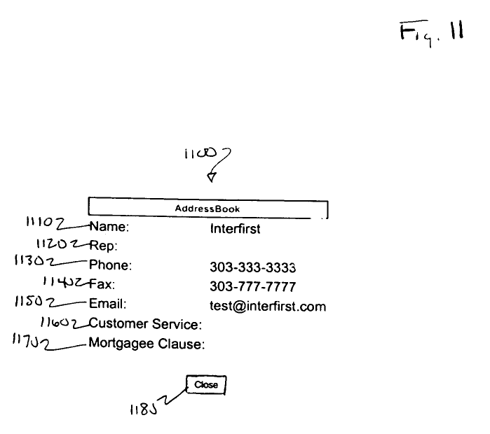

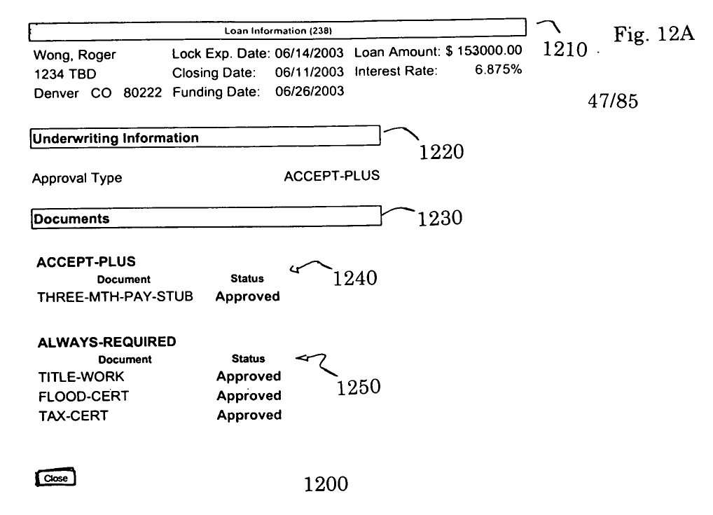

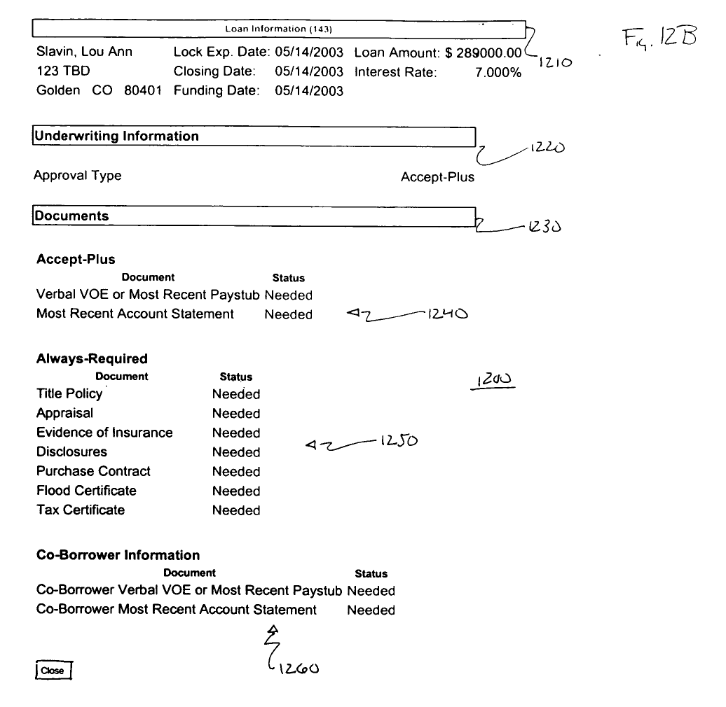

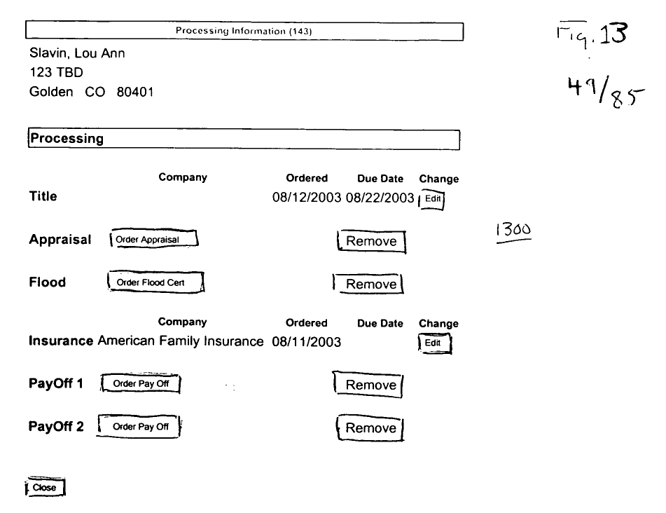

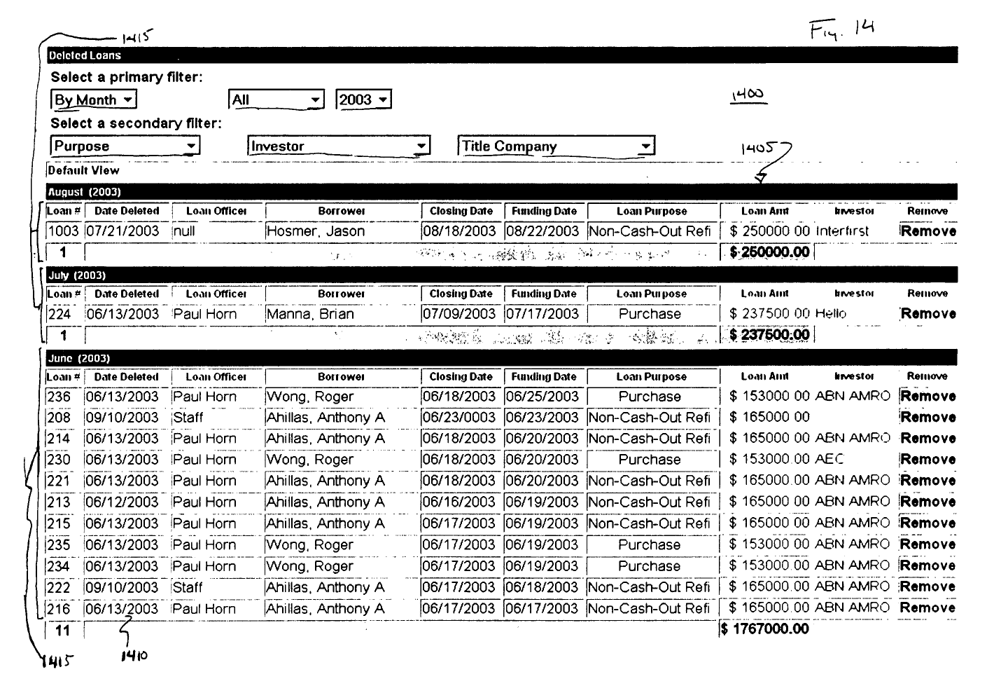

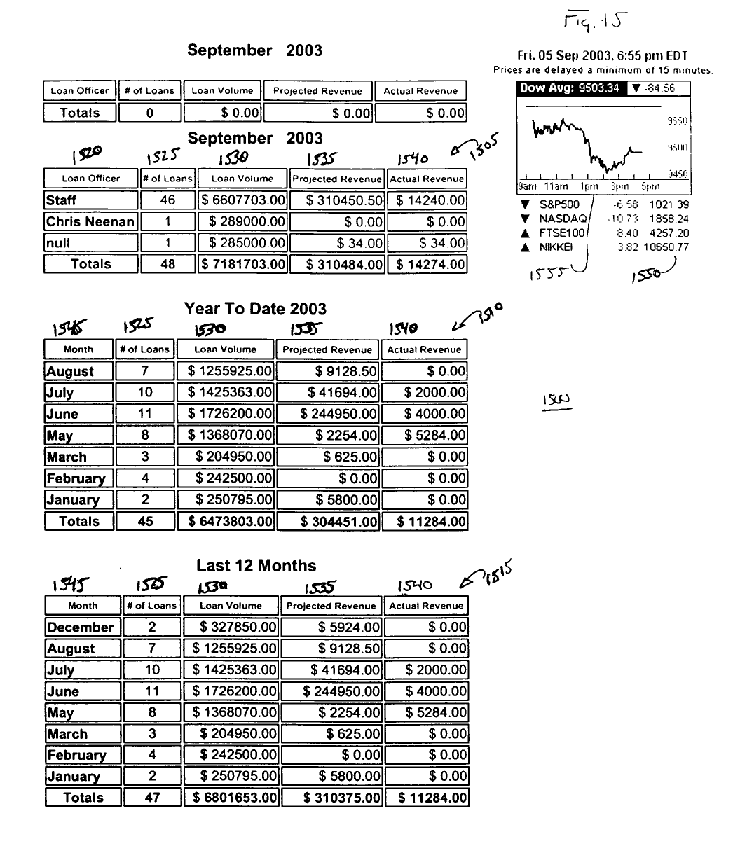

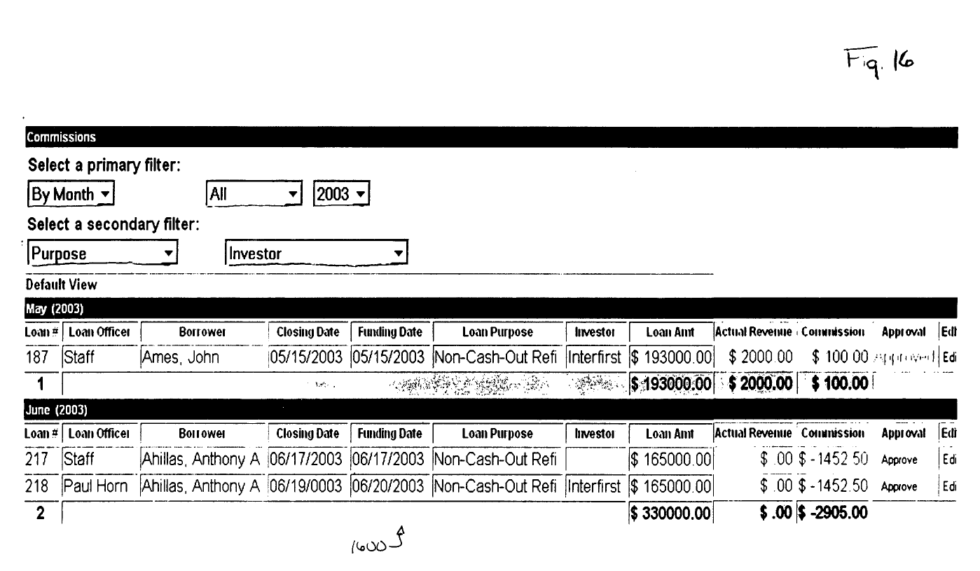

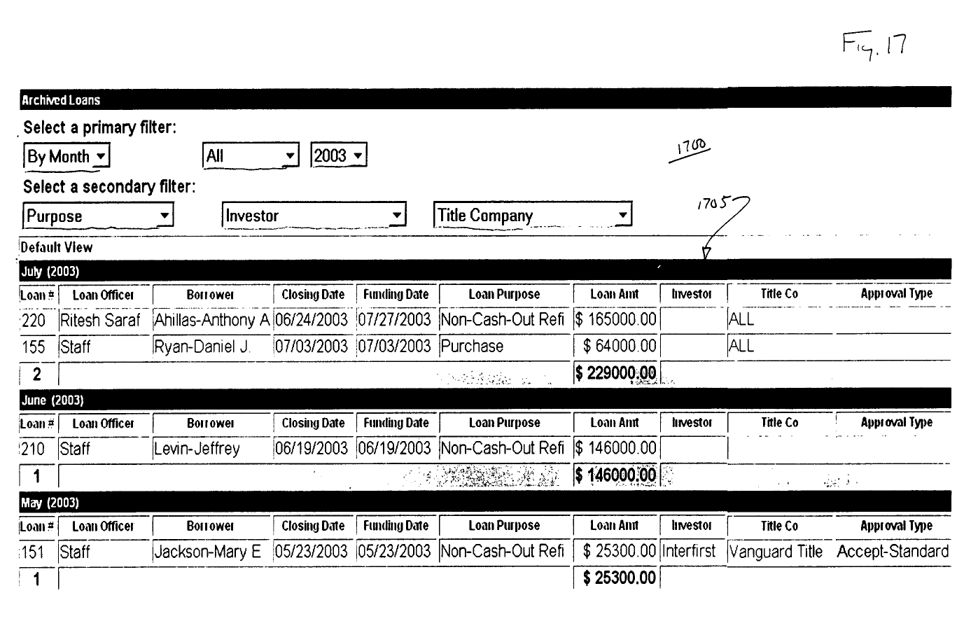

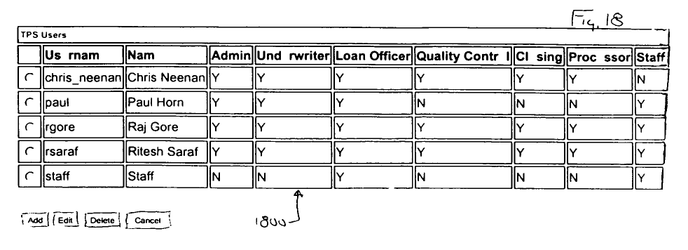

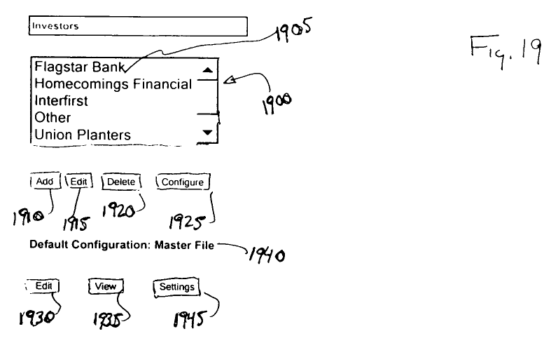

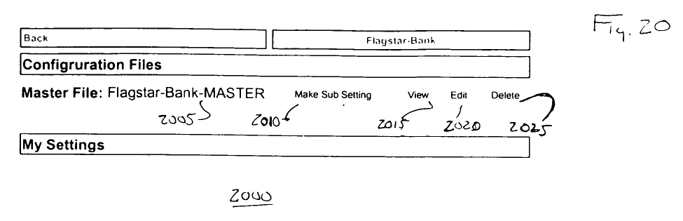

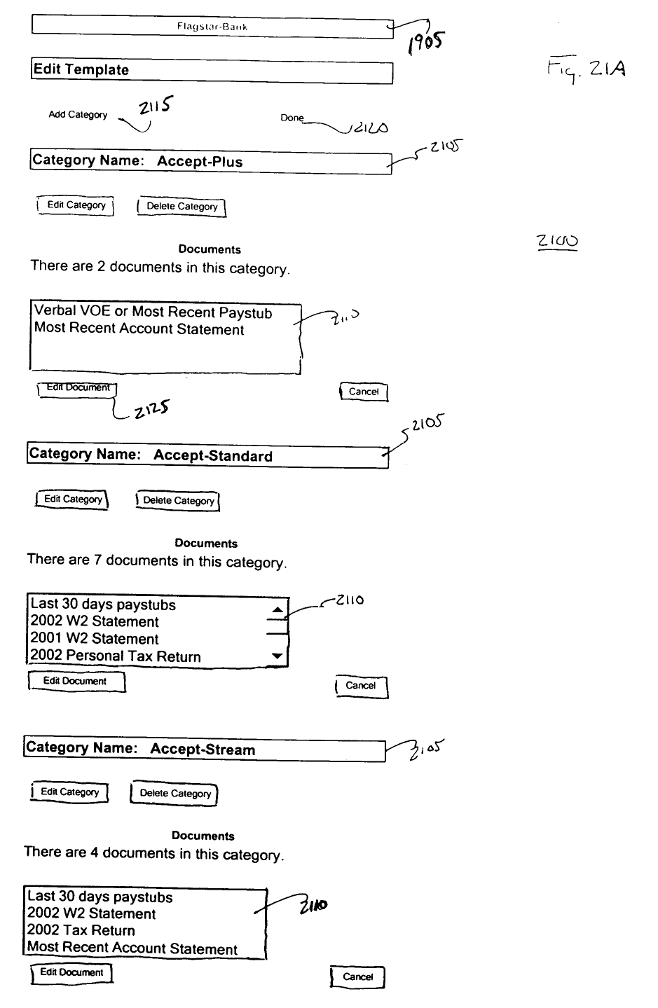

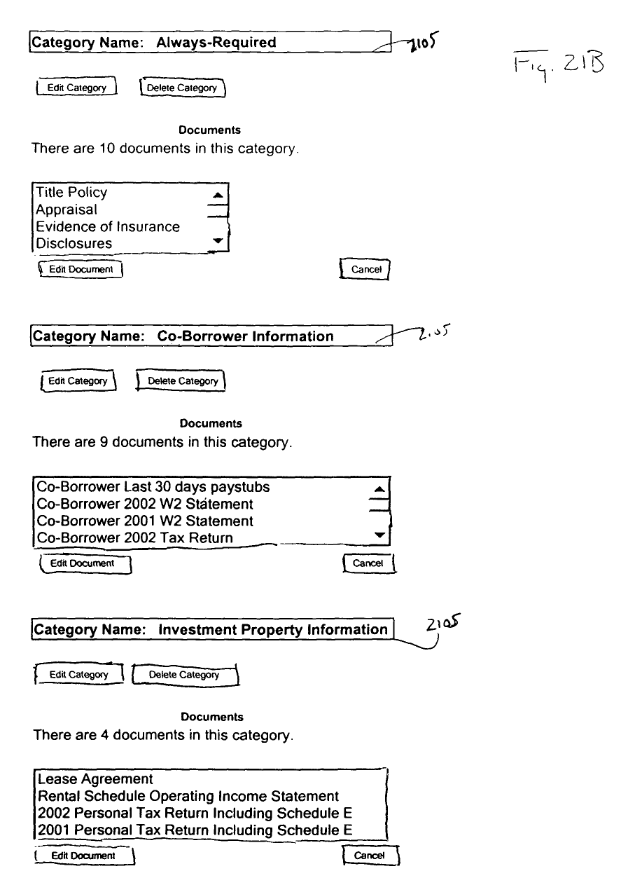

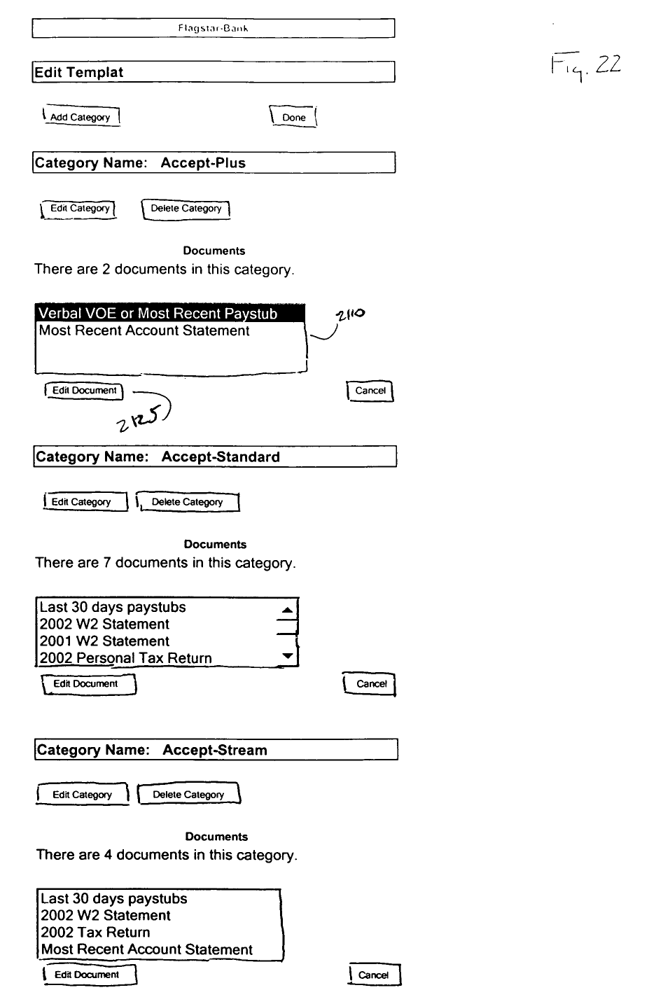

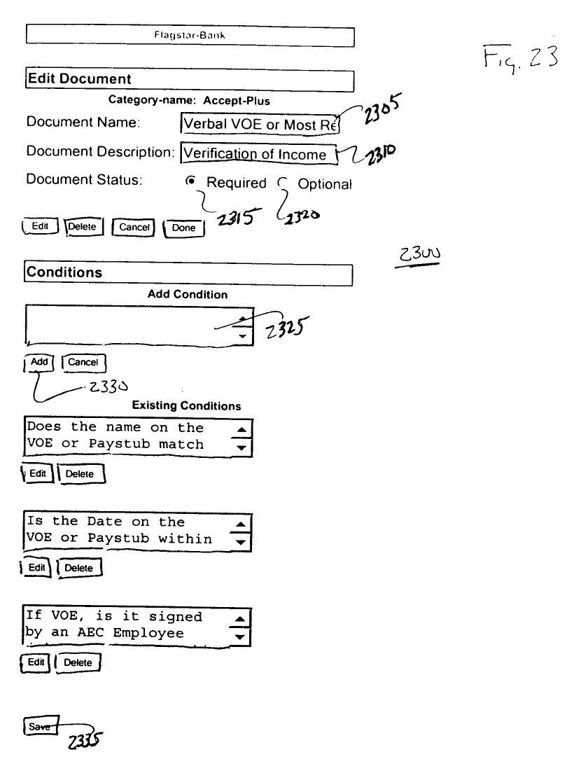

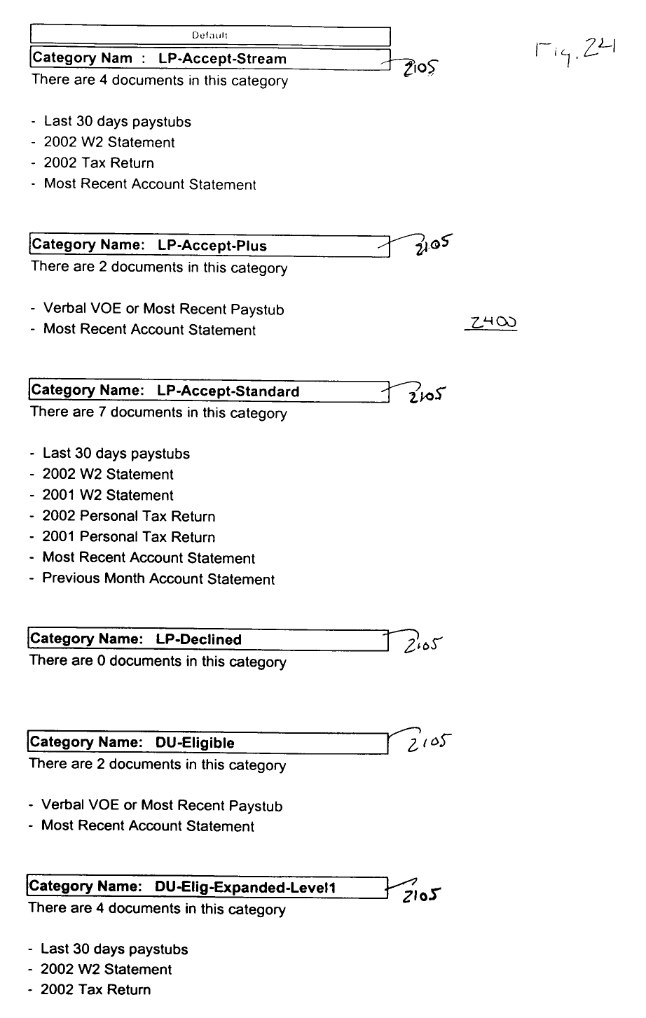

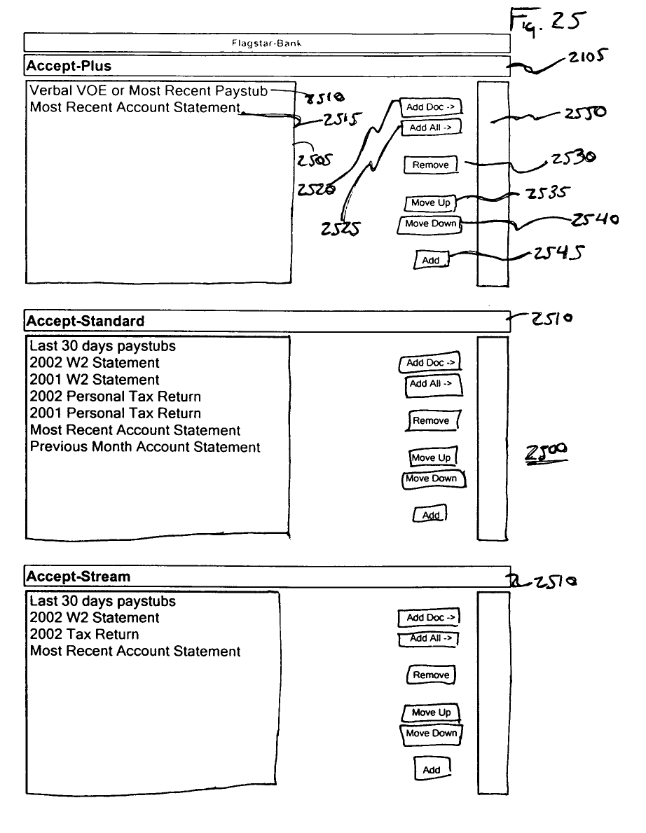

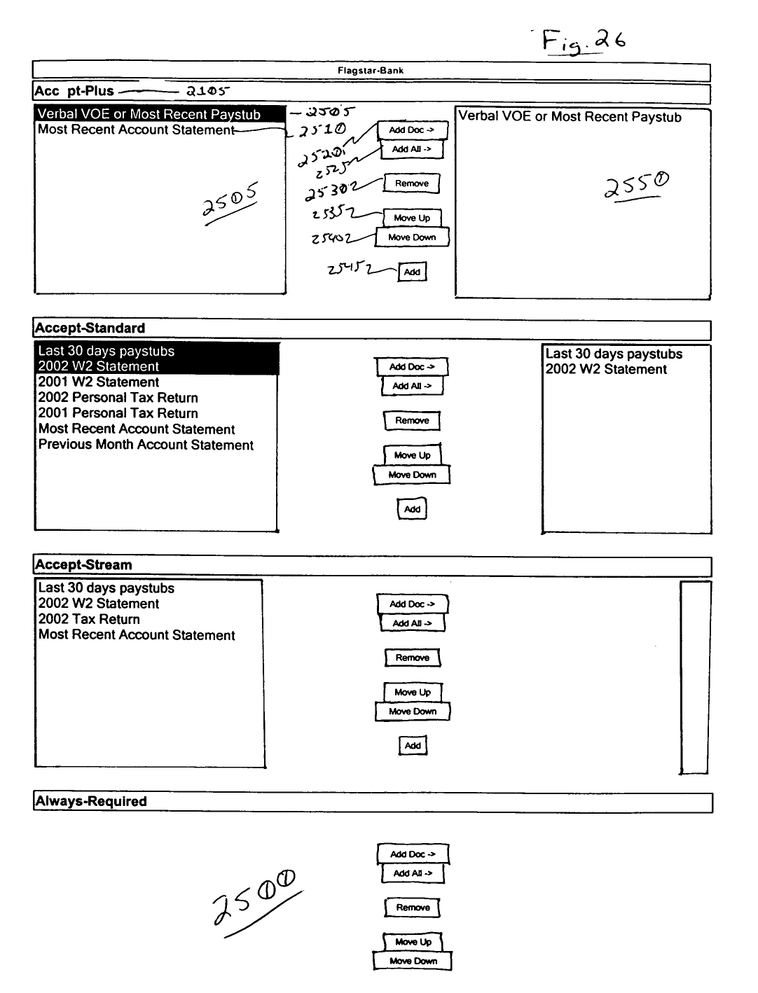

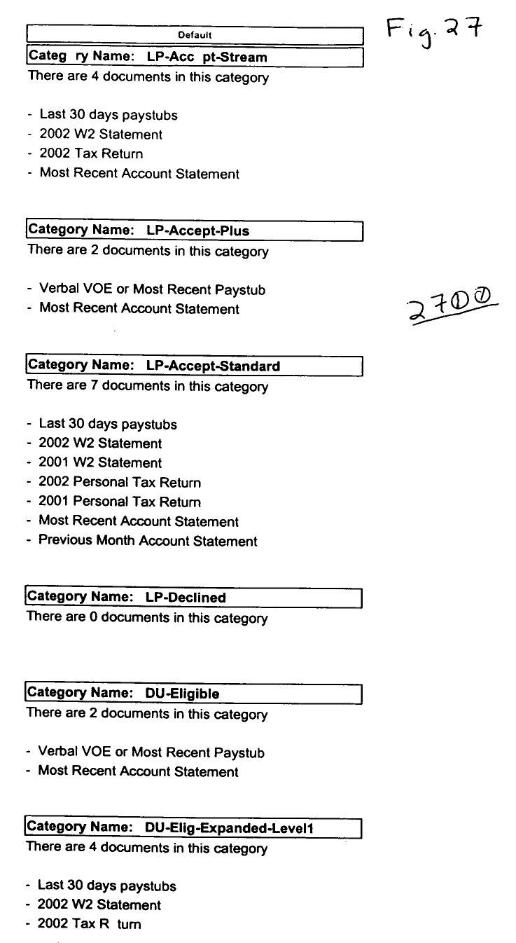

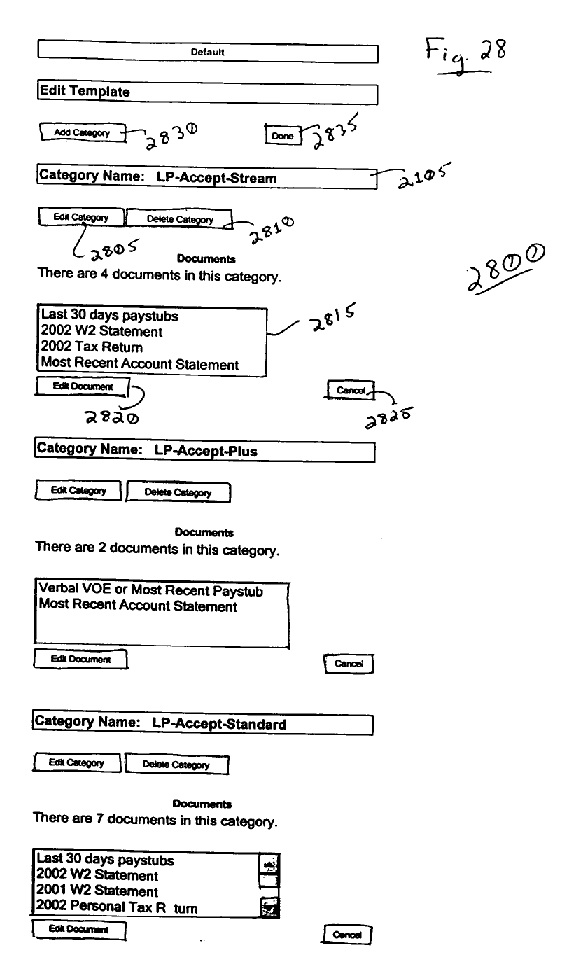

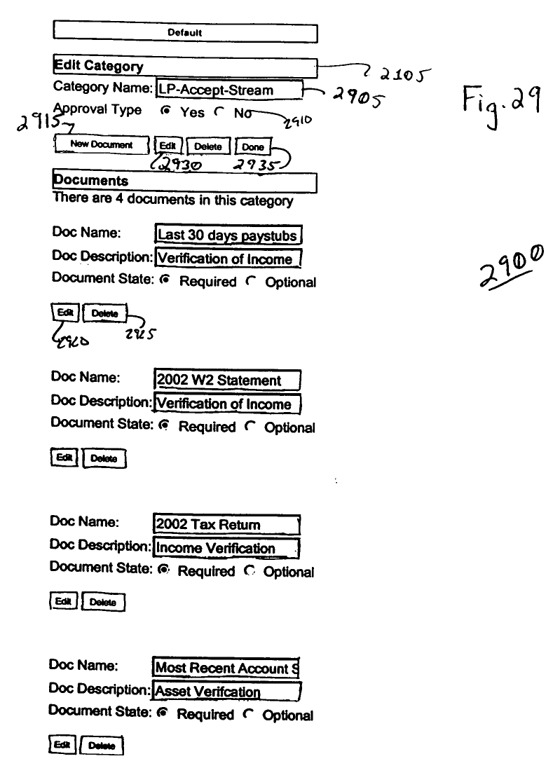

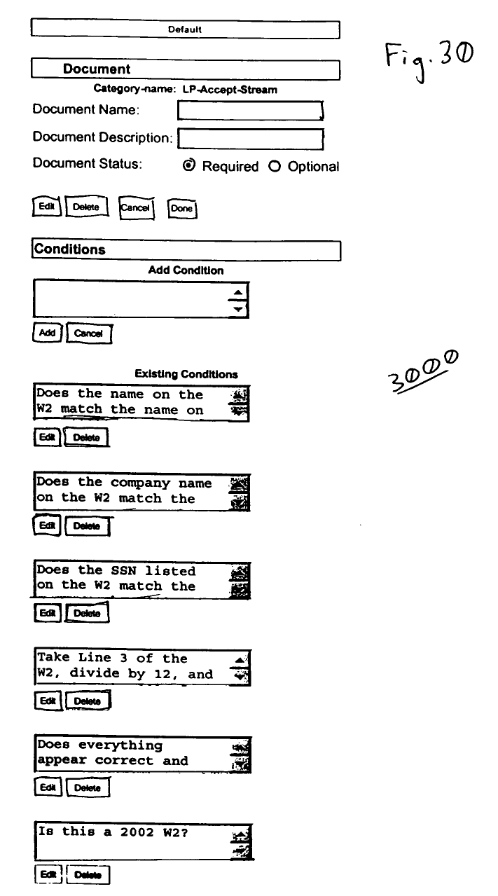

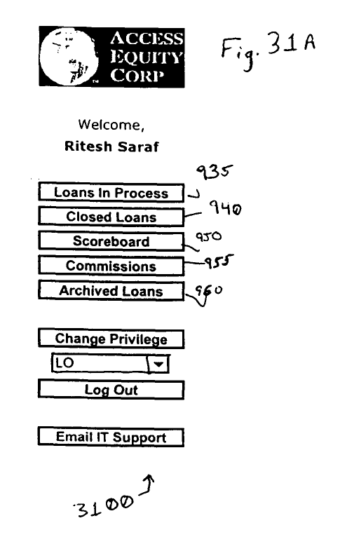

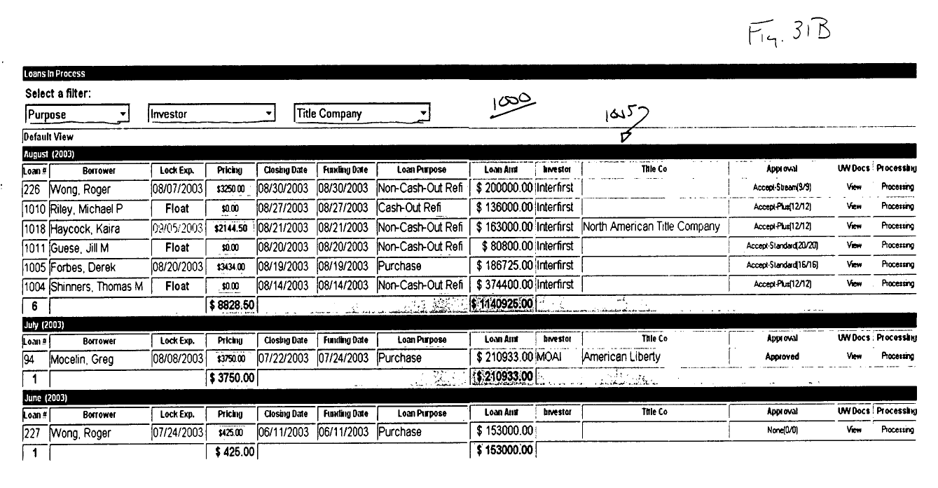

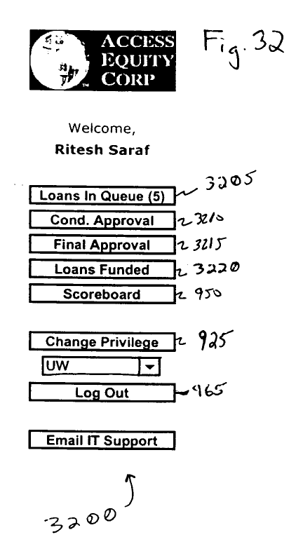

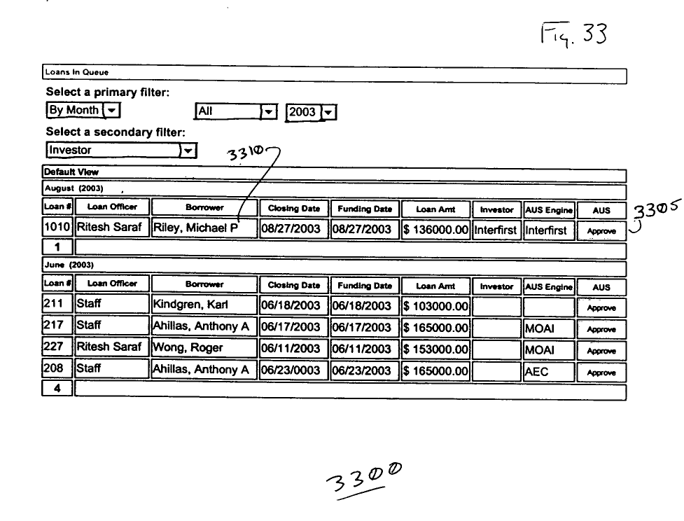

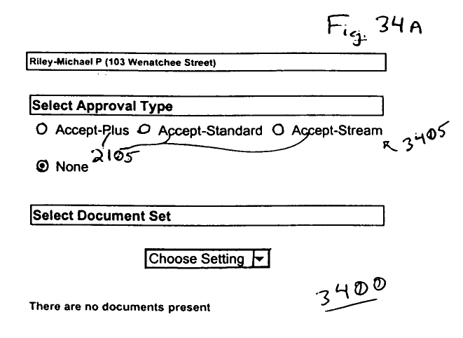

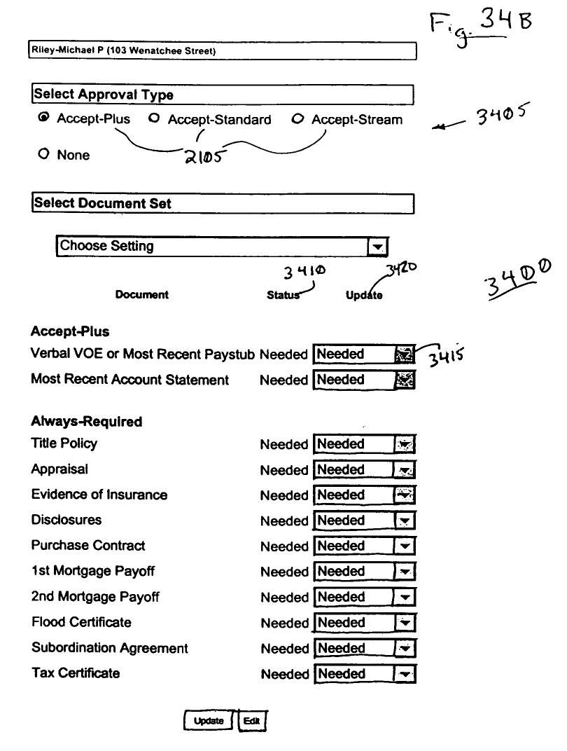

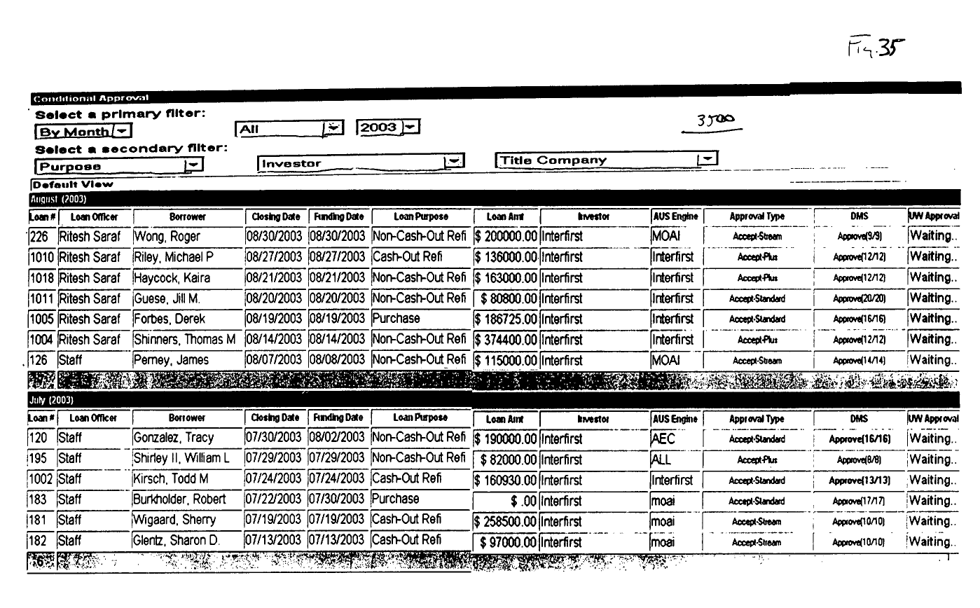

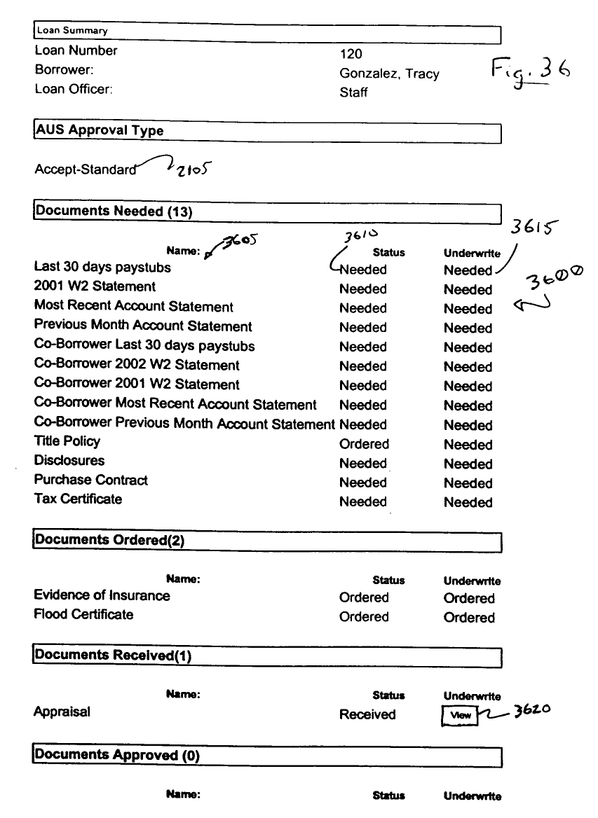

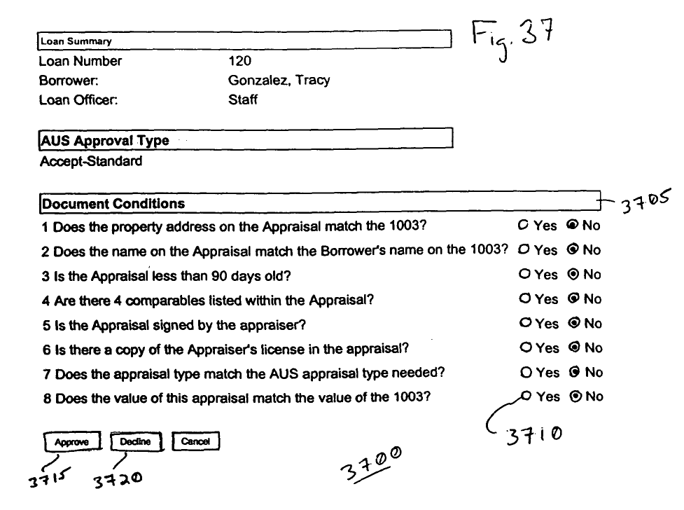

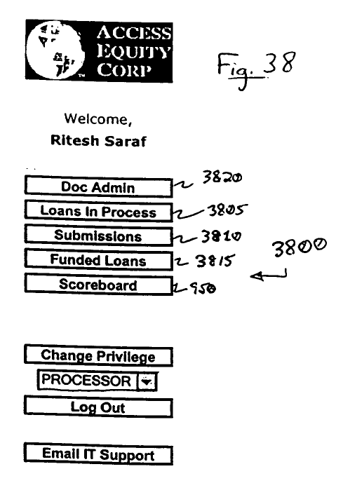

FIG. 2J depicts a screenshot of the loan officer “loans in queue” screen of FIGS. 2A, 2D, and 2E, reflecting the approval of all documents by the underwriter.

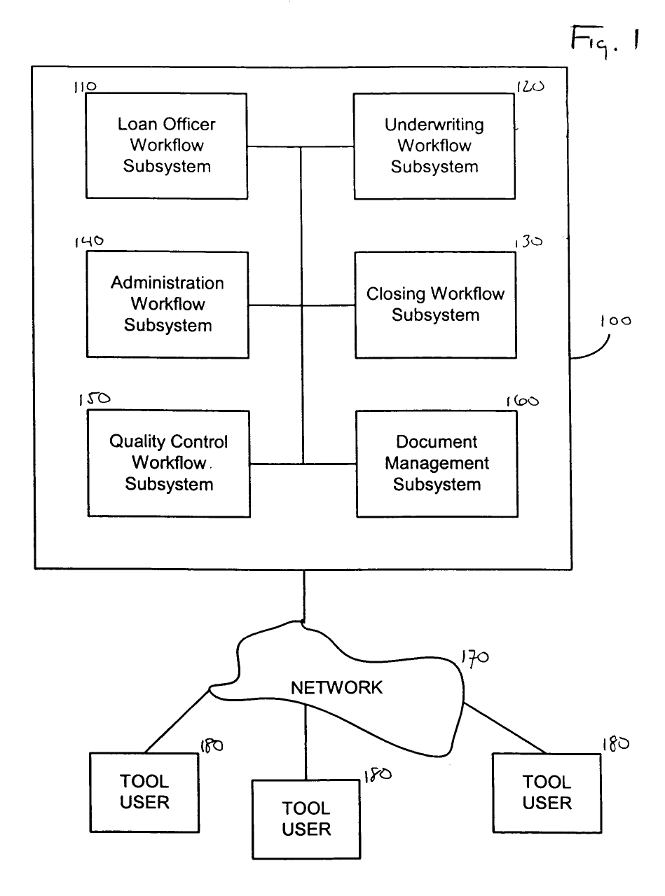

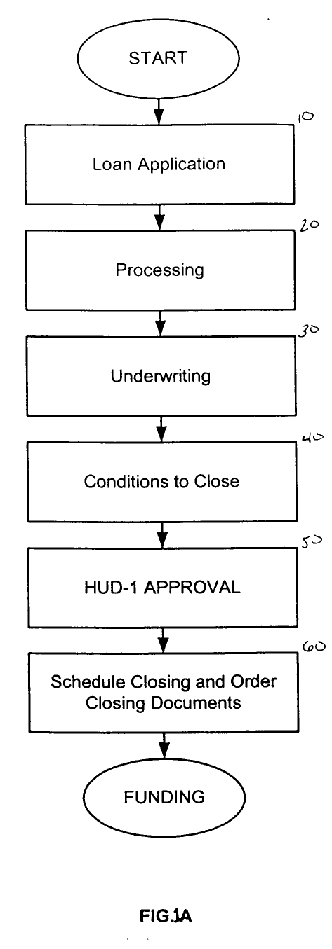

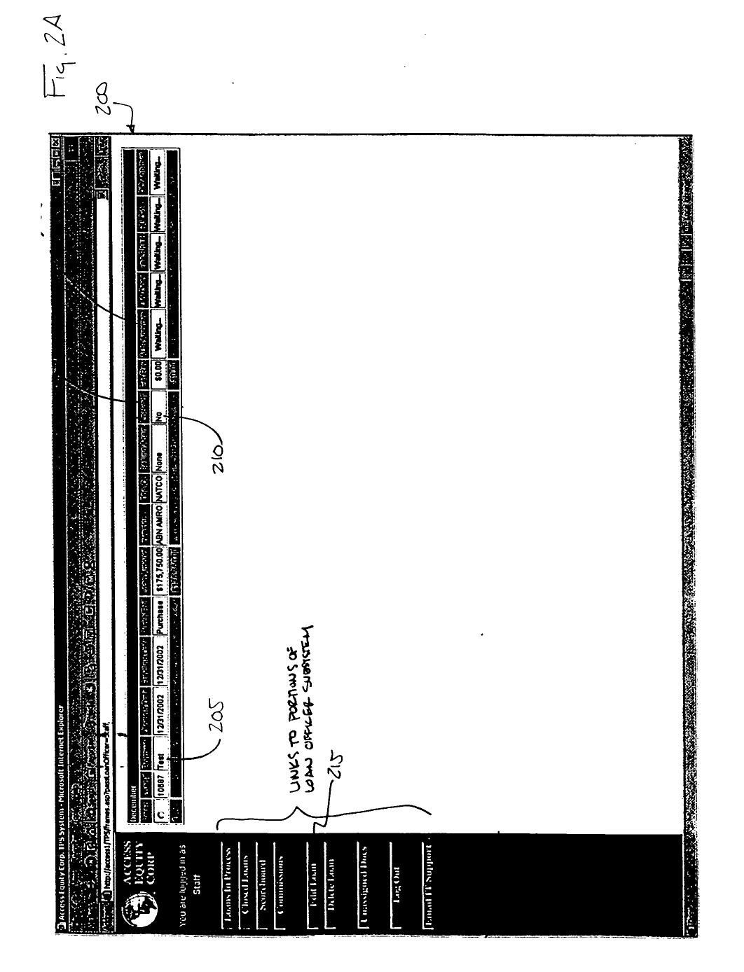

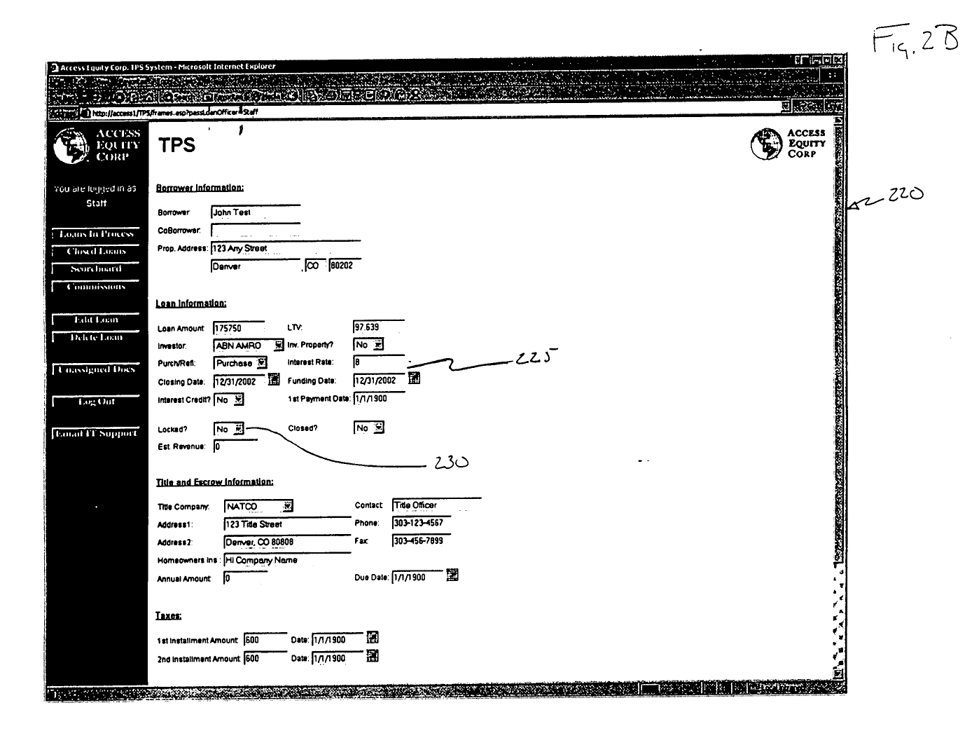

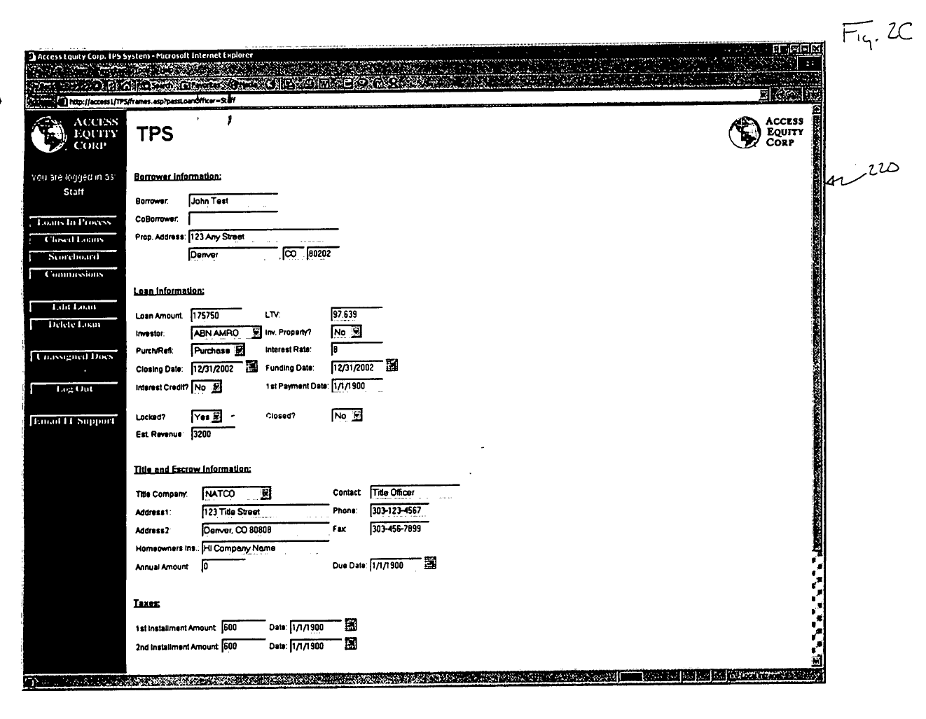

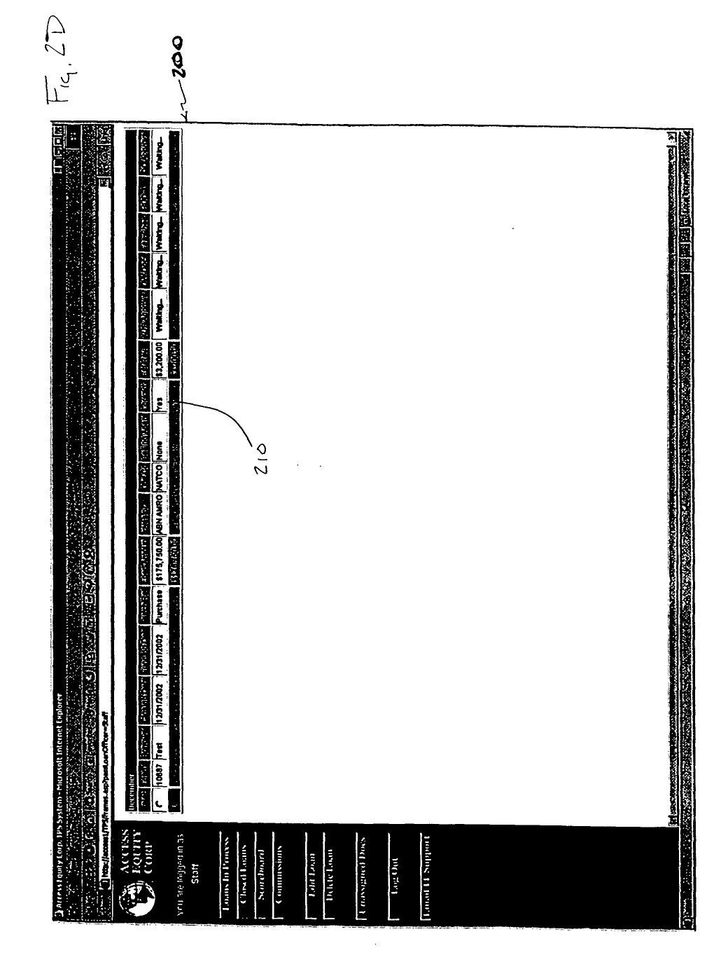

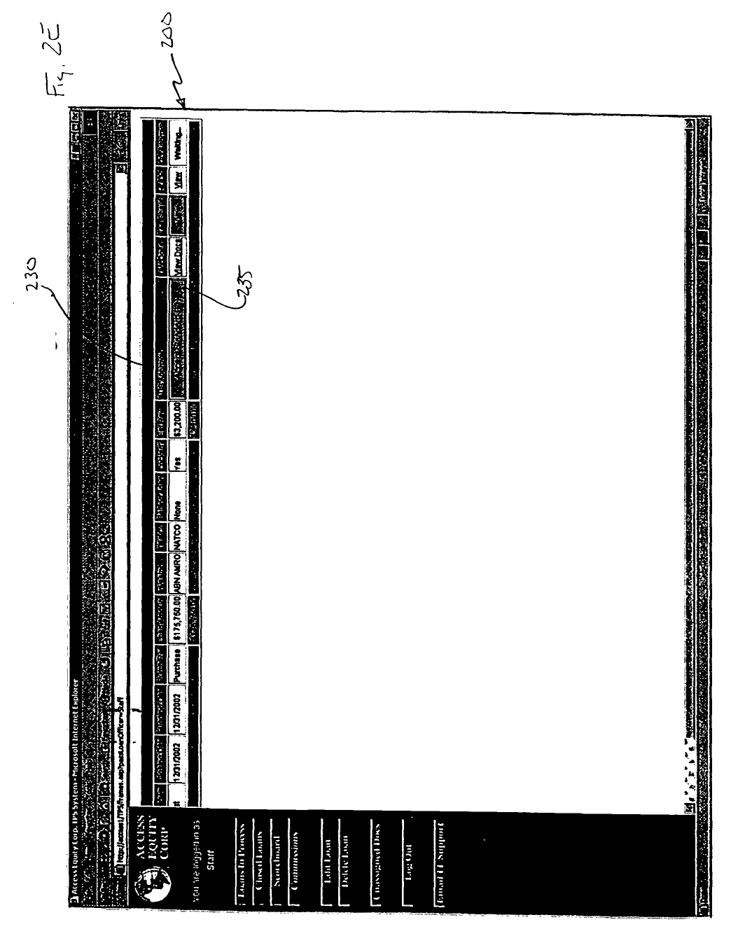

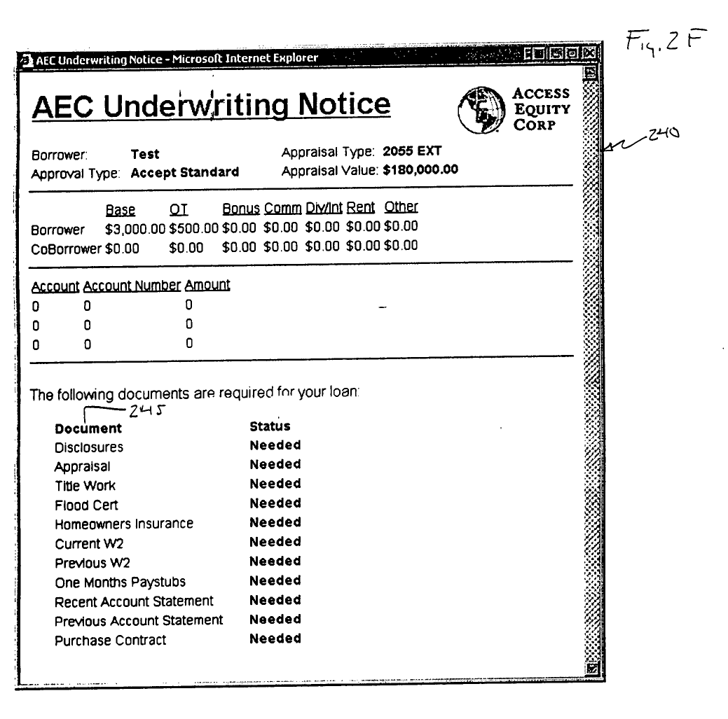

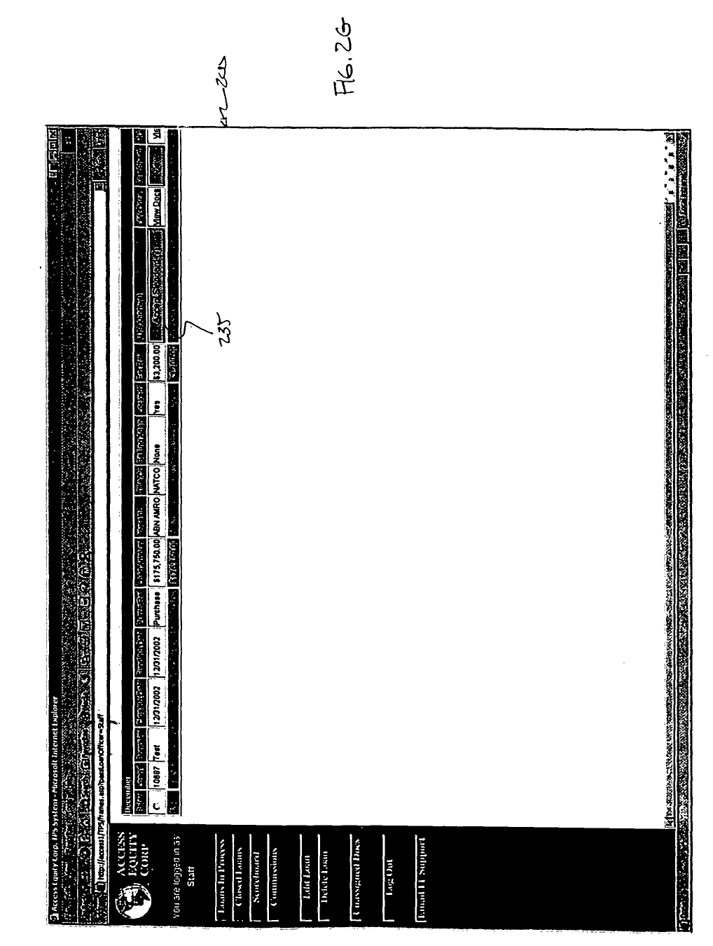

FIG. 2K depicts a screenshot of a fee sheet in accordance with the embodiment of FIG. 1.

FIG. 2L depicts a screenshot of the loan officer “loans in queue” screen of FIGS. 2A, 2D, 2E, and 2J, with the QC column thereof updated.

FIG. 2M depicts a screenshot of the loan officer “Closed Loan” screen, in accordance with the embodiment of FIG. 1.

FIG. 2N depicts a screenshot of the loan officer “Closed Loan” screen of FIG. 2M, updated to reflect the receipt of a check.

FIG. 2-O depicts a loan officer scorecard, in accordance with the embodiment of FIG. 1.

FIG. 3A depicts a screenshot of the underwriting “loans in queue” screen, which is a part of the underwriting subsystem of the embodiment of FIG. 1.

FIG. 3B depicts a screenshot of an approval form, in accordance with the embodiment of FIG. 1.

FIG. 3C depicts a screenshot of a “Conditional Approval” screen, in accordance with the embodiment of FIG. 1.

FIG. 3D depicts a screenshot of a document approval screen, in accordance with the embodiment of FIG. 1.

FIG. 3E depicts a screenshot of the document approval screen of FIG. 3D, illustrating the approval of documents.

FIG. 3F depicts a screenshot of the “Conditional Approval” screen of FIG. 3C, updated to reflect the approval of documents.

FIG. 3G depicts a screenshot of a “Final Approval” screen, in accordance with the embodiment of FIG. 1.

FIG. 3H depicts a second screenshot of the “Final Approval” screen of FIG. 3G.

FIG. 4A depicts a screenshot of the administration “loans in process” screen, which is a part of the administration subsystem of the embodiment of FIG. 1.

FIG. 4B depicts a screenshot of the administration “loans in process” screen of FIG. 4a, updated to reflect an indication that an interest rate was locked.

FIG. 4C depicts a screenshot of an administration “Closed Loans” screen, in accordance with the embodiment of FIG. 1.

FIG. 4D depicts a screenshot of an “Edit Loan” screen, in accordance with the embodiment of FIG. 1.

FIG. 4E depicts a screenshot of an administrator closed loan screen, in accordance with the embodiment of FIG. 1.

FIG. 4F depicts a screenshot of a scorecard screen, in accordance with the embodiment of FIG. 1.

FIG. 4G depicts a second screenshot of a scorecard screen, in accordance with the embodiment of FIG. 1.

FIG. 4H depicts a screenshot of a user screen, in accordance with the embodiment of FIG. 1.

FIG. 4I depicts a third screenshot of a scorecard screen, in accordance with the embodiment of FIG. 1.

FIG. 5A depicts a screenshot of a quality control “Loans in Queue” screen, in accordance with the embodiment of FIG. 1.

FIG. 5B depicts a screenshot of a quality control checklist, in accordance with the embodiment of FIG. 1.

FIG. 5C depicts a screenshot of an updated quality control “Loans in Queue” screen.

FIG. 6 depicts a screenshot of a CALYX POINT loan application, which may be employed with embodiments of the present invention.

FIG. 7 depicts a block diagram illustrating one possible overall workflow using an embodiment of the present invention.

FIG. 8 depicts a screenshot of a loan officer closing and funding page, in accordance with a second embodiment of the invention.

FIG. 9A depicts a screenshot of a login screen, in accordance with the second embodiment of the invention.

FIG. 9B depicts a screenshot of a starting screen, in accordance with the second embodiment of the invention.

FIG. 9C depicts a screenshot of an administrative sidebar, in accordance with the second embodiment of the invention.

FIG. 10A depicts a screenshot of a loan screen, in accordance with the second embodiment of the invention.

FIG. 10B depicts a screenshot of a pricing structure, in accordance with the second embodiment of the invention.

FIG. 11 depicts a screenshot of an investor summary screen, in accordance with the second embodiment of the invention.

FIG. 12A depicts a screenshot of a first loan information screen corresponding to a first investor, in accordance with the second embodiment of the invention.

FIG. 12B depicts a screenshot of a second loan information screen corresponding to a second investor, in accordance with the second embodiment of the invention.

FIG. 13 depicts a screenshot of a processing information screen, in accordance with the second embodiment of the invention.

FIG. 14 depicts a screenshot of a “Deleted Loans” screen, in accordance with the second embodiment of the invention.

FIG. 15 depicts a screenshot of a scoreboard screen, in accordance with the second embodiment of the invention.

FIG. 16 depicts a screenshot of a commissions table, in accordance with the second embodiment of the invention.

FIG. 17 depicts a screenshot of an archived loans screen, in accordance with the second embodiment of the invention.

FIG. 18 depicts a screenshot of a user list, in accordance with the second embodiment of the invention.

FIG. 19 depicts a screenshot of an investor list, in accordance with the second embodiment of the invention.

FIG. 20 depicts a screenshot of an investor configuration screen, in accordance with the second embodiment of the invention.

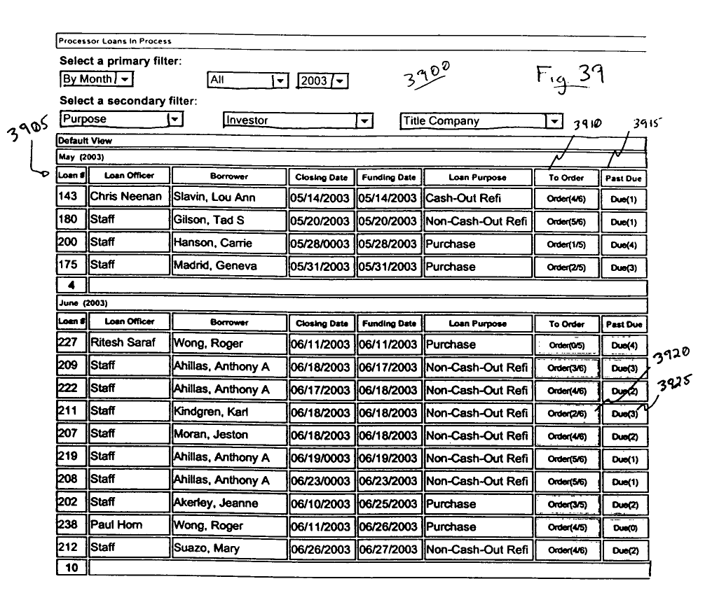

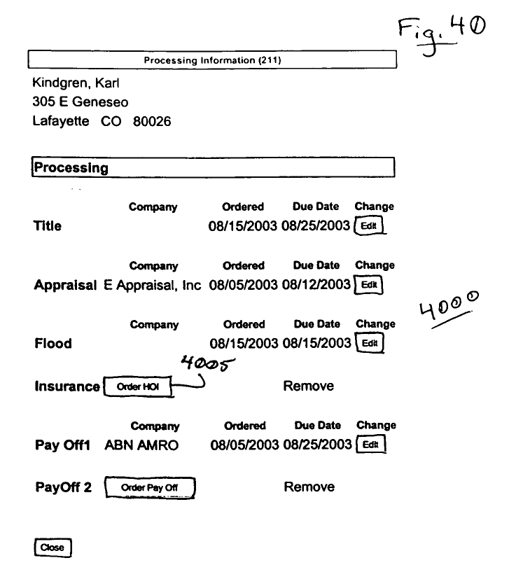

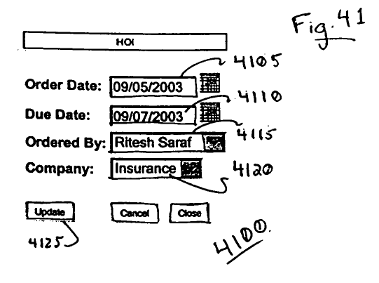

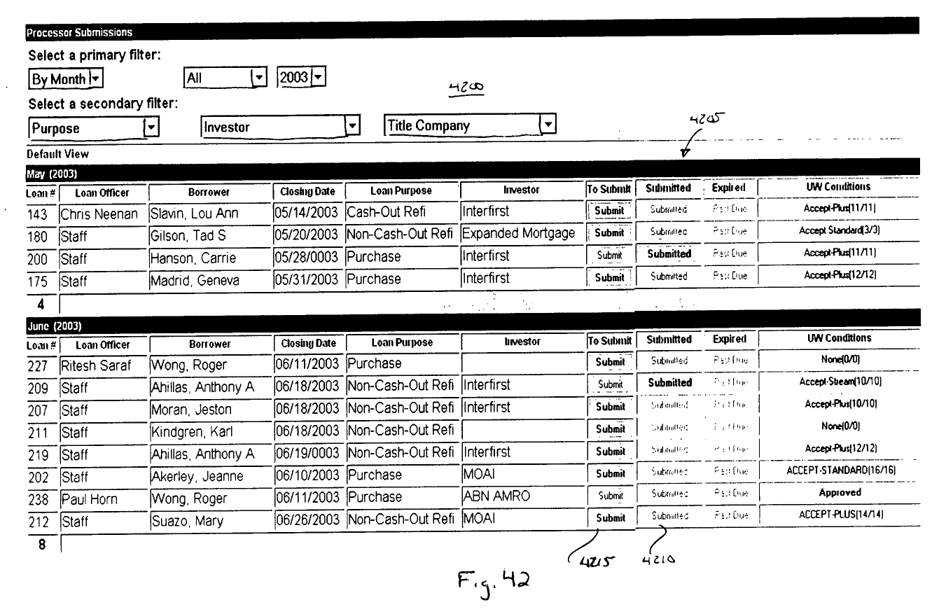

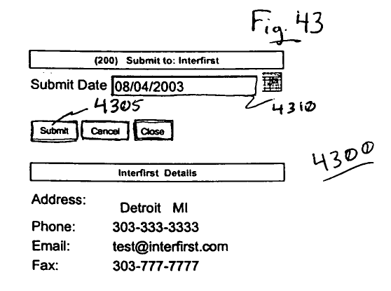

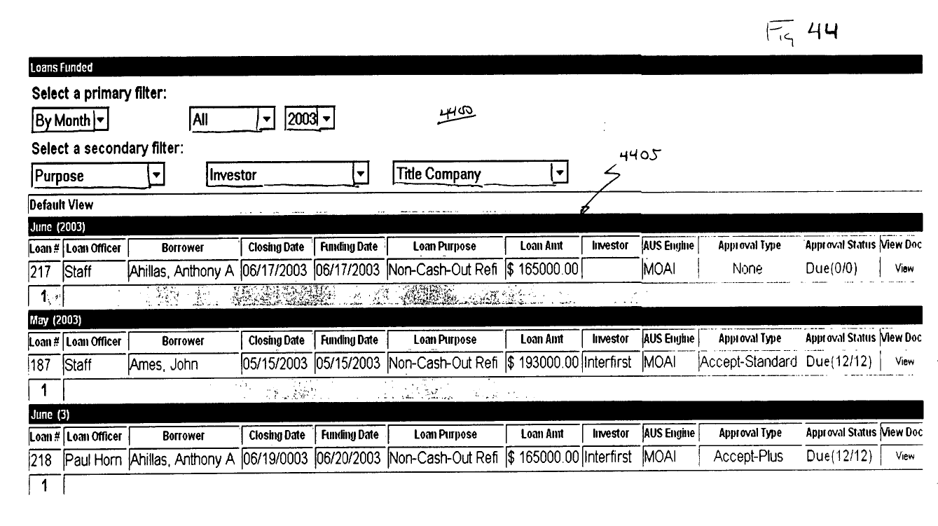

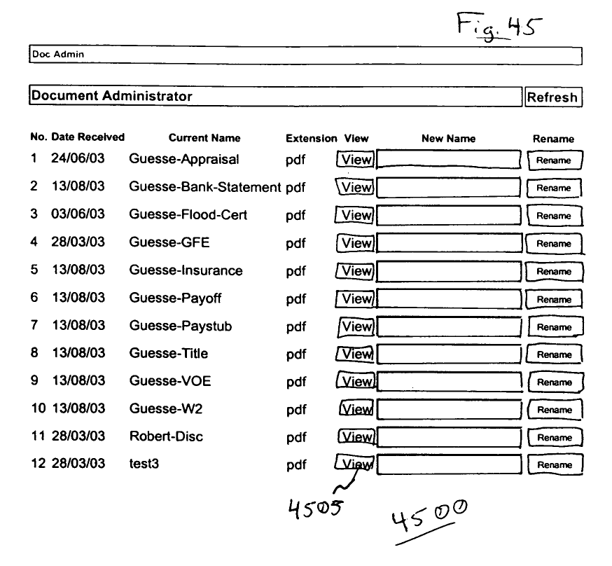

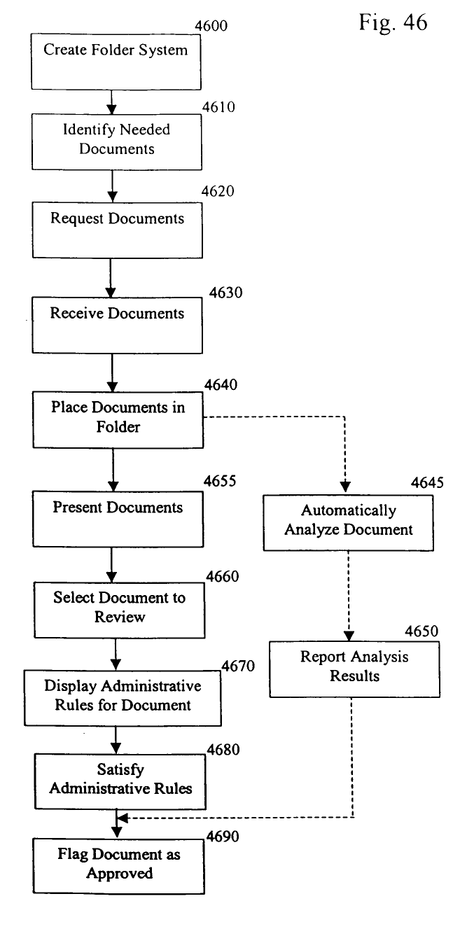

FIG. 21A depicts a screenshot of an edit template screen, in accordance with the second embodiment of the invention.

FIG. 21B depicts a second screenshot of an edit template screen, displaying additional approval categories, in accordance with the second embodiment of the invention.

FIG. 22 depicts a screenshot of the edit template screen of FIG. 21A, with a document highlighted.

FIG. 23 depicts a screenshot of a document editing screen, in accordance with the second embodiment of the invention.

FIG. 24 depicts a screenshot of an approval category screen, in accordance with the second embodiment of the invention.

FIG. 25 depicts a screenshot of a sub-setting dialog, in accordance with the second embodiment of the invention.

FIG. 26 depicts a screenshot of the sub-setting dialog of FIG. 25, with a document selected.

FIG. 27 depicts a screenshot of a master template, in accordance with the second embodiment of the invention.

FIG. 28 depicts a screenshot of an edit template dialog, in accordance with the second embodiment of the invention.

FIG. 29 depicts a screenshot of an edit category dialog, in accordance with the second embodiment of the invention.

FIG. 30 depicts a screenshot of a new document screen, in accordance with the second embodiment of the invention.

FIG. 31A depicts a screenshot of a loan officer sidebar, in accordance with the second embodiment of the invention.

FIG. 31B depicts a screenshot of a loan screen 1000 and loan table 1005 for a specific loan officer, in accordance with the second embodiment of the invention.

FIG. 32 depicts a screenshot of an underwriter sidebar, in accordance with the second embodiment of the invention.

FIG. 33 depicts a screenshot of a “loans in queue” screen, in accordance with the second embodiment of the invention.

FIG. 34A depicts a screenshot of a loan approval dialog, in accordance with the second embodiment of the invention.

FIG. 34B depicts a screenshot of the loan approval dialog of FIG. 34A, with an approval category selected.

FIG. 35 depicts a screenshot of a conditional approval screen, in accordance with the second embodiment of the invention.

FIG. 36 depicts a screenshot of a loan summary table, in accordance with the second embodiment of the invention.

FIG. 37 depicts a screenshot of a document approval dialog, in accordance with the second embodiment of the invention.

FIG. 38 depicts a screenshot of a processor toolbar, in accordance with the second embodiment of the invention.

FIG. 39 depicts a screenshot of a processor “loans in process” screen, in accordance with the second embodiment of the invention.

FIG. 40 depicts a screenshot of a processing information screen, in accordance with the second embodiment of the invention.

FIG. 41 depicts a screenshot of a document ordering dialog, in accordance with the second embodiment of the invention.

FIG. 42 depicts a screenshot of a processor submissions screen, in accordance with the second embodiment of the invention.

FIG. 43 depicts a screenshot of a loan submission screen, in accordance with the second embodiment of the invention.

FIG. 44 depicts a screenshot of a funded loans screen, in accordance with the second embodiment of the invention.

FIG. 45 depicts a screenshot of a document administration screen, in accordance with the second embodiment of the invention.

FIG. 46 is a flowchart depicting exemplary operations for a document verification system, in accordance with the second embodiment of the invention.

### DETAILED DESCRIPTION OF THE INVENTION

1. General Overview of the Embodiment

Embodiments of the present invention provide a comprehensive document and workflow management tool for use in various industries. In one particular embodiment discussed herein, the present invention provides a comprehensive computer-implemented document and workflow management tool (the “Tool”) for a mortgage brokerage, or other financial institution, to process a mortgage loan application. By using this embodiment, a loan officer and underwriter may perform some or all aspects of their work at the same or similar times, i.e., in parallel. Thus, the time from when a loan is applied for to the time when the final loan is approved by the mortgage loan broker and submitted to the lender can be dramatically reduced as compared to conventional methods. Moreover, embodiments of the present invention allow the mortgage loan broker to submit the loan to the investor with a high degree of confidence that all of the loan documents are accurate and complete.

The present invention is described below with reference to one particular embodiment, i.e., the Tool, for use by a mortgage brokerage to manage the loan application process. The present invention, however, is adaptable to many other embodiments. For example, an embodiment of the present invention may be used to manage car sales at a car dealership or to manage a franchisee/franchisor relationship.

Generally, the Tool takes the form of one or more computer-executable instructions, for example software modules or data structures. The Tool (and other embodiments discussed herein) may be implemented on any manner of computing devices, including personal computers, minicomputers, macrocomputers, servers, web tablets, personal digital assistants, portable computing devices, wireless devices, wired devices, and any other devices having sufficient computing capability.

Referring now to the embodiment of the present invention for use by a mortgage brokerage, generally, a comprehensive document and workflow management tool (FIG. 1) 100 is provided that provides coordinated workflow and document management in the brokerage. The Tool includes a loan officer workflow subsystem 110 (FIGS. 2A-2-O), an underwriter workflow subsystem 120 (FIGS. 3A-3H), a closing workflow subsystem 130, an administration subsystem 140 (FIGS. 4A-4I), a quality control workflow subsystem 150 (FIGS. 5A-5C), and a document management subsystem 160. The Tool may be connected with a network 170 for access and use by a plurality of users 180. The network may be an intranet, Internet, local area network (LAN), wide area network (WAN), wireless network, infrared or radio frequency network, cellular network, land-line network, plain old telephone system (POTS) network, packet switched network, Internet protocol (EP) network, or any other network permitting access by a plurality of users 180. Access to the Tool 100 may be provided through any device disclosed above, as well as through telephones, cellular telephones, pagers, wireless devices, wired devices, and so forth.

In some mortgage brokerages, many different people may assume the roles of loan officer, underwriter, closer, quality controller, and administrator and use the associated subsystems of the Tool. However, the same people may perform a combination of the roles.

At a high level, the various modules (subsystems) of the embodiment operate as follows. The loan officer subsystem 110 is used to manage the acquisition of the required documents. The underwriting subsystem 120 is used to manage the internal underwriting of the loan application. The quality control subsystem 150 is used as an extension of the underwriting subsystem to further verify and validate the loan application. The closer subsystem 130 is used to manage the closing. Finally, the administration subsystem 140 is used to manage the overall loan application process along with the underwriters and loan officers working to process loan applications.

2. Loan Processing

The present invention will now be described with reference to the processing of a loan in the system from the point that the loan is applied for by a prospective borrower, i.e., the applicant, to the point at which the loan is approved for submission to the investor that will ultimately fund the loan. Other aspects of the invention will also be described such as the general administration of the loan and the loan officer and underwriter workload and commissions.

Before loan processing may begin, the loan information is exported to the Tool 100. In one example, the loan application is uploaded to a CALYX POINT loan application 600 or other loan application submission tool. FIG. 6 illustrates a screenshot of a CALYX POINT loan application 600, which may be employed with embodiments of the present invention. The loan application includes the applicant's name 610, address 620, contract information 630, the type of loan 640 the applicant is applying for, the purpose of the loan 650, the price of the property 660 that the applicant seeks to purchase with the mortgage loan funds, the applicant's income 670, and any other information typically found in a mortgage loan application and likely required to obtain a mortgage loan. Upon completion of the CALYX POINT loan application or other suitable electronic loan application (including, for example, electronically scanned loan applications), the loan application information is exported to the Tool.

Upon exportation of the loan application 600 to the Tool 100, presence of the newly exported loan application is illustrated in the loan officer subsystem 110, the underwriting subsystem 120, and the administration subsystem 140. FIG. 2A illustrates a screenshot of a loan officer “loans in process” screen 200, which is part of the loan officer subsystem, after the loan application is first exported to the Tool. FIG. 3A illustrates a screenshot of the underwriting “loans in queue” screen 300, which is a part of the underwriting subsystem 120, after the loan application is first exported to the Tool 100. FIG. 4A is a screenshot of the administration “loans in process” screen 400, which is a part of the administration subsystem 140, after the loan application 600 is first exported to the Tool. It can be seen that the various screens include various columns and information for each loan. For example, there is a borrower column 205, 305, 405, where the name of the borrower is illustrated. However, not all of the columns in all of the screens are the same. The various columns and the information provided therein will be described throughout.

In the example, it can be seen in FIGS. 2A, 3A, and 4A, that the loan application number is “10687,” and the borrower is denoted as “Test.” This information will remain the same throughout the various screenshots shown herein so that the coordinated workflow may be better recognized in the various screenshots. Referring now to FIG. 2A, it can be seen under the column “locked” 210 that the interest rate for the loan that Test is applying for has not been locked. To lock the interest rate for the loan, the loan officer will select the “edit loan” link 215 on the left side of the “Loans in Process” screen 200 shown in FIG. 2A, which will launch the “edit loan” screen 220 illustrated in FIG. 2B. The edit loan screen 220 includes most or all of the information for the loan that was submitted in the loan application 600. In the edit loan screen all or some of the original loan application may be edited or additional information for the loan may be added or changed. In particular, the edit loan screen 220 includes an interest rate window 225 where the loan officer indicates the interest rate for the loan and a “locked?” drop down menu 230 where the loan officer indicates that the interest rate was locked. FIG. 2C is a screenshot of the edit loan screen 220 after the loan officer has indicated that the loan is locked at an interest rate of 8%.

When the new loan application 600 is exported to the Tool 100, it is also submitted to an automated underwriting submission (AUS), such as is provided by Mortgages Online at InterFirst (MOAI) for processing. The AUS will return a list of conditions for the loan application being applied for. In addition, when the new loan application 600 is first exported to the Tool 100, a new folder is automatically generated where all documents relating to the loan will eventually be saved.

When the interest rate is locked, an “update” button at the bottom of the screen (not shown) is selected, which causes the loan information on the loan officer screen 200 and the administration screen 400 to change. FIG. 2D is a screenshot of the loan officer “loans in queue” screen 200 and FIG. 4B is a screenshot of the administrator “loans in process” screen 400, both updated to reflect the indication that the interest rate was locked by illustrating “Yes” in the “locked?” 210, 410, column. (As used herein, the terms “loans in queue” and “loans in process” are essentially synonymous, except where clearly indicated otherwise through text or figures.)

When the interest rate is locked, the underwriter begins working with the loan. In one alternative embodiment, the underwriting “loan in queue” screen 300 will not include a new loan until the loan has been locked or it will include an indication that the loan is locked similar to the loan officer 200 or administrator screens 400. Referring to FIG. 3A, to begin underwriting the loan, the underwriter selects the “Approve” button 310 in the “AUS approval column” 315 of the “Loans in Queue” screen 300. The selection of the Approval button will launch the AUS approval form 320, an example screenshot of which is illustrated in FIG. 3B. The initial AUS approval form as shown in FIG. 3B is generated from the conditions returned by the AUS system.

Broadly, the AUS approval form 320 includes an AUS approval category 325 section, a dollar amounts to be verified 330 section, an asset information 335 section, and an additional conditions 340 section. The AUS approval category section includes a list of AUS approval categories that may be selected as the projected or actual approval category required by the investor to whom the broker has or will submit the loan. Typically, when the loan amount and interest rate are locked, the broker will present the loan to the investor and obtain the AUS approval category 325 required for the loan. Although, in some instances presentation of the loan to the investor is not required because the broker may know in advance what AUS approval category the investor will require. In this example, the underwriter has selected the “Accept Standard” 345 AUS approval category 325.

The AUS approval form 320 also includes a list of conditions for the loan. The conditions are illustrates in the “$ amounts to be verified” 330 section and the “Additional Conditions” 340 section. The additional conditions section allows the brokerage underwriter to add conditions for the loan. The AUS approval form also includes an “Asset Information” 335 section listing the accounts 350, account numbers 355, and amounts 360 in those accounts as originally submitted by the applicant on the loan application. This information may be edited and revised either in the AUS approval screen 320 or in the edit loans screen 220.

By selecting the “update” button 365, the loan officer screen 200 is updated to reflect the AUS approval, and the loan moves from the underwriter “Loans in Queue” screen 300 to a “Conditionally Approved” screen 370. Referring to FIG. 2A, before AUS approval, the “AUS Approval” column 230 of the loan officer screen indicates “waiting.” Referring to FIG. 2E, after update, the AUS approval column 230 has changed from “waiting” to displaying a button labeled “Accept Standard (11)” 235 to reflect the AUS approval category 325 and the number of unsatisfied conditions. After update, the loan is also moved from the underwriter “loans in queue” screen 300 (FIG. 3A) to the “Conditional Approval” screen 370 illustrated in FIG. 3C.

By selecting the AUS approval “Accept Standard (11)” button 235 (FIG. 2E), the loan officer may launch an “AEC Underwriting Notice” screen, 240 which is illustrated in FIG. 2F. The AEC Underwriting Notice screen (Notice screen) illustrates the information from the AUS Approval Form 320 (FIG. 3B) (as updated by the underwriter) that the loan officer must obtain or verify. The Notice screen 240 also includes a list 245 of all of the documents that the loan officer is required to obtain for the AUS approval category. For example, it can be seen that for the “Accept Standard” AUS approval category 325, eleven documents are required (disclosures, appraisal, title work, flood certificate, homeowners insurance, current W2, previous W2, one months pay stub, recent account statement, previous account statement, and purchase contract). The loan officer then goes about collecting the documents from the applicant and placing the documents in the folder. Generally, all documents received by the broker, whether by fax, mail, e-mail, or other, are placed in digital form and stored in a document directory (i.e., part of the document management subsystem 160). Typically, the loan officer or a document administrator will place the documentation in the correct folder.

As soon as a document is placed in the folder, the underwriter may go about analyzing and approving the document. In the present embodiment, the underwriter ensures that the documents obtained from the applicant meet the requirements for the AUS approval category 325. Thus, for example, if a 2055 EXT type appraisal in the amount of $180,000 is required for approval of the loan, then the underwriter ensures that the home sought to be purchased with the funds from the mortgage loan meets or exceeds an appraisal of $180,000 performed in accordance with the 2055 EXT appraisal standard. The underwriter may use the “View Docs” link 371 in the “UW Docs” column 373 (FIG. 3C) to access the folder containing all of the documents received from the applicant.

Upon approval of a document, the underwriter selects the “Approve (11)” button 372 in the “Doc Approval” column 374 (FIG. 3C) which launches a document approval screen 376 illustrated in FIG. 3D. In the document approval screen the underwriter may indicate which documents have been analyzed and approved by selecting “Approved” in a drop down menu 378 associated with each document listed. In FIG. 3D all of the documents are listed as “Needed.” FIG. 3E is a screenshot of the document approval screen illustrating the approval of the last four documents. To update the Tool 100 to illustrate the approval of the documents, the underwriter selects the “Update Documents” button 380 at the bottom of the screen.

When some or all of the documents are approved, the underwriting Conditional Approved screen 370 and the loan officer “loans in queue” screen 300 are both updated. FIG. 3F illustrates the underwriting Conditional Approval screen with the document approval “Approve” button 372 changed from “(11)” (FIG. 3C) to “(7)” (FIG. 3F) to reflect the approval by the underwriter of the four documents. Whenever one or more documents are approved, the conditions number decrement accordingly. FIG. 2G illustrates the loan officer “loans in queue” screen 200 with the AUS approval button “Accept Standard” 235 also changed from “(11)” (FIG. 2E) to “(7)” (FIG. 2G) to reflect the approval by the underwriter of the four documents. In addition, when some of the documents are approved, the AEC underwriting notice screen 240 is also updated. FIG. 2H is a screenshot of the Notice screen illustrating the approval of the four documents.

The Tool 100 allows the underwriter to begin analyzing documents as soon as the loan officer collects the first document. As such, the loan officer and the underwriter may be working on processing a loan application at, or nearly at, the same times. Thus, embodiments of the present invention allow a mortgage brokerage to move away from conventional serial processing of loan applications to substantially parallel processing of loan applications, which dramatically cuts the time required to process a loan application.

FIG. 21 is a screenshot of the Notice screen 240 illustrating the approval of all of the required documents. Note, the last “Recent Account Statement” document 250 is listed as not needed. Such a change may be made by the underwriter through the Document Approval Screen 376 (FIGS. 3D and 3E). FIG. 2J is a screenshot of the loan officer “Loans in Process” screen 200 showing the AUS approval column 230 updated to “Approved!” to reflect the approval of all documents by the underwriter.

When all of the documents are approved, the loan moves from the underwriting “Conditionally Approved” screen 370 (FIG. 3F) to a “Final Approval” screen 382 FIG. 3G is a screenshot of the underwriting “Final Approval” screen illustrating the Approve button 372 in the Doc Approval column 374 updated to reflect “0” remaining documents to approve, and further illustrating a new “Approve” button 377 in the UW Approval column 378. When the underwriter is ready to finally approve the loan application, he or she selects the new Approve button 372. Typically, the loan is ready to approve when all of the conditions are satisfied (e.g., all of the documents have been approved and all of the various AUS requirements are verified). In some instances, some or all aspects of the loan will change, which will require the underwriter to approve a new document or other underwriting condition. For example, the applicant may request a higher amount for the loan, which might require analysis of some or all of the documents and other loan processing.

Upon approval of all documents by the underwriter, or in some instances before approval, the loan officer may view the Fee Sheet 255 (shown in FIG. 2K) and verify that all of the information for the loan is correct. If all of the information is correct, then the loan officer may select “Order Documents” 260 to order the closing documents. This allows the final closing documents to be ordered well in advance of the actual closing to help avoid closing day stress.

If all of the information is incorrect, then the loan officer may use the edit loans 220 or other screens to change certain parameters of the loan application 600. At this point in the application processing, any such change generates an alert to the underwriter as the change may necessitate further underwriting. This functionality, along with other functionality described herein, helps to ensure that the final loan application submitted to the investor for in-house underwriting and funding will be accurate. Inaccurate submission to the investor can delay the closing and greatly effect throughput of the mortgage brokerage.

By selecting “Order Documents” 260 the loan officer is indicating his or her final approval for the loan. Note, in some embodiments of the present invention, the loan officer, underwriter, and quality control person must all finally approve the loan before closing can occur.

When the underwriter is ready to finally approve the loan application, he or she selects the final Approve button 377 in the UW Approval column 378. Such selection launches the Final Approval Screen 384 illustrated in FIG. 3H. By selecting “Yes” 386 the underwriter finally approves the loan application 600. In some embodiments, the “final approval” screen may list loans approved by an investor, rather than by an underwriter.

Upon final approval by the underwriter, the quality control person may begin the quality control process. In one embodiment, the Tool 100 includes a “Quality Control” subsystem 150, which includes a “loans in queue” screen 500. One example of a screenshot of a second screenshot of a scorecard screen, in accordance with the embodiment of FIG. 1. is illustrated in FIG. 5A. The bottom row of the screen illustrates the information for the loan being processed for borrower Test. The quality control screen allows the quality control person to ensure that the underwriting and other loan processing was performed correctly thus far. Hence, the quality control screen 500 provides links to the underwriting documents, the closing documents, and the HUD-1 documents so that the quality control person may view any of these documents.

To manage the quality control operations, the quality control “Loans in Queue” screen 500 also includes a QC Approval button 510 that launches a Quality Control checklist 520, one example of which is illustrated in FIG. 5B. The quality control checklist includes a list of questions 530 that must be answered positively before the quality control person can approve the loan. Upon selecting “Yes” 540 for each question, and selecting “Update,” 550 the quality control Loans in Queue screen 500 QC approval column 560 is updated to show the loan has been approved. Generally, approval is shown by placing “Approved!” in the approval column(FIG. 5C). In addition, the loan officer screen 200 , which also includes a QC Approval column 265 is also updated from “Waiting . . . ” to “Approved!” 270 (FIG. 2L). In addition to verifying that all of the information required by the checklist is correct and accounted for, the quality control person may perform other quality control checks. When all of the checks are complete, the quality control person may finally approve the loan by selecting the Final Approve button 570 (FIG. 5C), which only becomes available when the QC checklist 520 is complete. At this point, the loan may proceed to closing.

FIG. 4C is a screenshot of the administration “Closed Loans” screen 415 and FIG. 2M is a screenshot of the loan officer “Closed Loan” screen 275 before the funds for the loan have been received (see “Funds In?” column and “Check In?” column, respectively). At this point, the projected revenue for the loan, originally submitted in the estimated revenue window of the edit loan screen is $3200. Because the check has not been received by the investor, the actual revenue and the commission for the loan officer are not yet known. When the check is received, the administrator selects the “Edit Loan” link 215 to launch the Edit Loan screen 220 (FIG. 4D) and indicates that the check is received by selecting “Yes” in the “Check In?” drop down menu 420, and inputting the amount of the check in the “Actual Revenue” window 425. By selecting Update (not shown), the closed loan 415 and scorecard administrations 430 screens are updated as well as the loan officer closed loan screen 275, and the loan officer commission is generated.

FIG. 4E illustrates the administrator closed loan screen 415 and FIG. 2N illustrates the loan officer closed loan screen 275 after the edit loan screen 220 is updated to reflect the receipt of the check, namely by updating the entry in the “Check In?” column 277. Note, in this example, the commission (shown in the “commission” column 276) is $975. The generation of the commission by the Tool 100 may be achieved by any formula that a particular mortgage broker chooses. FIG. 8 is a screenshot of a loan officer closing and funding page 800. The closing and funding page gives the loan officer the ability to order closing documents and to order finding for the loan.

Besides management of any one loan being processed, the Tool 100 may also be used to generate any presentation of the data received and processed by the Tool that a particular mortgage broker or other user 180 would prefer. In one example, the administration subsystem 140 includes a Scorecard screen 430 (FIG. 4F, 4G, and 41) which displays the past commissions 435 for the loan officers. It also provides prospective commissions 440 for the administrator to approve. Before a commission is approved the loan officer has the opportunity to approve the commission in the loan officer commissions screen (not shown) and may view all pending and actual commissions in a loan officer scorecard 280 (FIG. 2-O).

The administration subsystem 140 further includes a user screen 445 where users 180 may be added or deleted (FIG. 4H). This avoids the necessity of the system administrator having to add or delete users.

3. Loan Processing Workflow

FIG. 7 is a block diagram illustrating one possible overall workflow using an embodiment of the present invention. In the present embodiment, the workflow may be broken down into multiple modules 710, 720, 730, 740, 750, 760, each of which facilitates different functionality and aspects of the embodiment. Each module 710, 720, 730, 740, 750, 760 generally may be thought of as an independent software application accessible from a single interface or “front end” 700, shown on FIG. 7 as the block labeled “TPS Workflow Creation.” As used herein, “TPS” stands for “Total Product Solution,” which in turn refers to an embodiment of the present invention. Each of the modules typically shares a common file record system and/or may access shared files, such as documents, extensible markup language (XML) or hypertext transfer protocol (HTTP) records, spreadsheets, user information files, and so forth.

The closing module 710 generally controls and facilitates closing of a loan. For example, the closing module may permit a user to order documents necessary for a loan closing, such as title insurance, flood certification, loan payment tables, and so forth. The closing module 710 further permits a user to order the HUD-1 statement discussed above. Typically, documents are not ordered through the closing module 710 until preliminary approval of all documents is given via the underwriting module 740, as discussed below.

The document administrator module 720 generally receives, processes, tracks, and displays various documents used by the embodiment or a user thereof. As documents are received by the embodiment (usually via facsimile or electronic mail, but also by any other computer-readable message or medium), the document administrator module 720 may display the document to the user, so that the user may place it in the proper folder. In alternate embodiments, the document administrator module may automatically determine the document type and place it in the proper folder. The document administrator module 720 may, for example, employ optical character recognition to scan a document to locate certain key words, phrases, numbers, or alphanumeric strings, then process the document accordingly. Alternately, the name of a file associated with or containing the document may be recognized by the document administrator module, or some other indicator may be recognized by the document administrator module. Further, the document administrator module 720 generally tracks which loan documents have been received and which are still required, and displays this information accordingly. For example, the document administrator module 720 may depict the total number of documents required to approve a loan and the number of documents already received and/or approved by an underwriter, as discussed in more detail below with respect to FIG. 10.

The loan officer module 730 generally facilitates the operations accessible by, and display shown to, loan officers. The loan officer operations of the embodiment were more fully discussed with respect to FIGS. 2A-2L. Briefly, the loan officer module 730 permits a loan officer to gather documentation required to review and/or approve a loan, submit these documents to the underwriter or other entity through the embodiment, and track the progress of the loan application.

The underwriter module 740 generally facilitates the operations accessible by, and display shown to, an underwriter. The underwriter operations of the embodiment were more fully discussed with respect to FIGS. 3A-3H. In brief, the underwriter module 740 permits an underwriter to review and approve documentation and loans, identify documents necessary to approve loans, create and manage loan folder (in conjunction with the document administrator module 720), and finally approve loans.

The administration module 750 permits a user to create, delete, and manage administrative rules. Administrative rules are more fully discussed in the section entitled “Administrative Rules,” below. The operation of the administration module was also discussed with respect to FIGS. 4A-4I, above. Generally, the administration module coordinates and facilitates the operation of the other modules 710, 720, 73, 740, 760, as well as facilitating revenue and budget forecasting. One exemplary implementation of revenue and budget forecasting is the “Scorecard,” discussed above with respect to FIGS. 4F, 4G, and 4I.

The quality control module 760 generally validates the loan officer and underwriting processes, and was more fully described above with respect to FIGS. 5A-5C.

4. Second Embodiment

FIGS. 9A-46 depict another embodiment of the invention. Generally, the embodiment is depicted as a series of screens and/or displays associated with the various software modules mentioned above, and may incorporate functionality already described herein. FIG. 9A, for example, depicts a login screen 900, through which a user of the embodiment may gain access to its modules and functionality. Typically, the user inputs a user identifier into the “UserID” field 901 and a password into the “Password” field 902. The user may then select a privilege level from the “Privilege” drop-down box 903. The user may then click the “Submit” box 904. Presuming the user identifier and password match, and both indicate the user is permitted the access corresponding to the chosen privilege type, the user is permitted access to the embodiment.

In the present embodiment, the user is presented with a start screen 905 upon accessing the embodiment, as shown in FIG. 9B. The start screen may display a sidebar 910, having a variety of buttons and/or drop-down boxes. The start screen 905 may also depict a corporate logo 920 or other identifier.

In the present embodiment, the sidebar 910 contents change depending on the privilege level chosen from the “Privilege” drop-down box 903 on the login screen 900. Each privilege level permits access to a different set of functionality, although certain embodiment functions may be common to one or more privilege levels. In the example shown in FIG. 9C, the sidebar 910 is configured for a user having the “ADMIN” (or administrative) privilege level. Typically, the user's current privilege level is shown in the privilege drop-down box 930, located directly beneath the “change privilege” button 925.

Some users may have access to multiple privilege levels. In order to change a privilege level without exiting the embodiment and logging back in through the login screen 800, a user may select a different privilege level from the drop-down box 930. In the present embodiment the drop-down box 930 displays only those privilege levels to which the currently logged-in user has access. Once a new privilege level has been selected, the “change privilege” button 925 may be clicked to access the sidebar 910 associated with the selected privilege level.

As used herein, privilege levels generally correspond to various positions within a mortgage, banking, or investing company. For example, the present embodiment recognizes the following privilege levels: loan officer (or “LO”), underwriter (or “UW”), administrative (or “Admin”), quality control (or “QC”), and processor. Alternate embodiments may employ more or fewer privilege levels.

5. Administrative Tools

The admin sidebar 910 permits access to a range of functionality. For example, clicking the “loans in process” button 935 displays the loan screen 1000, as shown in FIG. 10. It should be noted that the sidebar 910 remains; the logo 920 is replaced with the loan screen 1000. By keeping the sidebar, the embodiment permits the user to quickly and efficiently navigate between different screens by selecting different buttons.

The loan screen 1000 generally depicts all loans currently in process in a tabular format. As used herein, a loan “in process” is one that has been accepted by the mortgage company, but not yet closed. The loan table 1005 has a variety of entries. Each loan 1010 occupies a separate row on the table, with each column representing a different datum. For example, FIG. 10A depicts thirteen columns in the table 1005. The first column 1015 is the loan number, typically assigned by the embodiment when the loan is first created, as detailed above. The second column 1020 is the name of the loan officer originating the loan. The third column 1025 displays the borrower name

The fourth column 1030 is the date upon which the loan's lock expires, if any. Some loans may not have a lock expiration date (or may have passed a lock expiration date); these loans may have an entry reading “float” in the loan lock column 1030. The “pricing” column 1035 indicates the closing costs and fees quoted by the loan officer (or other authorized mortgage agent) to the mortgagee. Where a portion of the loan proceeds will be used to cover the closing costs, this number is zero. Clicking the entry in the pricing column 1035, which serves as a hyperlink, will display the pricing summary of the loan. The pricing summary may be displayed in the same window as the loan screen 1000, or may be shown in a dedicated window. An exemplary pricing summary is shown in FIG. 10B.

The sixth column 1040 displays the closing date for the loan. If the closing dates changes, the embodiment may automatically update this value. The seventh column 1045 depicts the funding date, which is the date the mortgage company will provide a check to the mortgagee. Typically, this date is no later than the closing date.

The eighth column 1050 indicates the purpose of the loan. For example, loans used to purchase a residence are indicated by the word “Purchase” in the column, while refinancing loans generally display either “Non-Cash-Out Refi” or “Cash-Out Refi” in the entry, depending on whether or not the purpose of the refinance is to draw equity from the property for the mortgagee's use.

The ninth column 1055 displays the loan amount, while the tenth column 1060 displays the investor name. In the present embodiment, the investor is the entity (corporate or personal) purchasing the loan as a mortgage-backed security. The investor name also constitutes a selectable hyperlink. When a user clicks on the investor's name, an investor summary screen 1100 is displayed, as shown in FIG. 11. The investor summary screen 1100 typically depicts the investor's name 1110, contact representative 1120, telephone number 1130, facsimile number 1140, electronic mail address 1150, customer service representative name 1160, and a list of any specific mortgagee clauses 1170 that may apply to mortgages sold to the investor. The mortgagee clause is often used as an investor's assignment designation. Typically, this is used by a mortgage broker to secure property insurance.

The investor summary screen 110 may be closed by clicking the “close” button 1180.

The eleventh column 1065 depicts the name of the title company. Clicking the entry in the title company column 1065 displays a title summary screen, having essentially the same entries therein as those described with respect to the investor summary screen.

The twelfth column 1070 is the approval or processing column. The approval column 1070 lists a loan status, indicating whether the loan has been approved or is still being processed. Each entry in the processing column 1070 is identical, namely a processing button. Clicking the processing button instructs the embodiment to display a processing information screen 1300, shown in FIG. 13.

Generally, the processing information screen 1300 depicts the name and home address of the loan applicant, as well as the status of all underwriting documents. The processing information screen 1300 also includes ordering buttons 1310 for each document not yet received and processed by the embodiment. (The receipt and processing of documents is discussed in more detail below, in the section entitled “Document Verification System.”) Clicking the ordering button 1310 will initiate a request for the corresponding document. In the present embodiment, a message requesting the document will be accordingly initiated and automatically transmitted from the embodiment to the appropriate agency. The embodiment requires no additional interaction from a user other than clicking the ordering button 1310. The message may be, among other formats, a facsimile, an electronic mail (“e-mail”), a HTTP or XML request, and so on. Once the document is ordered, the order date is displayed on the processing information screen.

The thirteenth column 1075 is the underwriting conditions column. In the present embodiment, if the loan requires additional documents be approved, the entry in the approval column indicates the approval category, how many total documents are required for final approval, and how many documents have already been approved. Typically, the number of documents approved and total number of documents requiring approval are displayed as a ratio. For example, “8/11” indicates that eight documents have been approved for the loan in question, while eleven total documents are required.

The embodiment recognizes various approval categories, which at least partially determines the exact documents necessary to approve a loan. For example, one loan application may fall into an “Accept- Standard” category, while another may fall into an “Accept-Plus” category. The exact categories used may vary by embodiment, the administrative rules (discussed below in the section entitled “Administrative Rules”), the investor purchasing the loan, and so forth. Generally, the loan officer may place an applicant, as well as his or her loan, into one of the approval categories upon review of certain documents and/or criteria, such as a credit report or credit score.

It should be noted that different investors may require different documents, even for loans otherwise falling into the same approval category. For example, Investor #1 might require a recent paystub, recent tax return, appraisal, and proof of an applicant's Social Security number for all loans in a given approval category. Investor #2 may additionally require a bank statement and flood certificate, while Investor #3 may require a tax certificate and title policy, but no proof of an applicant's Social Security number. Accordingly, each of the three investors requires different documents (and different numbers of documents) for a loan falling into a certain approval category. Further, the number of documents may vary depending on whether or not a co-borrower will be present on the loan, whether the purchase will be a first mortgage or second mortgage, a first purchase property or a second purchase property, whether the loan is a purchase loan or a refinance, and so forth. Accordingly, while the approval category at least partially dictates the number and type of documents necessary to approve the loan, it does not solely dictate the necessary documents.

The entry in the approval column 1075 may function as a selectable hyperlink. Clicking the entry displays a loan information screen 1200, as shown in FIG. 12A. The loan information screen 1200 includes a variety of subsections, all of which are shown in a single screen in the present embodiment. The loan information subsection 1210 depicts general information about the loan, such as: the borrower's name and address of the purchase property to be secured by the loan; the lock expiration, closing, and funding dates; the loan amount; and the loan interest rate. Effectively, the loan information subsection 1210 summarizes the information on the loan screen 1000.

The underwriting information subdisplay 1220 generally depicts the approval category of the loan, as also depicted in the “approval” column 1065 of the loan screen 1000.

The documents subsection 1230 depicts the documents necessary to close the loan in question, as well as the status of each document. The documents subsection 1230 is further divided into an approval-specific subsection 1240, and an always-required subsection 1250. In the present embodiment, documents listed in the always-required subsection are necessary for every loan, while documents listed in the approval-specific subsection 1240 vary, depending on the approval category listed in the approval column 1065 of the loan summary screen 1000. It should be noted that the documents in both the always-required subsection 1230 and approval-specific subsection 1240 may vary with the investor purchasing the loan. That is, different investors may require different documentation for every loan, and may require different documentation for the same or similar approval categories. For example and as discussed above, the documents listed in the subsections 1240, 1250 on the loan information screen 1200 of FIG. 12A are different than those listed in the loan information screen of FIG. 12B, because the investors in the two loans are different. As can also be seen on FIG. 12B, any documents required from a co-borrower are typically displayed in the co-borrower information subsection.

Returning to FIG. 10, loans displayed on the loan table 1005 may be filtered in order to display only those loans matching certain criteria. In the present embodiment, a two-step filter 1080 may be employed. The filter 1080 consists of a primary filter 1085 and a secondary filter 1090. A user may select a primary and secondary filter criterion in order to display only those loans matching the criteria in the loan table 1005. Alternately, only a single filter criterion may be selected.

Closed loans may be accessed by clicking the closed loans button 940 on the administrative sidebar 910. All closed loans for all loan officers are displayed in a tabular format similar to that shown in FIG. 10, and generally shown in FIG. 4C.

FIG. 14 depicts the “Deleted Loans” screen 1400, accessed by clicking the deleted loans button 945 on the sidebar 910. Generally, the deleted loans screen 1400 depicts a table 1405 of all loans deleted or otherwise removed from the embodiment, for example when an applicant is unable to secure financing or foregoes the mortgage. The deleted loans table 1405 displays the same columnar information as in the loan summary table 1005 of FIG. 10. The deleted loans table 1405, however, also includes a “date deleted” column 1410, showing the date on which the loan was removed from active processing. In the present embodiment, deleted loans may be grouped into sub-tables 1415 by month of deletion.

FIG. 15 depicts the scoreboard screen 1500, accessible in the present embodiment by clicking the “scoreboard” button 950 of the sidebar 910. The scoreboard 1500 generally indicates the number, volume, and value of loans initiated by each loan officer for a set period of time, for example in the last year. The scoreboard may be useful for tracking productivity of individual loan officers. Typically, the displayed loan data may be generated by one of the modules 710, 720, 730, 740, 750, 760 discussed above. The scoreboard is analogous to the “Scorecard” discussed above with respect to FIGS. 4F, 4G, and 4I.

The scoreboard information is shown in a variety of tables 1505, 1510, 1515. The first table 1505 is a month-to-date table, depicting the number of loans closed and funded (although not necessarily initiated) in the present month, as well as associated data. The next table 1510 is a year-to-date table, depicting the number of loans closed and funded in the current calendar year. The third table 1515 depicts the number of loans closed and funded in the last twelve months.

The month-to-date table 1505 has five columns 1520, 1525, 1530, 1535, 1540. The first column 1520 displays the name of the loan officer initiating the loan (the “loan officer column”). The second column 1520 depicts the number of loans initiated in the current month by the loan officer, while the third column 1530 indicates the aggregate value of the loans. The fourth column 1535 displays the projected revenue of the loans initiated by the officer in the current month, and the fifth (and final) column 1540 shows the actual revenue collected to date on the loans.

With respect to the year-to-date and last twelve months tables 1510, 1515, the columns are substantially similar to those described with respect to the month-to-date table. However, the data is broken down by month rather than by individual officer. Accordingly, the loan officer column 1520 is replaced by a month column 1545. Similarly, the information displayed in the other columns 1525, 1530, 1535, 1540 is an aggregate of all loans initiated in the month specified in the month column 1545, rather than being loan officer-specific data.

The scoreboard 1500 may include additional useful data, such as a stock ticker 1550, stock market chart 1555, and so on.

The commissions table 1600, shown in FIG. 16, is accessed by clicking the commissions button 955 on the sidebar 910. The commissions table 1600 generally depicts the same data as shown in the loan summary table 1005, but may also depict the commissions generated on each loan.

Clicking the archived loans button 960 on the sidebar 910 brings up the archived loans screen 1700, as shown in FIG. 17. The archived loans screen 1700 displays the archived loans table 1705, which summarizes all closed loans. In the present embodiment, the information contained in and format of the archived loans table 1705 is identical to that of the loan summary table 1005 of FIG. 10, although alternate embodiments may vary the information and/or formatting. The primary difference between the two tables is that the loan summary table 1005 depicts information for loans not yet closed, while the archived loans table 1705 depicts information for loans no longer in process.

FIG. 18 depicts a user list 1800. From the user list 1800, an administrative-level user may add, edit, or delete other users. The administrative-level user may additionally specify the level of access of any other user.

6. Administrative Rules

In addition to the aforementioned functionality, the present embodiment may permit the specification and application of flexible administrative rules. The administrative rules may specify the approval categories in which a loan may be classified, the documents necessary to approve a loan in a given approval category, and the necessary conditions for approving each such document. Each investor may have its own sets of administrative rules, specifying (among other possibilities) the various approval categories for loans, the criteria for placing a loan within a given approval category, the criteria for approving a loan in each approval category, the criteria for approving documents required by each approval category or common to all such categories, and which documents within each approval category must be approved before the loan may be approved, and which are optional documents. Once created, administrative rules may be stored as one or multiple XML files for later retrieval and use by the embodiment. Administrative rules and their creation are handled by the administrative module 750. In alternate embodiments of the invention, administrative rules for specific documents, approval categories, and/or investors may be automatically downloaded from regulatory bodies (such as Fannie Mae or Freddie Mac) or investors when updated rules are published, rather than requiring manual updates.

For example, a user of the present embodiment may select an investor 1905 from an investor list 1900, as shown on FIG. 19. The user may then specify one or more administrative rules to apply to all loans involving that investor. In other words, the rule will affect any loan currently in process, or later initiated, that is purchased by the investor. For reference, the rules generally apply any time the investor 1905 is listed in the investor column 1055 of the loan summary table 1005. The investor list 1900 may be accessed by selecting “Investors” from the admin drop-down box 930 on the sidebar 910.

The interface shown on FIG. 19 permits a user to add, edit, delete, or configure investors 1905 through one of a series of processes, each of which are initiated by selecting the appropriate button 1910, 1915, 1920, 1925 after selecting the investor from the investor list 1910. The process of editing the administrative rules will now be discussed.

FIG. 20 depicts an investor configuration screen 2000, displayed by the embodiment after the user selects a specific investor 1905 from the investor list 1910 of FIG. 19 and clicks the “configure” button 1915. The investor configuration screen 2000 lists the investor name 2005, and includes four buttons: “make sub-setting” 2010, “view” 2015, “edit” 2020, and “delete” 2025. Selecting the “delete” button 2025 purges the investor from an investor database maintained by the embodiment, thus eliminating the administrative rules for the investor. (Similarly, clicking the “delete” button 1920 shown in FIG. 19 has the same effect.) The investor database may be a classically-structured database, such as an SQL database, or may simply be an XML file having a list of investors 1905.

Selecting the edit button 2020 instructs the embodiment to display the edit template screen 2100. From the edit template screen 2100, a user may add, delete, or adjust approval categories for the currently-selected investor 1905. (Approval categories are more fully discussed above, with respect to FIGS. 10, 12A, and 12B.) For example, FIG. 21A shows three approval categories 2105 for the presently-selected investor 1905, namely “Accept-Plus,” “Accept-Standard,” and “Accept-Stream.” FIG. 21B depicts additional approval categories 2105 that may be employed by the present embodiment.

Returning to FIG. 21A, clicking the “add category” button 2115 permits a user to add additional approval categories, while clicking the “done” button 2120 returns the user to the investor configuration screen 2000 of FIG. 20. Adding approval categories is more fully discussed below with respect to FIG. 25.

Each approval category 2105 includes a document subfield 2110, listing all documents associated with the approval category. In short, a loan placed into a given approval category 2105 may not be verified until, at a minimum, all documents listed in the document subfield 2110 have been received and approved by an underwriter. As can be seen on FIG. 21A, the exact documents listed in the document subfield may vary by approval category. Individual documents may be selected in the document subfield 2110. For example, as shown in FIG. 22, the “Most Recent Paystub” document may be selected, thus highlighting the document.

If an individual document is highlighted and the “edit document” button 2125 is clicked, the embodiment may display a document editing screen 2300, as shown in FIG. 23. The user may then either add new conditions that must be fulfilled prior to approving the document, or edit currently-existing conditions. The user may also change the document name by changing the entry in the “document name” field 2305, and/or change the description of the document by editing the entry in the “document description” field 2310. Further, the user may select whether the document must be approved in order to approve the loan, or whether the document is merely optional, by selecting either the “required” or “optional” radio button 2315, 2320.

A user may add a new administrative rule (or “condition”) for the document by typing the rule into the “add condition” text box 2325 and clicking the “add” button 2330. Typically, each administrative rule for a document is phrased as a yes/no condition. For example, one administrative rule may be, “Does the name on the pay stub match the applicant's name?” Alternately, the administrative rule may be phrased as an instruction to the loan officer, underwriter, or other person approving the document, along the lines of, “Verify the name on the pay stub and the applicant's name are the same.” Because the rule is freeform text written by the administrative user, it may take any form desired. Each administrative rule must be satisfied before the document can be approved, as discussed in more detail in the section entitled “Document Verification System,” below. When applied to a document, an administrative rule may also be referred to as a “document approval criterion.”

The user may also edit or delete an existing administrative rule from this screen 2300 by selecting the appropriate button. Once all changes to or additions of administrative rules are made for the document, the user may save the changes by selecting the “save” button 2335.

Returning briefly to FIG. 19, the user may also view all approval categories 2105 for a given investor 1905 by selecting an investor from the investor list 1900 and clicking the view button 1935. In response, the embodiment displays an approval category screen 2400, shown in FIG. 24. The approval category screen 2400 generally displays all approval categories 2105 for the selected investor 1905, as well as the documents required to approve a loan falling within the category.

A user may select the “make sub-setting” view button 2010 from the investor configuration screen 2000 (shown on FIG. 20), in order to view the sub-setting dialog 2500, as shown on FIG. 25. As used herein, a “sub-setting” is an investor-specific set of documents required to approve a loan falling into a given approval category 2105. In other words, the sub-setting at least partially defines the set of loan approval criteria for a given approval category.

For example, some investors 1905 may not require all possible documents in order to approve loans falling into the “Accept-Standard” approval category. Accordingly, a sub-setting of the “Accept-Standard” approval category may be created for the investor, listing only the required documents. When loans in the “Accept-Standard” category 2105 are processed for the particular investor 1905, the underwriter need only approve the documents listed in the sub-setting. Approval of all “Accept-Standard” loans for all other investors would still require all documents defined in the default “Accept-Standard” category be processed. Effectively, the investor-specific sub-setting permits a user of the present embodiment the ability to tailor approval categories 2105 to individual investor criteria. It should be noted that sub-settings of sub-settings may also be created. That is, a sub-setting may be made for any defined set of loan approval criteria.

The sub-setting dialog 2500 displays the various approval categories 2105, along with a document selection box 2505 listing all documents that may be required for approving a loan falling into the given category. For example, the “Accept-Plus” category shown on FIG. 25 lists two documents in the document selection box 2505, namely “Verbal VOE or Most Recent Paystub” 2510 and “Most Recent Account Statement” 2515. Accordingly, loans in the “Accept-Plus” category may require either, both, or neither document 2510, 2515 be approved in order to approve the loan, but typically will not require additional documentation. The documents listed in each document selection box 2505 are drawn from the master template, as discussed below. Generally, the approval categories 2105 listed on the sub-setting dialog 2500 are also defined in the master template.

A user may define the sub-setting by selecting documents 2510, 2515 from the document selection box 2505 and clicking the “Add Doc” box 2520, as shown in FIG. 26. The highlighted documents are then transferred to the sub-setting document box 2550. All future approvals of loans in the given category 2105 will now require the documents listed in the sub-setting document box 2550 be reviewed and/or approved, while documents not listed in the box 2550 will not be required, as also shown in FIG. 26. A user may add all documents in the document selection box 2505 to the sub-setting document box by clicking the “Add All” box 2525. By contrast, selecting the “Remove” button 2530 will remove any highlighted documents from the sub-setting document box. Finally, clicking the “Move Up” or “Move Down” buttons 2535, 2540 will adjust the order in which documents are displayed to a user during the underwriting and loan officer processes. In some embodiments, the user may optionally select a button (not shown) to save changes to the sub-settings and exit.

As previously stated, the approval categories 2105 are typically initially created and defined in a master template. A user may access the master template from the investor screen 1900 by selecting either the “view” or “edit” buttons 1930, 1935 under the “Default Configuration: Master File” header 1940. Selecting the view button 1930 displays a list of all approval categories 2105 created in the master template 2700, along with associated documents, as shown in FIG. 27.

Selecting the edit button 1935 opens the “edit template” dialog 2800, depicted on FIG. 28. The edit template dialog 2800 may be used to create or edit approval categories 2105. This dialog permits a user to add, delete, or modify existing approval categories, with any such changes broadly applying to all investors 1905. It should be noted, however, that specific sub-settings (as discussed above with respect to FIGS. 25-26) may override template changes. In alternate embodiments, template changes may override sub-settings.

In order to edit an approval category 2105, a user may select the “edit category” button 2805. In response, the embodiment displays the edit category dialog 2900, shown on FIG. 29. The name of the category is displayed in the category name field 2905, and may be changed as desired. The “approval category” radio buttons 2910 indicate whether the category is an approval category or not. If the “yes” button is selected, the category is used to classify loans. Otherwise, the category is not. Occasionally, certain approval categories may be configured but not used to classify loans.

A new document may be added to the approval category 2105 by selecting the “new document” button 2915. Such an action opens a new document screen 3000 (shown in FIG. 30) in which the user may specify information regarding the document being added to the approval category, such as the document name, description, whether the document is required for approval or optional, and any administrative rules for the document. The new document screen 3000 is similar in many respects to the document editing screen 2300 already discussed, and shares functionality described with respect thereto.

In addition to adding new documents to an acceptance category 2105, a user may edit existing documents from the edit category dialog 2900. Selecting the “edit” button 2920 launches an editing dialog for the associated document. In the editing dialog, which is substantially similar to that shown in FIG. 23, the user may modify acceptance rules for the document or rename it. By contrast, selecting the “delete” button 2925 from the edit category dialog 2900 will remove the document from the approval category entirely. It should be noted that any changes made to a document from the edit category dialog 2900 will affect the document in all corresponding approval categories for all investors 1905.

Still with respect to the edit category screen 2900, changes made to the approval category 2105 may be saved by clicking the “edit” or “done” buttons 2930, 2935.

A user may add a new investor 1905 by specifying the administrative rules for the investor. By clicking the “add” button 1910, shown on FIG. 19, the user is taken to a screen where the name of the new investor 1905 may be specified, along with relevant contact information. Once the name and/or contact information is entered, the user may add administrative rules for the investor 1905 by selecting the investor from the investor list 1900 and clicking the “configure” button 1925, as already detailed.

Also with respect to FIG. 19, a general list of “master” administrative rules may also be maintained in one of a variety of so-called “master files.” The rules in a master file constitute a default template, and may be applied to any investors that do not have dedicated administrative rules in place. In the present embodiment, once a set of administrative rules is configured for an investor, the investor-specific rules may replace or override the master file. The master administrative rules may be edited or viewed by selecting either the “settings” button 1945 or “view” button 1935 for the master file, as shown on FIG. 19. Generally, the process of editing the master rules is similar to the process of editing or adding an administrative rule for a single investor 1905, as described above.

When initially configuring an administrative rule set for an investor, a master file may be used as a basis for the investor's 1905 administrative rule set. Selecting the “edit” button 1930 displays a list of master files (not shown), any of which may be selected, modified, and customized to create an investor's administrative rule set.

7. Loan Officer Tools

A user logged into the embodiment with loan officer privileges may access many of the reports, dialogs, and screens available to a user with administrative privileges, collectively managed by the loan officer module 730. For example, FIG. 31A depicts the loan officer sidebar 3100. As may be seen, the loan officer sidebar 3100 is shares multiple buttons with the administrative sidebar 910, such as the “loans in process,” “closed loans,” “scoreboard,” “commissions,” and “archived loans” displays. The major difference between the tables and screens accessed from the loan officer sidebar 3100 and those accessed from the administrative sidebar 910 is that the loan officer screens display information only for the user currently logged in. By contrast, the administrative screens previously discussed depict information for all loan officers.

For example, FIG. 31B displays a loan screen 1000 and loan table 1005 for a specific loan officer. The loan table 1005 is substantially similar to that accessed by an administrative user and shown in FIG. 10. The present loan table 1005, however, does not display loans for other loan officers. Accordingly, the table also omits the loan officer column 1020 (i.e., the second column of the loan table 1005 shown in FIG. 10).

The loan table 1005 accessed by a loan officer may include different functionality. For example, the loan officer loan table may permit a user to view underwriting documents associated with the loans shown in the table.

Similarly, the closed loans button 940 on the loan officer sidebar 3100 accesses a screen displaying all loans closed for the logged-in loan officer, rather than all loans closed for all loan officers. In the same vein, selecting the commissions button 955 or archived loans button 960 displays tables similar to those depicted when the same buttons are chosen from the administrative sidebar 910, but having only entries corresponding to the logged-in loan officer. Selecting the scoreboard button 950 depicts the scoreboard screen 1500, described in more detail above.

The general workflow and functionality of the loan officer module 730 of the present embodiment is identical to that described above, in the section entitled “Loan Processing.”

8. Underwriter Tools

A user logged into the embodiment with underwriter privileges may access many of the reports, dialogs, and screens available to a user with administrative privileges, collectively managed by the underwriter module 740. For example, FIG. 32 depicts the underwriter sidebar 3200. As may be seen, the loan officer sidebar 3100 is shares multiple buttons with the administrative sidebar 910, such as the scorecard button 950 and the change privilege button 925. For similar screens, the general workflow and functionality of the underwriter module 740 of the present embodiment is similar to that described above, in the section entitled “Loan Processing.”

The underwriter toolbar may also include several unique buttons, such as the “loans in queue” button 3205, the “conditional approval” button 3210, the “final approval” button 3215, and the “loans funded” button 3220. The loans in queue button 3205 accesses a “loans in queue” screen 3300, as shown in FIG. 33. This loans in queue screen 3300 is substantially similar to the one shown in FIG. 3A and discussed above. However, the present loans in queue screen 3300 also includes an “approve” button 3305 for each queued loan. Selecting the approve button 3305 initiates the loan approval process.

For example, the approve button 3305 for Michael Riley's loan 3310 may be selected. In response, the embodiment displays the loan approval dialog 3400, as shown in FIG. 34A. As a first matter, the underwriter may select the approval category into which the loan falls from the “approval category” subsection 3405 of the screen. The approval category subsection 3405 generally lists all approval categories associated with the loan's investor 1905.

Once the approval category 2105 is selected, the documents associated with the approval category 2105 are displayed on the loan approval dialog 3400, as shown on FIG. 34B. Further, the status of each document (i.e., whether needed for approval, ordered, or approved) is shown in the status column 3410. The user may update the status of each document by selecting the appropriate status from the associated drop-down box 3415 in the update column 3420. Sample document statuses include: needed (i.e., a document necessary to approve a loan); ordered (i.e., a document that has been requested from a third party, possibly through the document verification system discussed below in the section of the same name); received (i.e., a document that has been received by the embodiment, possibly through the document verification system); approved (i.e., the document has been underwritten and approved); declined (i.e., the document has been declined as unsuitable in some manner); and not needed (i.e., the document is not necessary for the loan approval process).

Updating a document status may impact work flow for one or more modules 710, 720, 730, 740, 750, 760. As a document's status is updated, the status change is reflected in one or more modules, and may affect what processing options are available in each module with respect to the document.

Returning to FIG. 32, the conditional approval button accesses a “conditional approval” screen substantially similar to that shown in FIG. 3C. This “conditional approval” screen 3500 is shown in FIG. 35. Similarly, the final approval button 3215 accesses a screen substantially similar to that shown in FIG. 3G.

The underwriter module 740 in the present embodiment may include additional functionality beyond that previously described. For example, an underwriter may view a loan summary table 3600 for any loan currently in the underwriting phase. One example of a loan summary table is shown in FIG. 36. The loan summary table generally depicts the approval category 2105 of the loan, a list 3605 of all documents needed to approve the loan, the approval status 3610 of each document (whether still required, ordered, received, and so forth), and the underwriting status 3615 of each document.

If a document has been received, it may be approved by the underwriter. Documents ready for approval may have a “view” button 3620 in the underwriting status column 3615 of the summary table 3600. Selecting the view button 3620 launches a document approval dialog 3700, shown in FIG. 37. The document approval dialog 3700 may be used to approve a document. In order to finally approve the document, each of the administrative rules associated with the document must be satisfied. The administrative rules are shown in the “document conditions” subsection 3705 of the approval dialog. Typically, the administrative rules shown in the document conditions subsection are specified through use of the administration module 750, as described above in the sections entitled “Administrative Rules” and “Administrative Tools.” If all administrative rules (in this case, document approval criteria) are satisfied by selecting a “yes” radio button 3710 for each, the document may be approved by clicking the “approve” button 3715. Alternately, the document may be declined by clicking the “decline” button 3720. Approving all documents associated with a loan typically initiates a dialog (not shown) requesting final approval of the loan. This final approval process transfers the loan from the “loans in queue” screen 3700 to the final approval screen shown in FIG. 3G. For reference, a loan is “conditionally approved” when an approval category is selected for a loan, and “finally approved” when all loan documents are approved.

9. Quality Control and Closing Tools

In the present embodiment, the quality control access level permits access to three screens, namely a “loans in process” screen (shown in FIG. 5A), a “closed loans screen” (shown in FIG. 4C), and a scoreboard (shown in FIG. 15). The functionality of each of these screens is discussed more fully above, as is the functionality of the quality control module 760.

10. Processor Tools

The present embodiment also includes functionality directed towards loan processors. Such processor functionality may include the ability to administer loan documents, view loans currently in process, submit loans for purchase by an investor once the loan is approved, and view funded loans. This functionality is typically accessed from the processor toolbar 3800, shown in FIG. 38.

Selecting the “loans in process” button 3805 from the processor sidebar 3800 calls up the loans in process screen 3900, shown on FIG. 39. In the present embodiment, the loans in process screen 3900 depicts a table 3905 of all loans still in the processing phase. The format of the table and data displayed therein is similar (although not necessarily identical) to that of the loan table 1005 of FIG. 10. For example, the processor loans table 3905 includes a “to order” column 3910 and a “past due” column 3915, which the loan table 1005 does not. The to order column 3910 displays both the total number of documents required to close the loan and the number that have yet to be ordered. With respect to the present embodiment, the two numbers are separated by a slash, with the number to the left of the slash indicating how many documents must still be ordered. For example, loan #211 displays the entry 3920 “Order (2/6)” in the order column 3910. Accordingly, six total documents are required to close the loan, and two documents must still be ordered.

The numerical entry 3925 in the past due column 3915 indicates how many documents are past the processing due date. Selecting either the entry 3920 in the to order column 3910 or the entry 3925 in the past due column 3915 accesses the document processing dialog 4000, shown on FIG. 40.

The processing information screen 4000 permits a processor to see at a glance what documents have been ordered, the order date, and the due date for an ordered document to arrive. If a document has not been ordered, an “order” button 4005 is displayed next to the document name. The processor may select this button 4005 to initiate a document order.

Ordering a document is generally done from the document ordering dialog 4100, shown on FIG. 41 and accessed by selecting the order button 4005 mentioned above. The ordering dialog 4005 displays the order date of the document (by default, the current date) in an order field 4105, the due date on which the processor wants to receive the document in a due field 4110, the name of the user ordering the document in the order box 4115, and the company from which the document should be ordered in the company box 4120. The processor may select a different user name from the order box 4115, and may similarly select a different company from the company box 4120 if desired. Selecting the “update” button 4125 initiates an electronic order for the document. Electronic ordering of a document is handled in the present embodiment by the document verification system, discussed in more detail below. In brief, a document order may be sent by the embodiment in any electronic format, such as an electronic mail, facsimile transmission, HTTP request, XML request, and so forth. The document request is substantially instantaneously communicated to the company in a company-approved format, thus eliminating much of the paperwork and formatting typically associated with ordering documents for a closing.

Returning briefly to FIG. 38, selecting the “submissions” button 3810 from the processor sidebar 3800 instructs the embodiment to display a processor submissions screen 4200. The processor submissions screen is depicted in FIG. 42, and includes a loan submission table 4205. Typically, only loans that have been completely approved and are ready for submission to an investor 1905 are displayed in the loan submission table 4205.

The loan submission table, in turn, displays for each loan: the loan number; loan officer; borrower; loan closing date; loan purpose; and investor, much like the loan table 1005 of FIG. 10. The loan submission table, however, additionally includes a “submitted” column 4210 depicting the submission status of a loan, and a “to submit” column 4215. The “submitted” 4210 and “to submit” 4215 columns bear an inverse relationship to one another. If a loan has already been submitted to an investor 1905, the entry in the “to submit” column is grayed out while the entry in the “submitted” column is active. Conversely, if a loan has not yet been submitted to an investor for review and/or purchase, the entry in the “to submit” column 4215 is active while the entry in the “submitted” column 4210 is grayed out. In either case, selecting the active entry causes the embodiment to display the loan submission screen 4300 of FIG. 43.

The processor may employ the loan submission screen 4300 to submit a loan to an investor 1905. It should be noted that the loan may be submitted whether or not it has previously been submitted. In other words, the processor may employ the loan submission screen to resubmit a loan, for example if loan data has changed. The loan may be immediately submitted to the investor 1905 by clicking the “submit” button 4305. The “submit date” field 4310 indicates the date on which the loan is submitted to the investor. In some embodiments, loan submissions may be delayed until a user-specified date, if desired.

Generally, the loan is electronically submitted to the investor as an electronic mail message, facsimile message, HTML or XML document, or any other computer-readable file or document. The loan submission is substantially instantaneous once the submission date is reached. Alternate embodiments may permit a processor to pick a specific time for submission as well as a date.

FIG. 44 displays a funded loans screen 4400, accessed via the “funded loans” button 3815 of the processor sidebar 3800. The funded loans screen 4400 typically displays a table 4405 having information on all funded loans. The term “funded loan” refers to a loan submitted to and purchased by an investor 1905. Essentially, the investor 1905 has provided or secured the loan funds.

FIG. 45 depicts a document administrator screen 4500, from which documents may be viewed and renamed. The document administrator screen 4500 is typically accessed by selecting the “doc admin” button 3820 on the processor sidebar 3800. Selecting the “view” button 4505 for a specific document instructs the embodiment to display the corresponding document, along with any administrative rules applying to the document.

The processor may also access the scoreboard (shown in FIG. 15) by selecting the scoreboard button 950 from the processor sidebar 3800.

11. Document Verification System (DVS)

The present embodiment may also include a document verification system. In the present embodiment, the document verification system is a subsystem of the document administrator module 720. The document verification system generally facilitates the identification and ordering of needed documents, as well as the receipt, verification, and general tracking of such documents during use by the embodiment.

Viewed another way, the document verification system performs any and all operations shown on the flowchart of FIG. 46. The flowchart of FIG. 46 details the path of a document through the embodiment, and the operation of the document verification system. The flowchart begins in operation 4600, in which a user creates a folder system for a new loan. The folder system generally includes a loan folder, as well as dedicated sub-folders for each document required to close a loan. Thus, for example, most loans will have sub-folders for a paystub or other form of income verification, an appraisal, a title certificate, and so forth.

Once the folder system is created in operation 4600, the DVS may identify documents necessary to close the loan and as yet not received. The DVS may accept user input identifying these documents, for example by means of the drop-down box 3415 of the loan approval dialog 3400 on FIG. 4. Alternately, the DVR may automatically determine which documents have not yet been received, for example by periodically scanning the folder structure and noting which document sub-folders lack files.

Regardless, once the needed documents are identified, the DVR may request such documents from the appropriate parties in operation 4620. This operation may be automatically carried out in response to determining a document has not been received, or may be initiated by a user. One exemplary interface for user-initiated ordering of documents is the order dialog 4100, shown on FIG. 41 and described with respect thereto.

In operation 4630, the DVR receives the ordered documents. Generally, documents are received as a facsimile, electronic mail message, computer-readable file, HTML file, XML file, word processing document, and so on. Documents may be received in any computer-readable format. As part of the receipt process, the DVR may optionally convert the document into a standardized format to ensure all documents managed by the embodiment share a common format. For example, one embodiment of the DVR may convert all incoming documents into a print document format (PDF), while another embodiment of the DVR may convert all incoming documents into a tagged image file format (TIFF). In the present embodiment, such receipt and optional conversion are handled by the DVR automatically, without user input. As part of the receiving operation 4630, the DVR may also optionally verify the file integrity of the document to ensure the entire document was received and is not corrupted. The DVR may further check the received document for computer viruses or other malicious files.

After the document is received and any optional sub-processes (document verification, virus scanning, document conversion, etc.) are carried out in operation 4630, the DVR places the document in the proper folder in operation 4640. The DVR may present the document to a user to classify and manually place in a folder. Typically, the DVR includes a graphical user interface (GUI) permitting a user to select, drag, and drop files as desired, thus facilitating the placement of documents in folders. For example, a user may be prompted that a document has been received. Part of the prompt may be a request to classify the document by placing it in the proper subfolder of the appropriate loan folder. Until the user places the document in a folder, the DVR may continue to flag the document as “needed” on status screens, such as the loan summary table 3600 (FIG. 36). Once the user drags and drops the document into a folder, the DVR may update the appropriate tables to reflect the receipt of the document.

Alternately, the DVR may automatically recognize and categorize the document. For example, the DVR may optically recognize characters in the document and search for the presence of one or more key elements. Based on the presence of such key words, phrases, numbers, and/or alphanumeric strings, the document verification system may assign the document to a specific loan and classify the document as a specific type. For example, the DVR may recognize a loan number, such as “1267,” and the word “appraisal” in the document, thus classifying the document as a home appraisal and assigning the document to loan #1267. In alternate embodiments, documents may be magnetically or optically encoded with information (for example, by means of a bar code, DataGlyph, or magnetic stripe) that the DVR may use to classify and associate the document as above, or the name of the file containing the document may include identifying information recognizable by the DVR.

Regardless, once the DVR classifies the document type and assigns it to a specific loan, it may move the document into the appropriate folder. For example, the DVR may identify the subfolder of the associated loan folder and deposit the document therein. The DVR may also optionally generate a prompt (such as an e-mail message, text alert, pop-up box, and so forth) to a user requesting the user verify the classification of the document. Further, once the DVR places the document in the appropriate subfolder, it may update various status screens to reflect the receipt of the document, as described above.

After the document has been classified and placed into the proper folder (or subfolder), two options exist. If the DVR is properly configured, it may automatically analyze the document in operation 4645. For example, the DVR may perform optical character recognition (OCR) operations on the document, as described above, to determine the presence of certain key words, phrases, numbers, or alphanumeric strings. Alternately, the name of a file associated with or containing the document may be recognized by the document administrator module, or some other indicator may be recognized by the document administrator module. This analysis may have been previously performed if the DVR automatically classified and sorted the document in operation 4640.

Still with respect to operation 4645, the DVR may determine a set of administrative rules applying to the document. Since each document type is associated with a specific approval category 2105 and investor 1905, once the document type (appraisal, paystub, title certificate, insurance, and so on) is determined the appropriate set of administrative rules for the loan's approval category and investor may be retrieved. The DVR may automatically review and initially approve or decline the document based on the administrative rules. For example, the DVR may again perform OCR functions on the document, scanning for key words, phrases, or concepts, which may then be used to determine responses to the rules. For example, one administrative rule given with respect to FIG. 23 was, “Does the name on the pay stub match the applicant's name?” The DVR may answer this rule by comparing the OCR name on the document to the applicant's name, typically stored as part of the loan information (see, for example, column 1025 of loan table 1005 on FIG. 10).

After the DVR makes an initial approval or decline in operation 4645, it may request user verification of its decision in operation 4650. The user may review the DVR's decision and confirm or override it. It should be noted that operation 4650 is entirely optional. After operation 4650, operation 4690 is accessed.

In the event the DVR is not configured for automated analysis of administrative rules, operation 4655 is accessed from operation 4640. In operation 4655, a list of all documents received but not yet approved (or declined) is presented to a user. For example, this presentation may take the form of the loan summary table 3600 of FIG. 36. The user may then select a document to review and approve in operation 4660.

Once a document is selected, the DVR retrieves the administrative rules for the document in operation 4670 and presents them to the user. As previously mentioned, the exact set of administrative rules applicable to a document may vary by approval category 2105 and investor 1905. One exemplary embodiment for presenting the document's administrative rules to the user is the document approval dialog 3700, shown in FIG. 37 and discussed above. The user may employ the document approval dialog 3700 to determine whether all administrative rules are satisfied.

If so, then in operation 4680 the DVR updates the administrative rules associated with the document to indicate all are satisfied. This may take the form of updating an XML file. Next, in operation 4690, the DVR may flag the document as “approved” on all relevant screens, as described above.

13. Closing Module

As previously mentioned, the closing module 710 permits a user of the embodiment to close a loan. More specifically, the closing module 710 may permit a user to order closing documents once a loan has been AUS approved, either automatically by the embodiment or by a user of the embodiment. Generally, the closing module 710 may collect loan data from other modules to facilitate the closing process.

The closing module permits a user to additionally review, approve, print, and transmit (for example, via electronic mail or facsimile) the ordered closing documents. Closing documents may be transmitted to any third party, such as a loan applicant, realtor, or investor 1905. Typically, the closing documents are converted into one or more PDF documents prior to transmission. The closing module may also receive a HUD-1 statement, convert the statement to a PDF document, and transmit the statement as necessary.

14. Pricing Module

Some embodiments of the present invention may include additional modules not heretofore discussed in detail. For example, some embodiments may include a pricing module (also referred to as a “secondary market module”).

The pricing module generally may consist of three sub-modules, each performing a unique (but oftentimes related) function. Alternately, one module, or two or more sub-modules, may perform the functions detailed herein. Accordingly, the sub-module structure of the pricing module should be understood to be illustrative only.

The first pricing sub-module is generally referred to as the platform sub-module. This sub-module facilitates the management of loan pricing, loan locking, and investor variances in loan pricing. Generally, the platform sub-module may facilitate interactions between a user and wholesale loan investors 1905.

Generally, as a loan application is initially received by the embodiment, an associated loan record (or identifying indicia) may appear in an “Unlocked Loans” screen. As the loan is locked, the loan record then moves from the “Unlocked Loans” screen to a “Loans To Be Locked” screen. The embodiment may facilitate locking the loan with an Investor 1905, which in turn may provide loan lock data to the pricing module and overall embodiment. Once the loan is locked, the associated loan record is displayed in a “Locked Loans” screen.

The second sub-module of the pricing module is the pricing formulator sub-module. The pricing formulator sub-module generally facilitates data flow and interfacing between the platform sub-module and a front-end pricing sub-module. (The front-end pricing sub-module is the third sub-module, and is discussed in more detail below.) Generally, the pricing formulator sub-module may capture pricing data entered into the embodiment, either by a user or automatically received from a third party. The pricing formulator may also cross reference such pricing data with data entered from the front-end pricing sub-module. Such cross-referencing may facilitate the production of a closing cost and/or rate structure for a loan. Further, the produced closing cost/rate structure may be consistent with a built-in pricing formula accessible by the pricing module. Generally, the pricing formula may be expressed as follows:

Loan Cost=[{Sum (A:E)}*{1+F}]; where

A is the sum of company hard costs (such as credit report costs, flood report costs, and any lender fees);

B is the sum of locality hard costs (such as title closing fees and title endorsement fees);

C is the sum of locality and/or loan level variable costs (such as title insurance costs and recording costs);

D is the sum of loan level hard costs (such as appraisal costs, subordination fees, cash out fees, investment property fees, and escrow waiver fees);

E is the sum of loan level commission costs (such as broker commissions and AEC revenue goals); and

F a variance hedge, expressed as a percentile.

It should be understood that the exemplary costs and fees for each category are illustrative, and by no means exclusive.

Further, the pricing formulator sub-module may calculate a guaranteed closing cost for a loan by using the following exemplary formula:

Guaranteed closing cost={X}−{H*Z}; where

X is the loan cost, computed as above;

H is a starting percentage price for the loan, also referred to as a yield spread premium;

and Z is the amount of the loan.

The third sub-module of the pricing module is the front-end pricing sub-module. This sub-module may capture or retrieve borrower or loan-specific data, use the data to formulate a query, and transmit the query to the pricing formulator sub-module. The pricing formulator sub-module may cross-reference the data with pricing information and the aforementioned pricing formula to produce an overall loan price. This price is generally transmitted to the front-end pricing sub-module and presented to the user.

The front-end pricing module generally may provide prices for either new loans or refinancing loans, including a variety of prices and closing costs for a number of interest rates since the yield spread premium typically varies with interest rate, the closing cost (and thus the overall loan price) may vary accordingly.

15. Conclusion

As will be recognized by those skilled in the art from the foregoing description, numerous variations on the described embodiments may be made without departing from the spirit and scope of the invention. For example, additional documentation or loan approval categories may be used, user reports may be easily and quickly created in multiple formats not listed herein, or additional information may be included in the electronic receipt. It should also be understood that the foregoing modules, processes, and embodiments may be implemented in any suitable computing language. Further, while the present invention has been described in the context of specific embodiments and processes, such descriptions are by way of example and not limitation. Accordingly, the proper scope of the present invention is specified by the following claims and not by the preceding examples.

We claim:

1. A computer-implemented method for managing mortgage broker work flow, comprising:
receiving a loan application;
generating an indication of at least one document required to approve the loan application;
electronically receiving the at least one document;
storing the at least one document;
providing access to the at least one documents;
electronically underwriting the at least one document; and
in response to electronically underwriting the at least one document, electronically approving the loan application.

2. The method of claim 1, further comprising:
generating an indication of a second document required to approve the loan application; and
at least beginning the operation of electronically underwriting the at least one document prior to receiving the second document.

3. The method of claim 2, further comprising the operation of:
in response to electronically approving the loan application, electronically submitting the loan application to an investor.

4. The method of claim 3, further comprising the operation of automatically recognizing a category for the at least one document.

5. The method of claim 3, wherein the operation of electronically underwriting the at least one document comprises:
determining at least one administrative rule for the at least one document; and
satisfying the at least one administrative rule.

6. The method of claim 5, wherein the operation of determining at least one administrative rule for the at least one document comprises:
determining an approval category for the loan application; and
in response to determining an approval category for the loan application, choosing an administrative rule for the at least one document corresponding to the approval category.

7. The method of claim 5, wherein the operation of determining at least one administrative rule for the at least one document comprises determining an administrative rule for the at least one document corresponding to the investor.

8. The method of claim 1, further comprising the operation of:
in response to generating an indication of at least one document required to approve the loan application, automatically requesting the at least one document.

9. The method of claim 8, wherein the operation of electronically underwriting the at least one document comprises:
in response to storing the at least one document, automatically initially underwriting the at least one document to generate an initially underwritten document.

10. A computer-implemented apparatus for electronically managing and approving a loan application, comprising:
a plurality of modules comprising:
a document administration module;
a loan officer module;
an underwriting module; and
an administration module; wherein
each of the modules is operably connected to one another;
at least one of the modules operates on a document associated with the loan application; and
the plurality of the modules may simultaneously operate on the loan application.

11. The apparatus of claim 10, wherein a plurality of the modules may simultaneously operate on the loan application.

12. The apparatus of claim 10, wherein the document administration module electronically receives and stores the document.

13. The apparatus of claim 12, wherein the administration module creates at least one document administrative rule applying to the document.

14. The apparatus of claim 11, wherein the document administration module controls an electronic submission of the loan application to an investor.

15. The apparatus of claim 14, wherein the administration module creates at least one investor administrative rule applying to the investor.

16. The apparatus of claim 15, wherein the at least one investor administrative rule is a sub-setting of a loan approval category.

17. The apparatus of claim 16, wherein:
a plurality of documents are associated with the loan approval category; and
the sub-setting is associated with at least a portion of the plurality of documents, but not an entirety of the plurality of documents.

18. The apparatus of claim 10, wherein:
the plurality of modules further comprises a quality control module operable on the document; and
the quality control module must approve the loan application prior to a final approval of the loan application.

19. The apparatus of claim 15, wherein:
the plurality of modules further comprises a processor module operable on the document;
the at least one administrative rule is a document approval criterion;
the processor module may satisfy the document approval criterion, thereby approving the document.

20. The apparatus of claim 19, further comprising a scoreboard displaying a loan datum for each loan initiated within a given timeframe, the loan datum generated by one of the plurality of modules.

21. A method for approving a loan, comprising:
receiving a loan application in electronic format;
receiving at least one document associated with the loan application in electronic format;
communicating the receipt of the document to a plurality of modules;
updating a status associated with the document;
communicating the update of the status associated with the document to the plurality of modules; and
in response to communicating the update of the status associated with the document to the plurality of modules, dispositioning the loan application.

22. The method of claim 21, wherein the step of dispositioning the loan application comprises approving the loan application.

23. The method of claim 21, wherein the step of dispositioning the loan application comprises declining the loan application.

24. The method of claim 21, wherein the step of communicating the receipt of the document to a plurality of modules comprises:
storing the document in a folder; and
in response to storing the document in a folder, updating at least one status entry in at least one table.

25. The method of claim 24, wherein the at least one table may be accessed by the plurality of modules.

26. The method of claim 24, further comprising the operations of:
operating on the loan application with a first of the plurality of modules; and
operating on the loan application with a second of the plurality of modules; wherein
the first and second modules operate simultaneously on the loan application.

27. The method of claim 26, wherein the first module is an underwriter module and the second module is a loan officer module.

28. The method of claim 21, further comprising the operations of:
identifying a second document associated with the loan application;
creating an electronic file associated with the second document;
in response to creating the electronic file associated with the second document, determining whether the second document is present; and
in response to determining the second document is not present, automatically ordering the second document from a third party.

29. The method of claim 28, further comprising the operations:
receiving the second document from the third party;
recognizing at least one identifier associated with the second document; and
in response to recognizing at least one identifier associated with the second document, placing the second document in the electronic file associated with the second document.
